(19) United States
(12) Patent Application Publication
(10) Pub. No.: US 2007/0110397 A1
(43) Pub. Date: May 17, 2007

(54) Playback apparatus and bookmark system

(76) Inventors: Kentaro Tanikawa, Osaka (JP); Yuko Tsusaka, Osaka (JP); Kazuhiro Nomura, Osaka (JP)

Correspondence Address: WENDEROTH, LIND & PONACK L.L.P., 2033 K. STREET, NW, SUITE 800, WASHINGTON, DC, 20006, US

(21) Appl. No.: 10/571,678

(22) PCT Filed: Sep. 22, 2004
(86) PCT No.: PCT/JP04/14294

§ 371 Date: Nov. 9, 2006

(30) Foreign Application Priority Data
Sep. 25, 2003 (JP) 2003-334184

(51) Int. Cl. H04N 7/00

(52) U.S. Cl. 386/95

(57) ABSTRACT

A playback apparatus that enables a user to acquire a desired partial content from a content. When it receives type information indicating a type of an object, the playback apparatus acquires position information indicating a playback position, which corresponds to a time at which the type information was received, in a content that was being played back then. The playback apparatus further acquires a partial content that includes an object corresponding to the type indicated by the received type information and is started from either the playback position indicated by the position information or a position in a vicinity of the playback position.

### TECHNICAL FIELD

The present invention relates to a technology for enabling a user to acquire a desired partial content from a content.

### BACKGROUND ART

In a known technology, if a user, while watching/listening to a content, would like to refer to information about the content, the user can specify the content so that the user can refer to the information later.

For example, there has been disclosed a search system that can search for information concerning a content that has been broadcast, even if the user does not know a proper keyword for the search. The search system includes a bookmarker that specifies a program content to be referred to, a search engine, and a gateway device that performs communications with the search engine. The search engine includes a database storing playlists that indicate in correspondence with each other (a) names of contents that were broadcast by broadcast stations and (b) broadcast times of the contents. The search engine also includes a database storing, in correspondence with each other, (c) names of contents that were broadcast and (d) information related to the contents.

The search system enables a user, who likes a music content he/she happened to listen to on a radio program, to use the bookmarker to acquire time information that indicates the time, and stores the acquired time information in the bookmarker. The bookmarker is connected to the gateway device, and transmits the time information stored therein to the search engine when it receives input of a predetermined operation of the user. The search engine acquires, from the playlists, the name of the music content (title of the tune) that was broadcast at the time indicated by the received time information, acquires information (for example, artist name) related to the acquired tune title, and transmits the acquired tune title and related information to the gateway device. The gateway device receives the tune title and related information and displays them. This enables the user to refer to the tune title and related information later with ease.

However, the above-mentioned search system only displays the content name and related information by the gateway device after acquiring the content name and related information of the broadcast content by the search engine. Such a system does not satisfy users who desire to experience again the content that was broadcast on a program.

### DISCLOSURE OF THE INVENTION

It is therefore the object of the present invention to provide a playback apparatus, a bookmark system, a terminal apparatus, an acquisition method, an acquisition program, an acquisition program recording medium, a bookmark method, a bookmark program, and a bookmark program recording medium that enable a user to acquire a desired partial content from a content.

The above-described object is achieved by a playback apparatus, comprising: an information receiving unit operable to receive type information that indicates a type of an object; a position acquiring unit operable to acquire position information that indicates a playback position, which corresponds to a time at which the type information was received, in a content that was being played back then; and a partial content acquiring unit operable to acquire, from the content, a partial content being a part of the content that includes an object corresponding to the type indicated by the type information and is started from either the playback position indicated by the position information or a position in a vicinity of the playback position.

With the above-stated construction, the playback apparatus includes an object of a type that is indicated by the type information, and can acquire a partial content that is started from either the playback position indicated by the position information or a position in a vicinity of the playback position. This enables the playback apparatus to acquire a partial content that includes an object favored by the user, and the user can view the object, which he/she favors, with the acquired partial content, again.

In the above-stated playback apparatus, the partial content acquiring unit may acquire the partial content when the position acquiring unit acquires the position information, the playback apparatus further comprising: a bookmark storing unit; and a writing unit operable to write the partial content into the bookmark storing unit.

With the above-stated construction, the playback apparatus can acquire a partial content at a time when it receives the type information, and write the acquired partial content. This enables the playback apparatus to manage the acquired partial content by the bookmark storing unit.

In the above-stated playback apparatus, the content may include a moving image that is composed of a plurality of still images, the partial content is composed of a still image included in the content, the partial content acquiring unit detects, from a portion of the content positioned back prior to the playback position, a still image that contains an object corresponding to the type indicated by the type information, and acquires the detected still image as the partial content.

With the above-stated construction, the playback apparatus can detect a still image in which the object appears, and acquire the detected still image as the partial content.

In the above-stated playback apparatus, the partial content acquiring unit may acquire a still image as the partial content if the type information indicates an image-related type.

With the above-stated construction, the playback apparatus can acquire a still image if the type information indicates an image-related type.

In the above-stated playback apparatus, the type information may indicate that the type of the object is one of (i) either image of person or character that constitutes part of one image and (ii) capture that constitutes one entire image, and the partial content acquiring unit acquires a still image as the partial content if the type information indicates one of image of person, character, and capture as the type.

With the above-stated construction, the image-related type can be image of person, character, or capture.

In the above-stated playback apparatus, the content may include a moving image, which is composed of a plurality of still images, and a sound/voice that corresponds to the moving image, the partial content is composed of a partial moving image and a partial sound/voice, the partial moving image being included in the moving image, and the partial sound/voice corresponding to the partial moving image, the partial content acquiring unit detects, from a portion of the content positioned back prior to the playback position, a still image that contains an object corresponding to the type indicated by the type information, and acquires, as the partial content, the partial moving image that starts with the detected still image, and acquires the partial sound/voice that corresponds to the partial moving image.

With the above-stated construction, the playback apparatus can detect a still image in which the object appears, and acquire a partial moving image and a partial sound/voice that start with the detected still image, as the partial content.

In the above-stated playback apparatus, the partial content acquiring unit may acquire, as the partial content, a partial moving image and a partial sound/voice corresponding to the partial moving image if the type information indicates a sound-related type.

With the above-stated construction, the playback apparatus can acquire a partial moving image and a partial sound/voice if the type information indicates a sound-related type.

In the above-stated playback apparatus, the partial content acquiring unit may acquire, as the partial content, a partial moving image and a partial sound/voice corresponding to the partial moving image if the type information indicates music as a type.

With the above-stated construction, the sound-related type can be music.

In the above-stated playback apparatus, the content may include one or more corner contents, each corner content includes one or more images, a specific image indicating a boundary of corner content is present before and after each corner content, the partial content acquiring unit detects, from a portion of the content positioned back prior to the playback position, a specific image that is closest to the playback position, and acquires, as the partial content, a corner content that starts immediately after the detected specific image.

With the above-stated construction, the playback apparatus can acquire a corner content that includes an object corresponding to the type indicated by the type information, as the partial content.

The above-stated playback apparatus may further comprise: a request receiving unit operable to receive an output request for the partial content; a reading unit operable to, if the request receiving unit receives the output request, read the partial content from the bookmark storing unit; and an output unit operable to output the read partial content.

With the above-stated construction, the playback apparatus, upon receiving an output request, reads the partial content from the bookmark storing unit, and outputs the read partial content. This shortens the time required for outputting a partial content after receiving the request from the user because it does not need to acquire the partial content to be output, from the content.

The above-stated playback apparatus may further comprise: a receiving unit operable to receive an output request for the partial content from an external terminal via a network; a reading unit operable to, if the receiving unit receives the output request, read the partial content from the bookmark storing unit; and a content transmitting unit operable to transmit the read partial content to the external terminal via the network.

With the above-stated construction, the playback apparatus can receive an output request from an external terminal via a network, and transmit the read partial content to the external terminal via the network.

The above-stated playback apparatus may further comprise: a request receiving unit operable to receive an output request for the partial content acquired by the partial content acquiring unit; and an output unit operable to output the acquired partial content, wherein the partial content acquiring unit acquires the partial content using the position information and the type information when the request receiving unit receives the output request.

With the above-stated construction, the playback apparatus, upon receiving an output request, acquires the partial content using the position information and the type information, and outputs the acquired partial content.

In the above-stated playback apparatus, the partial content acquiring unit may, upon receiving delete information which instructs deletion of the content, delete the content except for a specific portion including the partial content.

With the above-stated construction, when it deletes the content, the playback apparatus can keep a specific partial content that includes the partial content.

In the above-stated playback apparatus, the content may include a moving image, which is composed of a plurality of still images, and a sound/voice that corresponds to the moving image, the playback apparatus further comprising a content storing unit operable to preliminarily store the content, wherein the partial content acquiring unit includes: a bookmark storing unit; a writing unit operable to write, into the bookmark storing unit, the position information and the type information with indication of correspondence with each other; a deletion receiving unit operable to receive delete information which instructs deletion of the content, a first acquisition unit operable to, if the deletion receiving unit receives the delete information, detect, from a portion of the content positioned back prior to the playback position, a still image that contains an object corresponding to the type indicated by the type information, and acquire a specific partial content which is part of the content, includes a specific partial moving image that starts with the detected still image, and includes a specific partial sound/voice that corresponds to the specific partial moving image; a recording unit operable to record the specific partial content acquired by the first acquisition unit into the content storing unit; a deletion unit operable to delete the content from the content storing unit; and a second acquisition unit operable to acquire the partial content from the specific partial content recorded in the content storing unit, using the type information and the position information.

With the above-stated construction, when it deletes the content, the playback apparatus can acquire a specific partial content that includes an object corresponding to the type indicated by the type information, using the type information and the position information, record the acquired specific partial content into the content storing unit, and acquire the partial content from the specific partial content. This enables the playback apparatus to acquire the partial content from the specific partial content recorded in the content storing unit even if it deletes the content.

The above-stated playback apparatus may further comprise: a request receiving unit operable to receive an output request for the partial content; and an output unit operable to output the acquired partial content, wherein the second acquisition unit acquires the partial content using the position information and the type information when the request receiving unit receives the output request.

With the above-stated construction, the playback apparatus can acquire the partial content from the specific partial content when it receives the output request.

In the above-stated playback apparatus, the partial content acquiring unit may acquire the partial content when the position acquiring unit acquires the position information, the playback apparatus further comprising: a content storing unit operable to preliminarily store the content; a bookmark storing unit; a writing unit operable to write the partial content into the bookmark storing unit; a deletion receiving unit operable to receive delete information which instructs deletion of the content; and a deletion unit operable to, if the deletion receiving unit receives the delete information, delete the content from the content storing unit, leaving the partial content in the bookmark storing unit without deleting thereof.

With the above-stated construction, the playback apparatus stores the partial content in the bookmark storing unit even if it deletes the content. This enables the user to view the object, which he/she favors, again with the stored partial content, even after the content is deleted.

In the above-stated playback apparatus, the information receiving unit may receive the type information from an external terminal, and further receives a terminal identifier for identifying the external terminal from the external terminal, the playback apparatus further comprising: a bookmark storing unit; and writing unit operable to write, into the bookmark storing unit, the terminal identifier in correspondence with the position information and the type information.

With the above-stated construction, the playback apparatus can write the terminal identifier into the bookmark storing unit in correspondence with the position information. This enables the playback apparatus to manage the position information for each external terminal.

The above-stated playback apparatus may further comprise: a receiving unit operable to receive a terminal identifier and an output request for the partial content acquired by the partial content acquiring unit, from an external terminal; and a content transmitting unit operable to transmit the partial content to the external terminal from which the output request was received, wherein the partial content acquiring unit compares the received terminal identifier with the terminal identifier stored in the bookmark storing unit, and if the two terminal identifiers are identical with each other, reads position information and type information that correspond to the terminal identifiers, from the bookmark storing unit, and acquires the partial content using the read position information and type information.

With the above-stated construction, the playback apparatus, upon receiving a terminal identifier and an output request from an external terminal, can compare the received terminal identifier with the terminal identifier stored in the bookmark storing unit, acquire the partial content using the read position information and type information that correspond to the matched terminal identifiers, and output the acquired partial content to the external terminal.

In the above-stated playback apparatus, the content may include an image group that is composed of a plurality of images, the partial content includes one or more images included in the image group, and the partial content acquiring unit performs degrading so that each image included in the partial content is lower in image quality than each image constituting the image group included in the content.

With the above-stated construction, the playback apparatus can perform degrading so that each of one or more images to acquire is lower in image quality than each image constituting the image group included in the content.

In the above-stated playback apparatus, the content may include a sound/voice, the partial content includes a partial sound/voice that is a part of the sound/voice, and the partial content acquiring unit performs degrading so that the partial sound/voice included in the partial content is lower in sound quality than the sound/voice included in the partial content.

With the above-stated construction, the playback apparatus can perform degrading so that the partial sound/voice to acquire is lower in sound quality than the sound/voice included in the partial content.

In the above-stated playback apparatus, the content may include an image group that is composed of a plurality of images, in the partial content, a predetermined character is attached to one or more images included in the image group, and the partial content acquiring unit attaches a predetermined character to an image acquired from the image group.

With the above-stated construction, the playback apparatus can acquire an image which is generated by attaching a predetermined character to an image acquired from the image group.

In the above-stated playback apparatus, the bookmark storing unit may further store another position information and another type information in correspondence with another terminal identifier for identifying another external terminal, said another position information and said another type information corresponding to the content, the playback apparatus further comprises an expiration time writing unit operable to write, in correspondence with the position information into the bookmark storing unit, an expiration time of the partial content transmitted by the content transmitting unit, and the partial content acquiring unit acquires the partial content if the receiving unit receives the output request and the terminal identifier from the external terminal before the expiration time, and prohibits itself from acquiring the partial content for said another position information and said another type information if the receiving unit receives, before the expiration time, said another terminal identifier and the output request for the partial content from said another terminal corresponding to said another position information and said another type information.

With the above-stated construction, the playback apparatus can attach an expiration time to the partial content to acquire, and until the expiration time is reached, prohibit itself from acquiring the partial content for another position information and another type information both corresponding to the same content.

In the above-stated playback apparatus, the information receiving unit may further receive a regional identifier that identifies a region related to the object, the playback apparatus further comprising: a bookmark storing unit; and a writing unit operable to write, into the bookmark storing unit, the regional identifier in correspondence with the position information and the type information.

With the above-stated construction, the playback apparatus can write the regional identifier into the bookmark storing unit in correspondence with the position information.

The above-stated playback apparatus may further comprise: an identifier receiving unit operable to receive, from an external terminal, an output request for the partial content acquired by the partial content acquiring unit and receive a terminal region identifier that identifies a region in which the external terminal is located; and a content transmitting unit operable to transmit the partial content to the external terminal, wherein the partial content acquiring unit reads, from the bookmark storing unit, position information and type information that correspond to a regional identifier that is identical with the received terminal region identifier, and acquires the partial content using the read position information and type information.

With the above-stated construction, the playback apparatus can receive a terminal region identifier from an external terminal, acquire a partial content using position information and type information that correspond to the received regional identifier, and transmit the partial content to the external terminal. This enables the user to receive the partial content regarding the outgoing destination, from the playback apparatus using the external terminal.

In the above-stated playback apparatus, the position acquiring unit may acquire, as the position information, an elapse time between a time at which the content is started to be played back and a time at which the type information is received, and the partial content acquiring unit acquires the partial content that is started within the elapse time.

With the above-stated construction, the playback apparatus can acquire, as the position information, an elapse time between a time at which the content is started to be played back and a time at which the type information is received, and acquire the partial content using the acquired elapse time.

The above-described object is also achieved by a bookmark system comprising a playback apparatus and a terminal apparatus that transmits an instruction to the playback apparatus to attach a bookmark to a content that is being played back, the terminal apparatus including: an instruction receiving unit operable to receive, from a user, an instruction to attach a bookmark regarding an object; and an information transmitting unit operable to, if the instruction receiving unit receives the instruction to attach a bookmark, transmit, to the playback apparatus, type information that indicates a type of the object, the playback apparatus including: an information receiving unit operable to receive the type information from the terminal apparatus; a position acquiring unit operable to acquire position information that indicates a playback position, which corresponds to a time at which the type information was received, in a content that was being played back then; and a partial content acquiring unit operable to acquire, from the content, a partial content being a part of the content that includes an object corresponding to the type indicated by the type information and is started from either the playback position indicated by the position information or a position in a vicinity of the playback position.

With the above-stated construction, the terminal apparatus of the bookmark system, upon receiving a bookmark instruction from a user, can transmit the type information to the playback apparatus, and the playback apparatus, upon receiving the type information from the terminal apparatus, can acquire position information, and acquire a partial content that includes an object corresponding to the type indicated by the type information and is started from either the playback position indicated by the position information or a position in a vicinity of the playback position.

In the above-stated bookmark system, the partial content acquiring unit may acquire the partial content when the information receiving unit receives the type information, the playback apparatus further including: a bookmark storing unit; and a writing unit operable to write the partial content into the bookmark storing unit.

With the above-stated construction, the playback apparatus can acquire the partial content when it receives the type information from the terminal apparatus, and write the acquired partial content into the bookmark storing unit. This enables the playback apparatus to manage the acquired partial content by the bookmark storing unit.

In the above-stated bookmark system, the terminal apparatus may further include an identifier storing unit for preliminarily storing a terminal identifier for identifying the terminal apparatus, and the information transmitting unit further transmits the terminal identifier with indication of correspondence with the type information, the information receiving unit further receives the terminal identifier, and the writing unit writes the received terminal identifier into the bookmark storing unit with indication of correspondence with the partial content.

With the above-stated construction, the playback apparatus can write the terminal identifier into the bookmark storing unit with indication of correspondence with the partial content. This enables the playback apparatus to manage partial contents for each terminal apparatus.

In the above-stated bookmark system, the instruction receiving unit may further receive an output request for the partial content stored in the bookmark storing unit, the playback apparatus further comprises: a receiving unit operable to receive the output request and the terminal identifier for identifying the terminal apparatus that received the output request, from the terminal apparatus; a reading unit operable to, if the receiving unit receives the output request and the terminal identifier, compare the received terminal identifier with the terminal identifier stored in the bookmark storing unit, and if the two terminal identifiers are identical with each other, reads a partial content corresponds to the terminal identifiers, from the bookmark storing unit; and a content transmitting unit operable to transmit the read partial content to the terminal apparatus, the terminal apparatus further includes: a request transmitting unit operable to, if the receiving unit receives the output request, transmit the received output request and terminal identifier to the playback apparatus; a content receiving unit operable to receive, from the playback apparatus, the partial content read by the reading unit; and a content output unit operable to output the received partial content.

With the above-stated construction, the playback apparatus, upon receiving the output request and the terminal identifier from the terminal apparatus, can compare the received terminal identifier with the terminal identifier stored in the bookmark storing unit, and output, to the terminal apparatus, a partial content corresponding to a terminal identifier that is identical with the received terminal identifier. Also, the terminal apparatus can receive the partial content from the playback apparatus, and output the received partial content. This enables the playback apparatus, upon receiving an output request for a partial content from a terminal apparatus, to read from the bookmark storing unit a partial content corresponding to a terminal identifier of the terminal apparatus that sent the output request to the playback apparatus, and transmit the read partial content to the terminal apparatus. This shortens the time required for outputting a partial content after receiving an output request, compared with the case where the playback apparatus acquire a partial content from a content and transmit the acquired partial content each time it receives an output request for a partial content from a terminal apparatus.

In the above-stated bookmark system, the playback apparatus and the terminal apparatus may be connected to each other by a home network, the playback apparatus is a server apparatus in the home network, and the terminal apparatus is a client apparatus in the home network.

With the above-stated construction, the playback apparatus can be used as a server apparatus in the home network, and the terminal apparatus can be used as a client apparatus in the home network. This enables a bookmark system to be formed on a home network.

In the above-stated bookmark system, the terminal apparatus may be a portable terminal apparatus.

With the above-stated construction, a portable terminal apparatus can be used as the terminal apparatus in the bookmark system.

In the above-stated bookmark system, the playback apparatus may further include a position transmitting unit operable to transmit the position information to the terminal apparatus, the terminal apparatus further includes: a position receiving unit operable to receive the position information; a bookmark storing unit; and an information writing unit operable to write the received position information into the bookmark storing unit with indication of correspondence with the type information that was transmitted to the playback apparatus.

With the above-stated construction, the playback apparatus can transmit the acquired position information to the terminal apparatus, and the terminal apparatus can write the position information into the bookmark storing unit with indication of correspondence with the type information.

In the above-stated bookmark system, the instruction receiving unit may further receive an output request for the partial content corresponding to the position information and the type information, the terminal apparatus further includes: a request transmitting unit operable to, if the instruction receiving unit receives the output request, transmit, to the playback apparatus, the received output request and the position information and the type information stored in the bookmark storing unit; a content receiving unit operable to receive, from the playback apparatus, the partial content acquired based on the transmitted position information and type information; and a content output unit operable to output the received partial content, the playback apparatus further includes: a receiving unit operable to receive the position information, the type information, and the output request from the terminal apparatus; and a content transmitting unit operable to transmit the partial content acquired by the partial content acquiring unit to the terminal apparatus, wherein if the receiving unit receives the position information, the type information, and the output request, the partial content acquiring unit acquires the partial content using the received position information and type information.

With the above-stated construction, the terminal apparatus can transmit an output request, position information, and type information to the playback apparatus. The playback apparatus can acquire a partial content using the received position information and type information, and transmit the acquired partial content to the terminal apparatus. And the terminal apparatus can output the received partial content.

The above-described object is also achieved by a terminal apparatus that transmits an instruction to a playback apparatus to attach a bookmark to a content that is being played back, the terminal apparatus comprising: an instruction receiving unit operable to receive, from a user, an instruction to attach a bookmark regarding an object; an information transmitting unit operable to, if the instruction receiving unit receives the instruction to attach a bookmark, transmit, to the playback apparatus, type information that indicates a type of the object; a position receiving unit operable to receive, from the playback apparatus, position information that indicates a playback position, which corresponds to a time at which the type information was received, in a content that was being played back then; a bookmark storing unit; and an information writing unit operable to write the received position information and the type information transmitted to the playback apparatus, into the bookmark storing unit with indication of correspondence with each other.

With the above-stated construction, the terminal apparatus, upon receiving a bookmark instruction from a user, can transmit type information to the playback apparatus, receive position information from the playback apparatus, and write the position information and the type information into the bookmark storing unit with indication of correspondence with each other.

In the above-stated terminal apparatus, the bookmark storing unit may have an area corresponding to the type indicated by the type information, and the information writing unit writes the position information and the type information into the area corresponding to the type indicated by the type information.

With the above-stated construction, the terminal apparatus can store the position information and the type information into the area corresponding to the type indicated by the type information. This makes it possible to manage the position information and type information for each type of object.

In the above-stated terminal apparatus, the instruction receiving unit may further receive an output request for the partial content acquired from the content by the playback apparatus, the output request corresponding to the position information and the type information, the terminal apparatus further includes: a request transmitting unit operable to transmit, to the playback apparatus, the received output request and the position information and the type information stored in the bookmark storing unit; a content receiving unit operable to receive, from the playback apparatus, the partial content acquired based on the transmitted position information and type information; and a content output unit operable to output the received partial content.

With the above-stated construction, the terminal apparatus can transmit an output request, position information, and type information to the playback apparatus, receive from the playback apparatus a partial content that corresponds to the transmitted position information and type information, output the received partial content. This enables the user to view the partial content using the terminal apparatus, even while the user is out of home or office.

In the above-stated terminal apparatus, the terminal apparatus may be a portable terminal apparatus that communicates with another terminal apparatus, and the information transmitting unit further transmits the position information and the type information stored in the bookmark storing unit, to said another terminal apparatus.

With the above-stated construction, a portable terminal apparatus can transmit the position information and the type information stored in the bookmark storing unit, to another terminal apparatus.

In the above-stated terminal apparatus, the position receiving unit may further receive, from said another terminal apparatus, position information and type information stored in said another terminal apparatus, and the information writing unit further writes the position information and type information received from said another terminal apparatus, into the bookmark storing unit.

With the above-stated construction, the terminal apparatus can receive, from another terminal apparatus, another position information and another type information, and write the received another position information and another type information into the bookmark storing unit.

In the above-stated terminal apparatus, the terminal apparatus may be a network-connected client apparatus in a home network in which the playback apparatus is a server apparatus.

With the above-stated construction, the terminal apparatus can be used as a client apparatus in a home network in which the playback apparatus is used as a server apparatus.

In the above-stated terminal apparatus, the instruction receiving unit may further receive a regional identifier that identifies a region related to the object, and he information writing unit further writes, into the bookmark storing unit, the regional identifier in correspondence with the position information.

With the above-stated construction, the terminal apparatus can write the regional identifier into the bookmark storing unit in correspondence with the position information.

In the above-stated terminal apparatus, the instruction receiving unit may further receive an output request for the partial content acquired from the content by the playback apparatus, the output request corresponding to the position information and the type information that correspond to a regional identifier, the terminal apparatus further comprises: an identifier acquiring unit operable to, if the output request is received, acquire a terminal region identifier that identifies a region in which the external terminal is currently located; an information acquiring unit operable to acquire, from the bookmark storing unit, position information and type information that correspond to a terminal identifier that is identical with the received terminal region identifier; a request transmitting unit operable to transmit the acquired position information and type information and the output request to the playback apparatus; a content receiving unit operable to receive, from the playback apparatus, the partial content acquired based on the transmitted position information and type information; and a content output unit operable to output the received partial content.

With the above-stated construction, the terminal apparatus can transmit, to the playback apparatus, position information and type information that correspond to a terminal identifier that is identical with a received terminal region identifier that identifies a region in which the external terminal is currently located, receive, from the playback apparatus, the partial content that corresponds to the transmitted position information and type information, and output the received partial content. This enables the user, who is carrying the terminal apparatus, to view the partial content that is related to the region in which the user is currently located.

### BRIEF DESCRIPTION OF THE DRAWING

FIG. 1 shows a use form of a bookmark system 1.

FIG. 2 is a block diagram showing the construction of the portable phone 100.

FIG. 3 is a block diagram showing the construction of the bookmark storing unit 101.

FIG. 4 shows the data structure of the music information table T100 included in the music folder 120.

FIG. 5 shows the data structure of the persons information table T101 included in the persons folder 121.

FIG. 6 shows the data structure of the characters information table T102 included in the characters folder 122.

FIG. 7 shows the data structure of the captures information table T103 included in the captures folder 123.

FIG. 8 shows the data structure of the regional information table T110 included in the regional information storing unit 102.

FIGS. 9A and 9B show examples of the information displayed on the display unit 109 for selection of the bookmark information.

FIG. 10 is a block diagram showing the construction of the playback apparatus 200.

FIG. 11 is a block diagram showing the construction of the program content storing unit 201.

FIG. 12 shows the data structure of the search information table T200 included in the search information storing unit 202.

FIG. 13 shows the contents of the data stored in the program content storing unit 201 after program content “FFF” is deleted.

FIG. 14 is a flowchart showing the outline of the operation of the bookmark registration.

FIG. 15 is a flowchart showing the outline of the operation of the specification display.

FIG. 16 is a flowchart showing the outline of the operation of the region display.

FIG. 17 is a flowchart showing the operation of the bookmark information storage process.

FIG. 18 is a flowchart showing the operation of the image data acquisition process.

FIG. 19 is a flowchart showing the operation of the program content acquisition process.

FIG. 20 is a flowchart showing the operation of the deletion process, continued to FIG. 21.

FIG. 21 is a flowchart showing the operation of the deletion process, continued from FIG. 20.

FIG. 22 is a block diagram showing the construction of the playback apparatus 1000.

FIG. 23 shows the data structure of the music information table T1000 included in the bookmark information storing unit 1002.

FIG. 24 is a block diagram showing the construction of the portable phone 1100.

FIG. 25 is a flowchart showing the outline of the operation of the bookmark registration.

FIG. 26 is a flowchart showing the outline of the operation of the specification display.

FIG. 27 is a flowchart showing the outline of the operation of the region display.

FIG. 28 is a block diagram showing the construction of the playback apparatus 200A.

FIG. 29 is a flowchart showing the operation of the image data acquisition process, continued to FIG. 30.

FIG. 30 is a flowchart showing the operation of the image data acquisition process, continued from FIG. 29.

FIG. 31 shows a use form of a bookmark system 2.

FIG. 32 is a block diagram showing the construction of the playback apparatus 2000.

FIG. 33 is a block diagram showing the construction of the program content storing unit 2001.

FIG. 34 is a block diagram showing the construction of the bookmark storing unit 2002.

FIG. 35 shows the data structure of the music information table T2000 included in the music folder 2020.

FIG. 36 shows the data structure of the persons information table T2001 included in the persons folder 2021.

FIG. 37 shows the data structure of the characters information table T2002 included in the characters folder 2022.

FIG. 38 shows the data structure of the captures information table T2003 included in the captures folder 2023.

FIG. 39 shows an example of a screen displaying screen data and the program content being played back.

FIGS. 40A and 40B show examples of the information displayed on the monitor 11 via the output unit 2007 for selection of the bookmark information.

FIG. 41 shows the construction of the remote controller 2300.

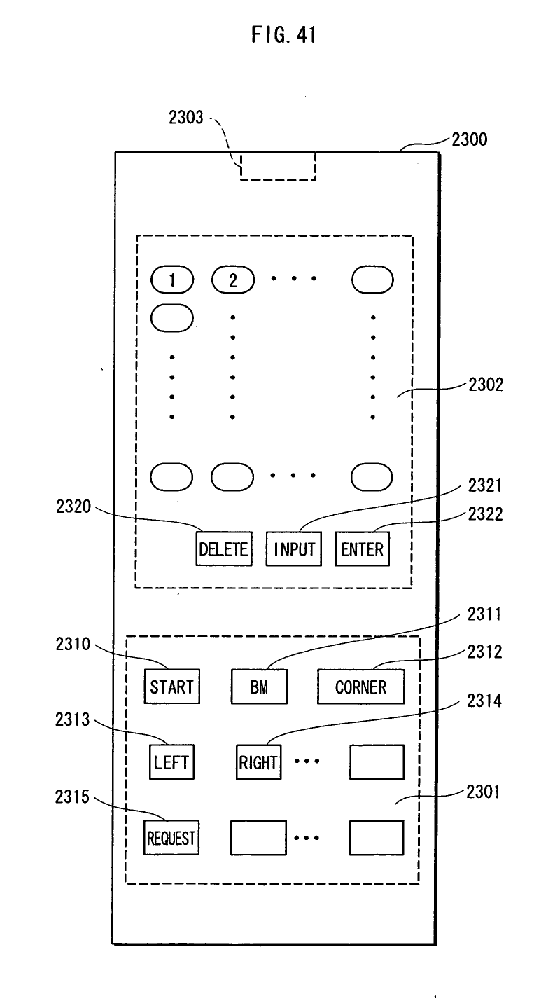

FIG. 42 is a block diagram showing the construction of the portable phone 2100.

FIG. 43 shows the data structure of the regional information table T2100 included in the regional information storing unit 2102.

FIG. 44 is a flowchart showing the operation of the BM registration process for registering the bookmark information.

FIG. 45 is a flowchart showing the operation of the image data acquisition process.

FIG. 46 is a flowchart showing the operation of the information storage process.

FIG. 47 is a flowchart showing the operation of the first display process.

FIG. 48 is a flowchart showing the operation of the second display process.

FIG. 49 is a block diagram showing the construction of the playback apparatus 3000.

FIG. 50 shows the data structure of the music information table T3000 included in the music folder of the bookmark storing unit 3002.

FIG. 51 is a flowchart showing the operation of the image data acquisition process.

FIG. 52 is a flowchart showing the operation of the program content acquisition process.

FIG. 53 is a flowchart showing the operation of the deletion process, continued to FIG. 54.

FIG. 54 is a flowchart showing the operation of the deletion process, continued from FIG. 53.

### BEST MODE FOR CARRYING OUT THE INVENTION

### 1. Embodiment 1

1.1 Construction of Bookmark System 1

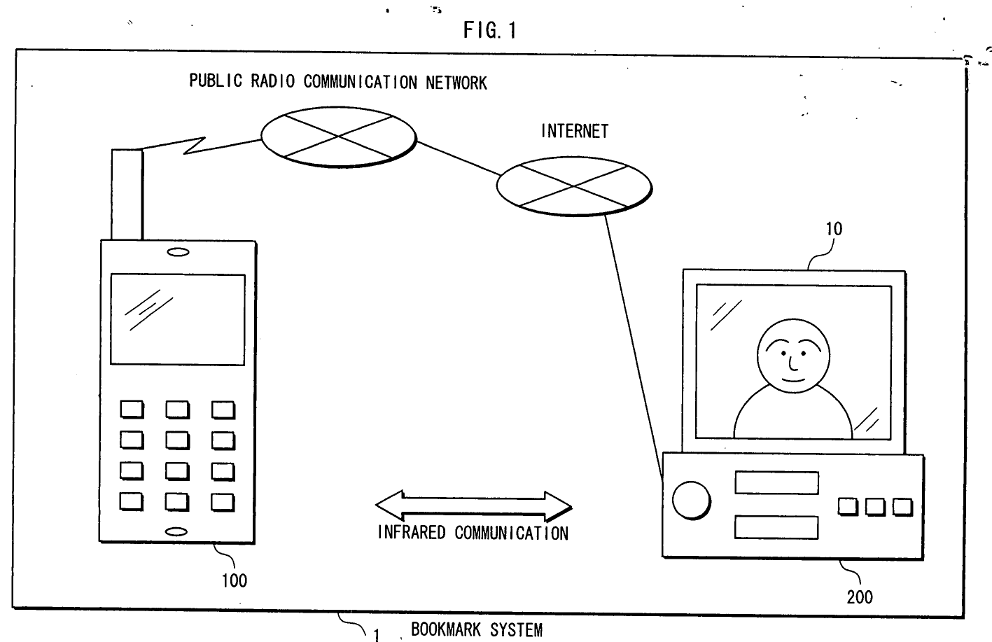

FIG. 1 shows a use form of a bookmark system 1. The bookmark system 1 includes a portable phone 100, a playback apparatus 200 connected to a television 10. The playback apparatus 200 is, for example, a DVD recorder.

The playback apparatus 200 records a program content that is broadcast by a broadcast station, and plays back the recorded program content. To the program content assigned are: a channel number (hereinafter, CH number) of a channel on which the program content was broadcast; a program ID for identifying the program content; and a recording start time at which the recording of the program content was started.

An interactive communication by an infrared communication and a communication by the Internet are available between the portable phone 100 and the playback apparatus 200.

The portable phone 100, while the television 10 is playing back a program content having been recorded by the playback apparatus 200, performs an infrared communication with the playback apparatus 200 and transmits information that indicates performing registration of information related to the image data desired to be referred to later, receives the information related to the image data desired to be referred to later from the playback apparatus 200, and stores the received information. It should be noted here that specifying image data desired to be referred to later is called “bookmarking”.

The portable phone 100 transmits the stored information related to bookmarked image data to the playback apparatus 200 via a public radio communication network and the Internet, receives from the playback apparatus 200 a still image or a moving image related to the bookmarked image data, and displays the received picture.

1.2 Construction of Portable Phone 100

The following describes the construction of the portable phone 100.

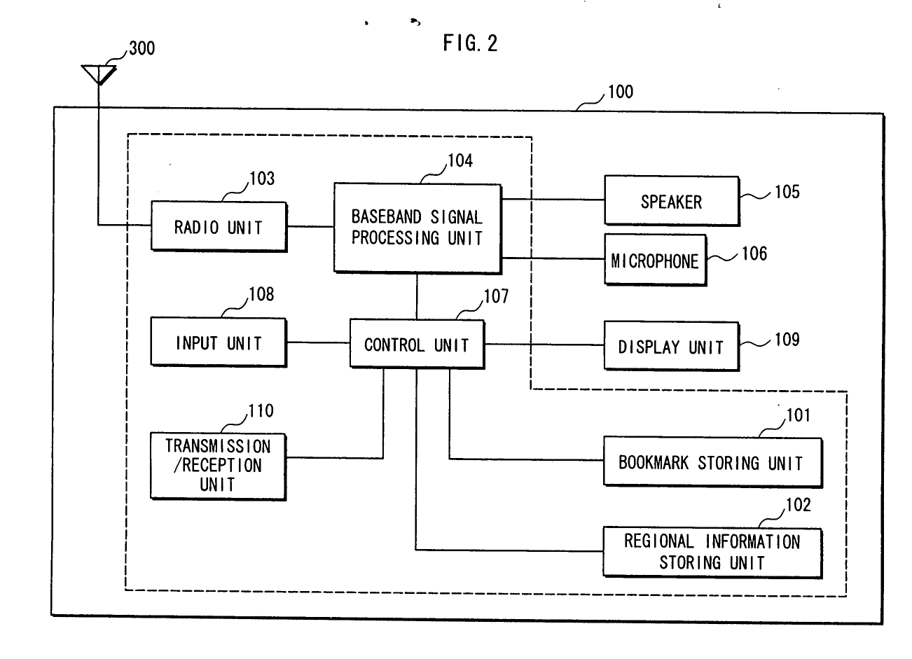

The portable phone 100 is a portable communication terminal apparatus and includes, as shown in FIG. 2, a bookmark storing unit 101, a regional information storing unit 102, a radio unit 103, a baseband signal processing unit 104, a speaker 105, a microphone 106, a control unit 107, an input unit 108, a display unit 109, and a transmission/reception unit 110.

The portable phone 100 is specifically a computer system that includes a microprocessor, ROM, RAM, a display unit and the like. A computer program is stored in the ROM. The microprocessor operates in accordance with the computer program and causes the portable phone 100 to achieve the functions.

(1) Bookmark Storing Unit 101

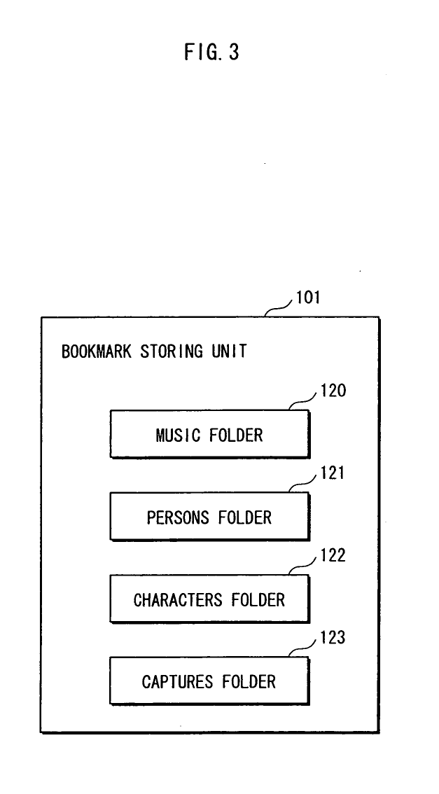

The bookmark storing unit 101 includes, as shown in FIG. 3, a music folder 120, a persons folder 121, a characters folder 122, and a captures folder 123.

<Music Folder 120>

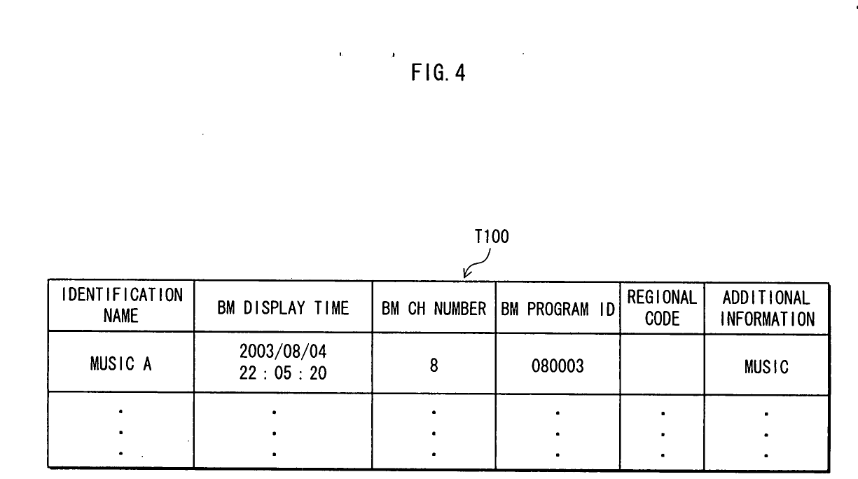

The music folder 120 includes a music information table T100, an example of which is shown in FIG. 4.

The music information table T100 has an area for storing one or more sets of: an identification name; a BM (BookMark) display time; a BM CH number; a BM program ID; a regional code; and additional information. It should be noted here that information composed of an identification name, a BM display time, a BM CH number, a BM program ID, a regional code, and additional information is referred to as bookmark information.

The identification name is a name used for identifying each piece of stored bookmark information. The BM display time is a broadcast time at which bookmarked imaged data was broadcast, and includes a date and a time. The BM CH number is a CH number that corresponds to a bookmarked program content. The BM program ID is a program ID that corresponds to a bookmarked program content. The regional code is information for identifying a region, and corresponds to the local area code for the telephone numbers of the region. The additional information is information that indicates an object of bookmarking.

Here, the regional code may not necessarily be recorded, but may be recorded as necessary.

It should be noted here that the additional information in the music information table T100 is always “music”. Also, the BM program ID is the same as the program ID stored in the playback apparatus 200, which will be described later.

The object of bookmarking is an object that can be recognized by human senses, and information indicating the object of bookmarking is a type of an object that can be recognized by human senses. When the additional information is “music”, the object of bookmarking is output sound/voice, and the sound/voice is an object recognizable by the sense of hearing of human being.

<Persons Folder 121>

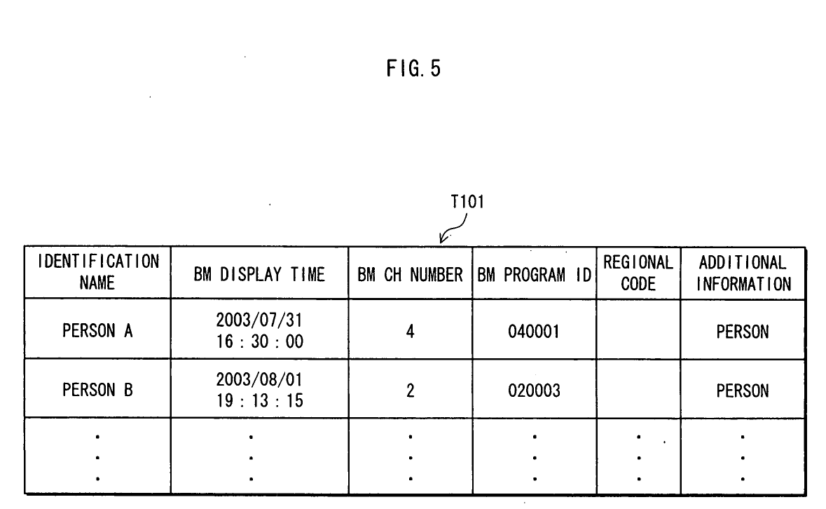

The persons folder 121 includes a persons information table T101, an example of which is shown in FIG. 5.

The description of data structure of the persons information table T101 is omitted since it is the same as that of the music information table T100.

It should be noted here that the additional information in the persons information table T101 is always “person”. When the additional information is “person”, the object of bookmarking is a person image that constitutes part of a displayed image, and the person image is an object that can be recognized by human senses.

<Characters Folder 122>

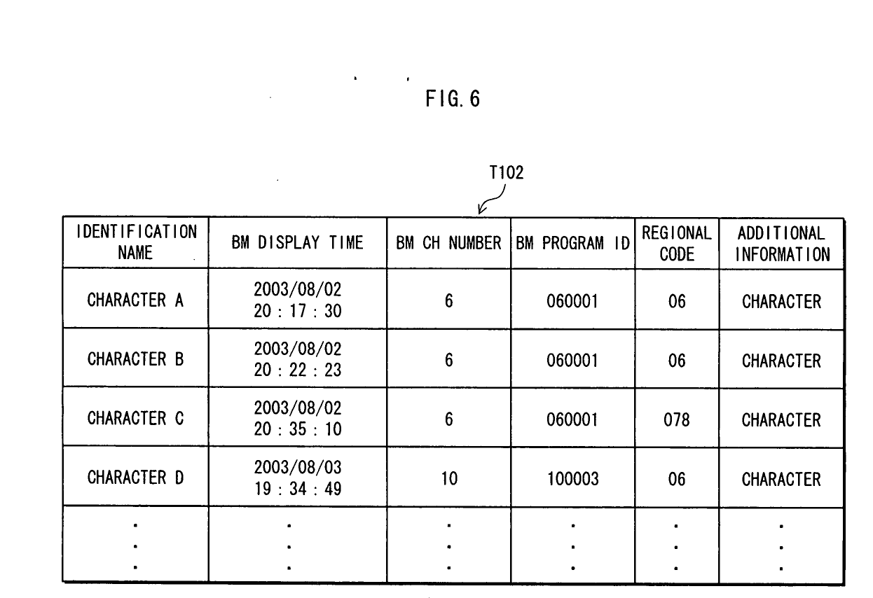

The characters folder 122 includes a characters information table T102, an example of which is shown in FIG. 6.

The description of data structure of the characters information table T102 is omitted since it is the same as that of the music information table T100.

It should be noted here that the additional information in the characters information table T102 is always “character”. When the additional information is “character”, the object of bookmarking is a character that constitutes part of a displayed image, and the character is an object that can be recognized by human senses.

<Captures Folder 123>

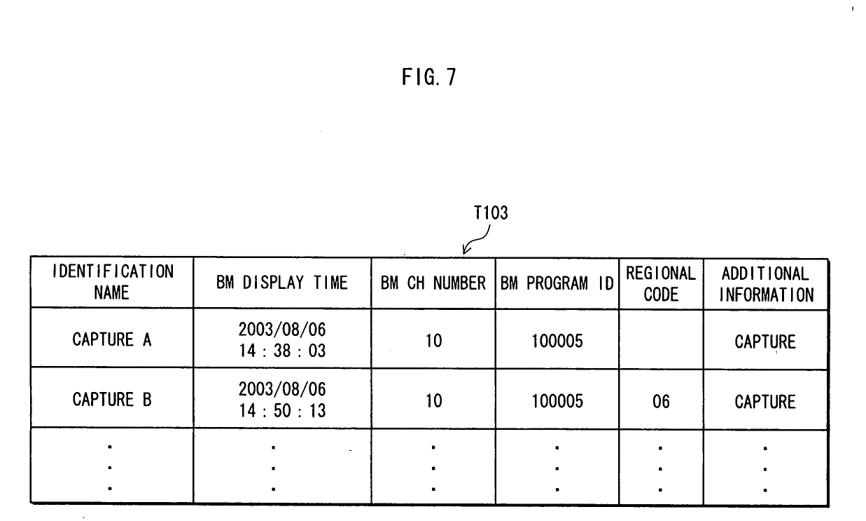

The captures folder 123 includes a captures information table T103, an example of which is shown in FIG. 7.

The description of data structure of the captures information table T103 is omitted since it is the same as that of the music information table T100.

It should be noted here that the additional information in the captures information table T103 is always “capture”. When the additional information is “capture”, the object of bookmarking is a displayed image, and the displayed image is an object that can be recognized by human senses.

(2) Regional Information Storing unit 102

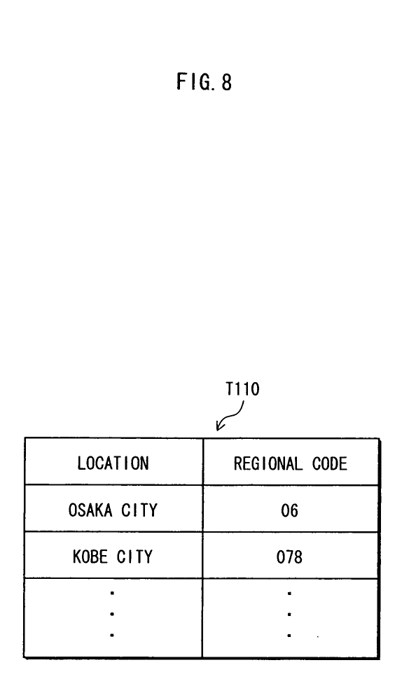

The regional information storing unit 102 includes a regional information table T110, an example of which is shown in FIG. 8.

The regional information table T110 has an area for storing one or more sets of: a location; and a regional code.

Here, the location is information that indicates a name of a region such as Osaka City or Kobe City. The description of the regional code is omitted since it is the same as the regional code provided in the music information table T100.

(3) Radio Unit 103

The radio unit 103, having an antenna 300, performs transmission/reception of radio signals.

(4) Baseband Signal Processing Unit 104

The baseband signal processing unit 104 performs signal processing to output a signal, which was received from the radio unit 103, to the speaker 105. The baseband signal processing unit 104 also performs signal processing to output sound/voice, which was received from the microphone 106, to the radio unit 103.

The baseband signal processing unit 104 further receives information, which has been received via the Internet and the public radio communication network, via the radio unit 103, and outputs the received information to the control unit 107. The baseband signal processing unit 104 further receives sound/voice data from the control unit 107, and performs signal processing to output the received sound/voice data to the speaker 105.

(5) Speaker 105

The speaker 105 outputs signals, which have been processed and output by the baseband signal processing unit 104, as sound/voice.

(6) Microphone 106

The microphone 106 receives sound/voice of the user, and outputs the received sound/voice to the baseband signal processing unit 104.

(7) Control Unit 107

The control unit 107 preliminarily has a GPS (Global Positioning System) function for measuring positions, and controls the entire portable phone 100.

The following describes the controls on the registration of the bookmark information, the display of bookmarked image data according to a specification by the user (hereinafter referred to as “specification display”), and the display of bookmarked image data in relation to a region containing the current position (hereinafter referred to as “regional display”).

<Registration of Bookmark Information>

The control unit 107 receives, from the input unit 108, bookmark instruction information that indicates performing the registration of the bookmark information. When the input unit 108 receives, from the user, regional code information that indicates a regional code, the control unit 107 receives, from the input unit 108, the regional code information together with the bookmark instruction information. The bookmark instruction information includes correspondence information that indicates an object of bookmarking, the object being any of “person”, “music”, “character”, and “capture”. For example, if the object of bookmarking is a person, the correspondence information indicates “person”; if the object of bookmarking is music, the correspondence information indicates “music”; if the object of bookmarking is a character, the correspondence information indicates “character”; and if the object of bookmarking is a capture, the correspondence information indicates “capture”. It should be noted here that information specified by “character” is, for example, a character sequence in a subtitle display. The control unit 107 then transmits the received bookmark instruction information to the playback apparatus 200 via the transmission/reception unit 110 in an infrared communication. The control unit 107 temporarily stores the bookmark instruction information it has transmitted. These functions constitute an information transmitting unit that transmits information that indicates a type of an object of bookmarking (correspondence information).

The control unit 107 receives program information composed of the BM display time, BM CH number, and BM program ID from the playback apparatus 200 via the transmission/reception unit 110, and further receives identification name information that indicates an identification name from the input unit 108. These functions constitute a time receiving unit that receives program information containing the BM display time.

The control unit 107 generates bookmark information from the identification name information, the received program information, the regional code information, and the correspondence information that is included in the temporarily stored bookmark instruction information. It should be noted here that the regional code included in the bookmark information is recorded only if the regional code information is received together with the bookmark instruction information from the input unit 108.

The control unit 107 records the generated bookmark information into any of the music information table T100, the persons information table T101, the characters information table T102, and the captures information table T103, according to the additional information included in the generated bookmark information. That is to say, if it judges that the additional information included in the generated bookmark information is music, the control unit 107 records the generated bookmark information into the music information table T100; if it judges that the additional information is person, the control unit 107 records the generated bookmark information into the persons information table T101; if it judges that the additional information is character, the control unit 107 records the generated bookmark information into the characters information table T102; and if it judges that the additional information is capture, the control unit 107 records the generated bookmark information into the captures information table T103. These functions constitute an information writing unit that writes the bookmark information to the bookmark storing unit 101.

<Specification Display>

The control unit 107, upon receiving from the input unit 108 display start information that indicates starting display of bookmarked image data, outputs, to the display unit 109, selection instruction information that urges selection of a storage destination of the bookmark information, and receives information of the selected storage destination from the input unit 108. Here, the information of the selected storage destination is information that indicates any of the music folder 120, persons folder 121, characters folder 122, and captures folder 123.

The control unit 107 further acquires an identification name that is included in the bookmark information recorded in the folder indicated by the information of the selected storage destination. For example, if the information of the selected storage destination indicates the persons folder, the control unit 107 acquires identification names “person A” and “person B” from all the bookmark information recorded in the persons folder 121 of the bookmark storing unit 101.

The control unit 107 generates list information that is composed of all of the acquired identification names, and outputs the generated list information to the display unit 109. For example, if the acquired identification names are “person A” and “person B”, the control unit 107 generates list information that is composed of “person A” and “person B”.

The control unit 107, upon receiving from the input unit 108 information of the selected identification name, acquires from the bookmark storing unit 101 bookmark information that corresponding to the received information of the selected identification name. For example, if the information of the selected identification name indicates “person B”, the control unit 107 acquires bookmark information that includes identification name “person B”, from the persons folder 121 of the bookmark storing unit 101.

The control unit 107 transmits the acquired bookmark information and the received display start information to the playback apparatus 200 via the radio unit 103 using a public radio communication network and the Internet.

These functions constitute an instruction transmitting unit that transmits information that indicates the bookmark information and a display instruction.

The control unit 107 receives image data of a still image or a moving image related to the transmitted bookmark information, from the playback apparatus 200 via the radio unit 103 using a public radio communication network and the Internet. When it receives image data of a moving image, the control unit 107 also receives sound/voice data related to the moving image. These functions constitute a content receiving unit that receives a partial content composed of a still image or a partial content composed of a moving image and sound/voice.

The control unit 107 displays, via the display unit 109, a still image or a moving image based on the received image data of the still image or the received image data of the moving image. When it also receives sound/voice data related to the moving image, the control unit 107 outputs the received sound/voice data to the speaker 105 via the baseband signal processing unit 104. This enables the control unit 107 to play back the received moving image.

These functions constitute a content outputting unit that outputs a partial content composed of a still image or a partial content composed of a moving image and sound/voice.

<Regional Display>

The control unit 107, upon receiving from the input unit 108 regional display information that indicates a display of bookmarked image data related to a region containing the current position, measures the current position using the GPS function. The control unit 107 acquires from the regional information storing unit 102 a regional code that corresponds to the region detected by the measurement. These functions constitute an identifier acquiring unit that acquires a regional code.

The control unit 107 acquires all the bookmark information that matches the regional code acquired from the bookmark storing unit 101, namely, all the bookmark information that includes the acquired regional code. For example, if the current position is Osaka City, the control unit 107 acquires all the bookmark information that includes a regional code “06”. In this case, the control unit 107 acquires from the characters folder 122 the bookmark information that includes identification names “character A”, “character B”, and “character D”, and acquires from the captures folder 123 the bookmark information that includes identification name “capture B”. These functions constitute an information acquiring unit that acquires the bookmark information.

The control unit 107 transmits all the acquired bookmark information and display start information that indicates starting display of a bookmarked image data, to the playback apparatus 200 via the radio unit 103 using a public radio communication network and the Internet. These functions constitute the instruction transmitting unit as in the case described earlier. That is to say, the instruction transmitting unit is a component that transmits the bookmark information and the display start information.

The control unit 107 receives image data of a still image or a moving image related to the transmitted bookmark information, from the playback apparatus 200 via the radio unit 103 using a public radio communication network and the Internet. When it receives image data of a moving image, the control unit 107 also receives sound/voice data related to the moving image. These functions constitute the content receiving unit as in the case described earlier.

The control unit 107 displays, via the display unit 109, a still image or a moving image based on the received image data of the still image or the received image data of the moving image. When it also receives sound/voice data related to the moving image, the control unit 107 outputs the received sound/voice data to the speaker 105 via the baseband signal processing unit 104. These functions constitute the content outputting unit as in the case described earlier.

When it transmits a plurality of pieces of bookmark information to the playback apparatus 200, the control unit 107 receives still images or pairs of a moving image and sound/voice that are respectively related to the transmitted plurality of pieces of bookmark information. In such a case, the control unit 107 receives preceding image information that instruct to switch to a preceding still or moving image, or receives subsequent image information that instruct to switch to a subsequent still or moving image, and controls still or moving images to be displayed on the display unit 109.

(8) Input Unit 108

The input unit 108 includes a keyboard equipped with numerical input keys and the like for input functions and receives instructions input by the user.

The input unit 108 receives the bookmark instruction information, and outputs the received bookmark instruction information to the control unit 107. The input unit 108 also receives the regional code information, and outputs the received regional code information to the control unit 107. It should be noted here that the regional code information is received together with the bookmark instruction information, and is output to the control unit 107 together with the bookmark instruction information.

The input unit 108 further receives the identification name information, and outputs the received identification name information to the control unit 107.

Upon receiving the display start information, the input unit 108 outputs the received display start information to the control unit 107, and receives a selection of a storage destination of the bookmark information. The input unit 108 then outputs the information of the selected storage destination to the control unit 107, receives a selection of a bookmark identification name, and outputs the information of the selected identification name to the control unit 107.

Upon receiving the regional display information, the input unit 108 outputs the received regional display information to the control unit 107. Upon receiving the preceding image information, the input unit 108 outputs the received preceding image information to the control unit 107. Upon receiving the subsequent image information, the input unit 108 outputs the received subsequent image information to the control unit 107.

These functions constitute a reception unit.

(9) Display Unit 109

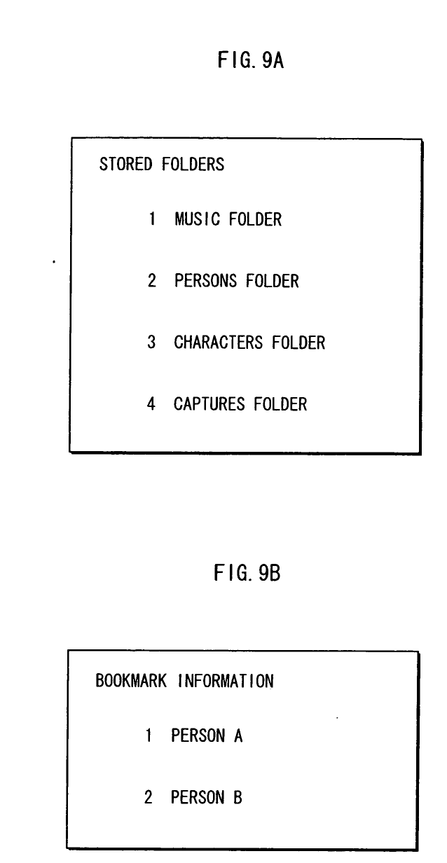

The display unit 109, upon receiving selection instruction information from the control unit 107, assigns different numbers to folder names of the folders included in the bookmark storing unit 101, and displays pairs of an assigned number and a folder name, as shown in FIG. 9A as an example.

This enables the portable phone 100 to urge the user to select a storage destination of the bookmarked information, and enables the user to select a storage destination of the bookmarked information by inputting a number displayed on the display unit 109.

The display unit 109, upon receiving the list information from the control unit 107 after the input unit 108 receives a selection of a storage destination, assigns different numbers to all identification names included in the received list information, and displays pairs of an assigned number and an identification name. FIG. 9B shows that all identification names included in the received list information are displayed when the persons folder is selected as the storage destination from the folders shown in FIG. 9A.

This enables the portable phone 100 to urge the user to select a piece of bookmark information, and enables the user to select a piece of bookmark information by inputting a number displayed on the display unit 109 from the input unit 108.

The display unit 109 displays a still image or a moving image based on image data of the still image or image data of the moving image received from the control unit 107.

(10) Transmission/Reception Unit 110

The transmission/reception unit 110 transmits information, which has been received from the control unit 107, to the playback apparatus 200 by an infrared communication.

The transmission/reception unit 110 also receives information from the playback apparatus 200 by an infrared communication, and outputs the received information to the control unit 107.

1.3 Construction of Playback Apparatus 200

Here, the construction of the playback apparatus 200 will be described.

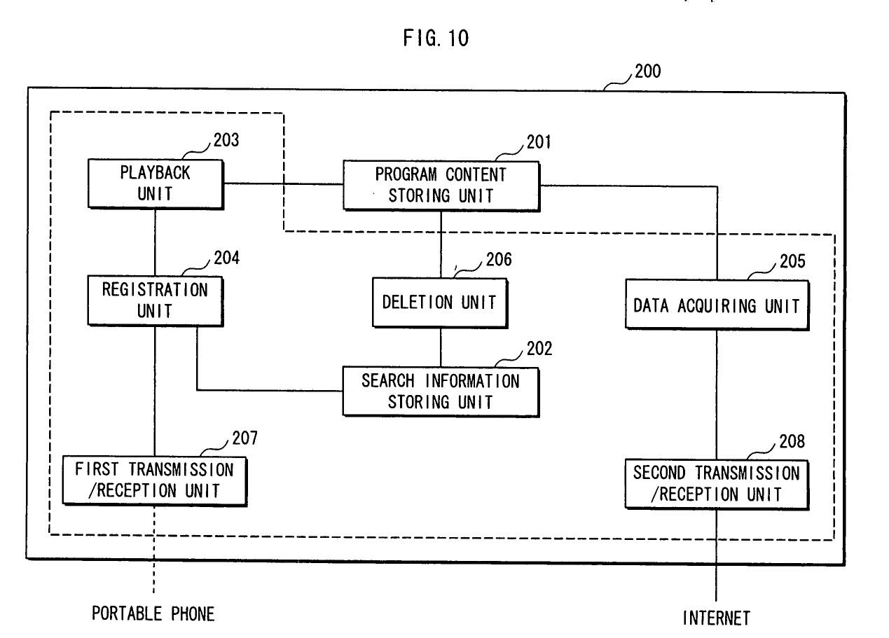

The playback apparatus 200 includes, as shown in FIG. 10, a program content storing unit 201, a search information storing unit 202, a playback unit 203, a registration unit 204, a data acquiring unit 205, a deletion unit 206, a first transmission/reception unit 207, and a second transmission/reception unit 208.

The playback apparatus 200 is specifically a computer system that includes a microprocessor, ROM, RAM, a hard disk unit and the like. A computer program is stored in the ROM. The microprocessor operates in accordance with the computer program and causes the playback apparatus 200 to achieve the functions.

(1) Program Content Storing Unit 201

The program content storing unit 201 has an area for storing one or more recorded program contents each with indication of correspondence with a CH number, a program ID, and a recording start time.

Each of the program contents recorded in the program content storing unit 201 includes: image data composed of a plurality of consecutive frames (still images) aligning along a time axis; and sound/voice data that indicates sound/voice of each frame. It should be noted here that when it records a program content, the playback apparatus 200 assigns a program ID to the program content.

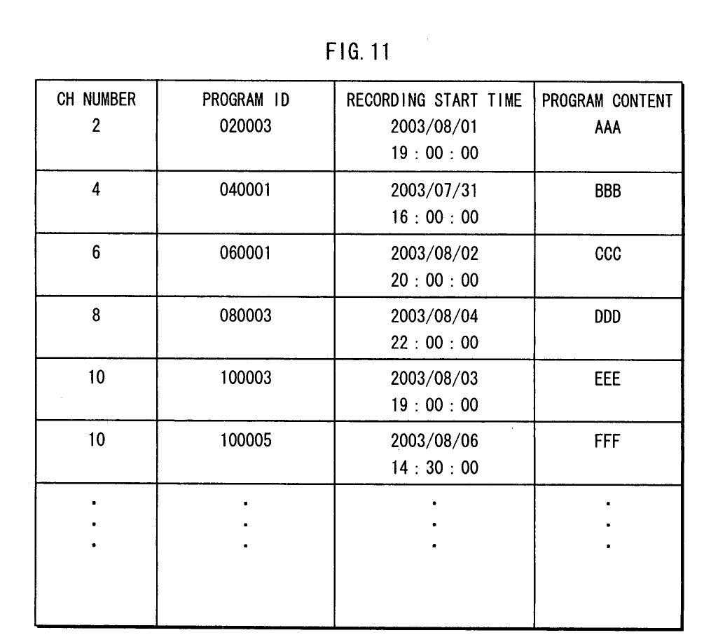

For example, as shown in FIG. 11 as an example, the program content “AAA” is recorded in correspondence with a CH number “2”, a program ID “020003”, and a recording start time “2003/08/01 19:00:00”.

These functions constitute a content storing unit that preliminarily records therein program contents.

(2) Search Information Storing Unit 202

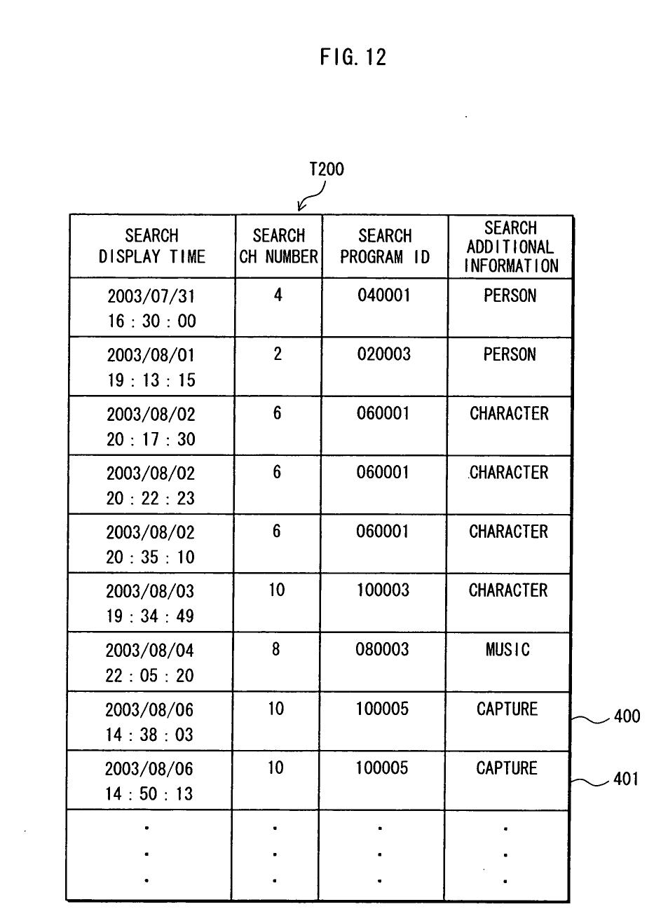

The search information storing unit 202 includes a search information table T200, an example of which is shown in FIG. 12.

The search information table T200 has an area for storing one or more sets of: a search display time; a search CH number; a search program ID; and search additional information. It should be noted here that information composed of a search display time, a search CH number, a search program ID, and search additional information is referred to as search information.

The search display time is a broadcast time at which bookmarked imaged data was broadcast, and is indicated by a date and a time. The search CH number is a CH number that corresponds to a bookmarked program content. The search program ID is a program ID that corresponds to a bookmarked program content. The search additional information is information that indicates an object of bookmarking, which is any of “music”, “person”, “character”, and “capture”.

(3) Playback unit 203

The playback unit 203 includes a playback information storage area for storing CH numbers, program IDs, and recording start times that correspond to program contents to be played back, respectively.

The playback unit 203 plays back a program content stored in the program content storing unit 201. When it plays back a program content, the playback unit 203 stores into the playback information storage area a CH number, a program ID, and a recording start time that correspond to the program content to be played back, and deletes the CH number, program ID, and recording start time when it ends the playback of the program content.

(4) Registration Unit 204

The registration unit 204 counts the number of frames played back in a playback of a program content by the playback unit 203.

The registration unit 204 receives, during a playback of a program content, the bookmark instruction information from the portable phone 100 via the first transmission/reception unit 207 through an infrared communication. These functions constitute an information receiving unit that receives information that indicates a type of an object of bookmarking (correspondence information).

The registration unit 204 calculates, from the number of frames counted until before the bookmark instruction information is received, an elapse time for a section that extends between image data at the start of the program content and image data being played back by the playback unit 203 when the bookmark instruction information is received. The registration unit 204 acquires the recording start time stored in the playback unit 203, and adds the calculated elapse time to the acquired recording start time to acquire the broadcast time of the image data that corresponds to the time at which the bookmark instruction information is received. The registration unit 204 further acquires the CH number and program ID that correspond to the program content being played back by the playback unit 203.

In general, a program content broadcast by the NTSC (National Television System Committee) method includes 30 frames (still images) per second of image data. In this case, the elapse time for a section that extends to the bookmarked imaged data can be detected in units of approximately 33 milliseconds. In the present embodiment, however, it is supposed that the elapse time is calculated in units of minutes and seconds to be added to the recording start time, for the sake of simplicity. It is also possible to identify a frame at the time when the bookmark instruction information is received, from the acquired broadcast time by taking into consideration the relationship between the acquired broadcast and the number of frames that are played back per second.

These functions constitute a position acquiring unit that acquires information (in the present example, the broadcast time) that indicates a position in the program content corresponding to the time when the bookmark instruction information is received.

The registration unit 204 generates program information from the acquired broadcast time, CH number, and program ID, and transmits the generated program information to the portable phone 100 via the first transmission/reception unit 207 through an infrared communication. These functions constitute a time transmitting unit that transmits program information that includes a broadcast time.

The registration unit 204 also generates search information from the acquired broadcast time, the correspondence information included in the received bookmark instruction information, and the CH number and program ID acquired from the playback unit 203, and writes the generated search information to the search information table T200.

It should be noted here that the search display time, search CH number, search program ID, and search additional information included in the search information respectively match the BM display time, BM CH number, BM program ID, and additional information included in the bookmark information that is generated in the portable phone 100 using the transmitted program information. This is because the search display time and the BM display time use the broadcast time calculated by the registration unit 204, and because the search CH number, the search program ID, the BM CH number, and the BM program ID use the CH number and the program ID that are acquired by the registration unit 204, and because the search additional information and the additional information use the correspondence information included in the bookmark information. This indicates that the correspondence between the search information and the bookmark information can be utilized.

(5) Data Acquiring Unit 205

The data acquiring unit 205 preliminarily stores: the number of still images (for example, 300) that constitute a moving image to be transmitted to the portable phone 100; a program that performs a music recognition process (hereinafter the program is referred to as “music recognition process”); a program that performs a person recognition process (hereinafter the program is referred to as “person recognition process”); a program that performs a character recognition process (hereinafter the program is referred to as “character recognition process”); a program that performs a capture recognition process (hereinafter the program is referred to as “capture recognition process”).

The music recognition process is a process in which a music start frame, which is positioned at the start of a music section that is a section in which a characteristic sound is repeated cyclically, is searched using a predetermined algorithm. The person recognition process is a process in which a person start frame, in which a person indicated by the image data corresponding to the BM display time included in the bookmark information appears for the first time in the image data of the program content, is searched using a predetermined algorithm. The character recognition process is a process in which a character start frame, in which a subtitle appears for the first time in the image data of the program content, is searched using a predetermined algorithm. The capture recognition process is a process in which a capture start frame, which is a start frame of a scene switched from another scene, is searched using a predetermined algorithm, where each scene is composed of a plurality of frames that were shot consecutively in time. It should be noted here that hereinafter the program that performs the music recognition process, the program that performs the person recognition process, the program that performs the character recognition process, and the program that performs the capture recognition process are referred to as the music recognition process, the person recognition process, the character recognition process, and the capture recognition process, respectively.

Upon receiving the bookmark information and the display start information from the portable phone 100 via the second transmission/reception unit 208, the data acquiring unit 205 acquires from the program content storing unit 201 a program content that corresponds to the BM CH number and the BM program ID that are included in the received bookmark information. Here, there is a possibility that there are a plurality of program contents that correspond to the BM CH number and the BM program ID, due to deletion of program contents which will be described later. In such a case, the data acquiring unit 205 acquires a plurality of program contents that correspond to the BM CH number and the BM program ID, and then acquires from those a program content that has a recording start time that matches the time indicated by the BM display time included in the bookmark information. This makes it possible to acquires one program content even if there are a plurality of program contents that correspond to the BM CH number and the BM program ID.

After this, the data acquiring unit 205 acquires a still image or a moving image from the acquired program content by the acquisition method described below. These functions constitute a partial content acquiring unit that acquires a bookmarked still image or moving image from the program content.

The data acquiring unit 205 transmits the acquired still image or moving image to the portable phone 100 via the second transmission/reception unit 208, as image data. When it transmits image data of a moving image, the data acquiring unit 205 also transmits sound/voice data related to the moving image.

<Acquisition Method>

The data acquiring unit 205 judges whether or not the additional information included in the bookmark information is “music”. If it judges that the additional information is “music”, the data acquiring unit 205 detects in the program content a music start frame that is before and closest to the frame indicated by the BM display time, by performing the music recognition process using the BM display time included in the bookmark information and the program content acquired from the program content storing unit 201. The data acquiring unit 205 then acquires, by copying, 300 consecutive frames starting with the detected music start frame. The data acquiring unit 205 also acquires, by copying, sound/voice data that corresponds to each of the acquired frames. That is to say, the data acquiring unit 205 acquires 300 frames including the music start frame and the sound/voice data corresponding to the frames, by copying. This indicates that the data acquiring unit 205 acquires a moving image and the sound/voice by copying.

If it judges that the additional information is not “music”, the data acquiring unit 205 judges whether or not the additional information is “person”. If it judges that the additional information is “person”, the data acquiring unit 205 detects in the program content a person start frame that is before and closest to the frame indicated by the BM display time, by performing the person recognition process using the BM display time included in the bookmark information and the program content acquired from the program content storing unit 201. The data acquiring unit 205 then acquires the detected person start frame by copying.

If it judges that the additional information is not “person”, the data acquiring unit 205 judges whether or not the additional information is “character”. If it judges that the additional information is “character”, the data acquiring unit 205 detects in the program content a character start frame that is before and closest to the frame indicated by the BM display time, by performing the character recognition process using the BM display time included in the bookmark information and the program content acquired from the program content storing unit 201. The data acquiring unit 205 then acquires the detected character start frame by copying.

If it judges that the additional information is not “character”, that is to say, if it judges that the additional information is “capture”, the data acquiring unit 205 detects in the program content a capture start frame that is before and closest to the frame indicated by the BM display time, by performing the capture recognition process using the BM display time included in the bookmark information and the program content acquired from the program content storing unit 201. The data acquiring unit 205 then acquires the detected capture start frame by copying.

It should be noted here that the phrase “being before the frame” means that the position in question is between the program content start position and the position indicated by the BM display time.

(6) Deletion Unit 206

The deletion unit 206 preliminarily stores the music recognition process, the person recognition process, the character recognition process, and the capture recognition process, as is the case with the data acquiring unit 205.

The deletion unit 206 receives, from the user, deletion instruction information that indicates performing deletion of a program content recorded in the program content storing unit 201. The deletion instruction information is information that includes a program ID.

The deletion unit 206 acquires, from the program content storing unit 201, a program content that corresponds to the program ID included in the received deletion instruction information, and acquires, from the search information storing unit 202, all pieces of search information that include a search program ID matching the program ID.

The deletion unit 206 repeats the following deletion method as many times as the number of acquired pieces of search information, using the acquired program content and search information.

<Deletion Method>

The deletion unit 206 judges whether or not the search additional information included in the search information is “music”. If it judges that the search additional information is “music”, the deletion unit 206 detects in the program content a music start frame that is before and closest to the search display time, by performing the music recognition process using the search display time included in the search information and the acquired program content. The deletion unit 206 then acquires, by copying, music sound/voice image data that is composed of (a) consecutive frames of a preliminarily set time period (for example, three minutes) starting with the detected music start frame and (b) the sound/voice data, and temporarily stores the acquired music sound/voice image data with indication of correspondence with the program ID, CH number, and search display time.

If it judges that the search additional information included in the search information is not “music”, the deletion unit 206 judges whether or not the search additional information is “person”. If it judges that the search additional information is “person”, the deletion unit 206 detects in the program content a person start frame that is before and closest to the search display time, by performing the person recognition process using the search display time included in the search information and the program content acquired from the program content storing unit 201. The deletion unit 206 then acquires, by copying, person sound/voice image data that is composed of (a) consecutive frames of a preliminarily set time period (for example, three minutes) starting with the detected person start frame and (b) the sound/voice data, and temporarily stores the acquired person sound/voice image data with indication of correspondence with the program ID, CH number, and search display time.

If it judges that the search additional information included in the search information is not “person”, the deletion unit 206 judges whether or not the search additional information is “character”. If it judges that the search additional information is “character”, the deletion unit 206 detects in the program content a character start frame that is before and closest to the search display time, by performing the character recognition process using the search display time included in the search information and the program content acquired from the program content storing unit 201. The deletion unit 206 then acquires, by copying, character sound/voice image data that is composed of (a) consecutive frames of a preliminarily set time period (for example, three minutes) starting with the detected character start frame and (b) the sound/voice data, and temporarily stores the acquired character sound/voice image data with indication of correspondence with the program ID, CH number, and search display time.

If it judges that the search additional information included in the search information is not “character”, that is to say, if it judges that the search additional information is “capture”, the deletion unit 206 detects in the program content a capture start frame that is before and closest to the search display time, by performing the capture recognition process using the search display time included in the search information and the program content acquired from the program content storing unit 201. The deletion unit 206 then acquires, by copying, capture sound/voice image data that is composed of (a) consecutive frames of a preliminarily set time period (for example, three minutes) starting with the detected capture start frame and (b) the sound/voice data, and temporarily stores the acquired capture sound/voice image data with indication of correspondence with the program ID, CH number, and search display time.

Hereinafter, the music, person, character, and capture sound/voice image data is generically referred to as sound/voice image data when there is no need for distinction between them.

After it performs the above-described operation onto each piece of search information acquired from the search information storing unit 202, the deletion unit 206 deletes the program content, and stores the temporarily stored sound/voice image data into the program content storing unit 201. At this point in time, the recording start time is the date and time indicated by the search display time.

With the above-described operation, the image data and sound/voice image data that are in the vicinity of the bookmarked image data are stored even after the program content is deleted, thus enabling the user to refer to the stored data.

<Example>

Here will be described the contents of the data to be stored in the program content storing unit 201 after the program content, which corresponds to a plurality of pieces of search information, is deleted.

For example, with reference to FIG. 11, when a program content “FFF” having a program ID “100005” is to be deleted, the deletion unit 206 first acquires search information 400 and 401 from the search information storing unit 202. The deletion unit 206 then refers to the search display time included in the acquired search information 400, and acquires the capture sound/voice image data (hereinafter referred to as “FFF-1”) that is in the vicinity of the time indicated by the search display time, and temporarily stores the acquired FFF-1 with indication of correspondence with a program ID, a CH number, and a search display time. The deletion unit 206 further refers to the search display time included in the acquired search information 401, and acquires the capture sound/voice image data (hereinafter referred to as “FFF-2”) that is in the vicinity of the time indicated by the search display time, and temporarily stores the acquired FFF-2 with indication of correspondence with a program ID, a CH number, and a search display time.

The deletion unit 206 then deletes “FFF” from the program content storing unit 201, and deletes the program ID, CH number, and recording start time that correspond to the “FFF”. The deletion unit 206 stores the temporarily stored capture sound/voice image data “FFF-1” and “FFF-2” into the program content storing unit 201.

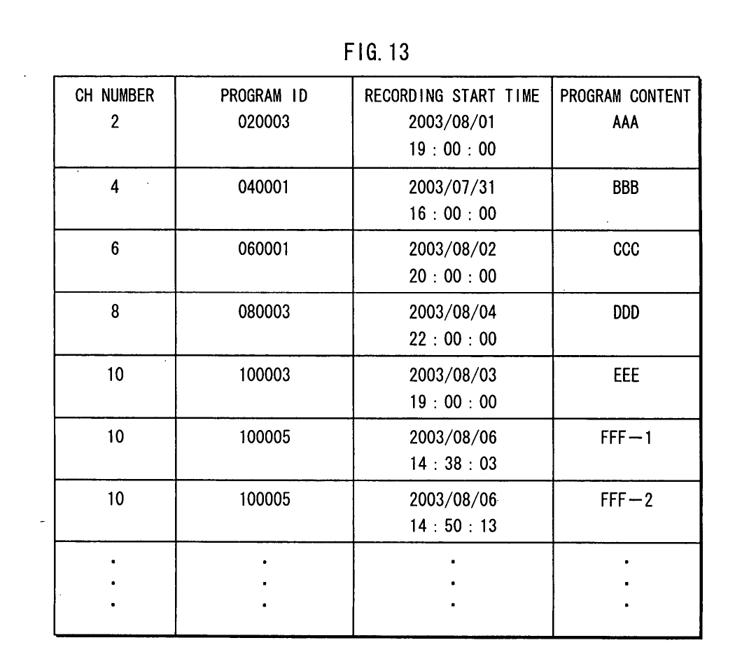

FIG. 13 shows the contents of the data stored in the program content storing unit 201 at this point in time. As described above, the program content “FFF” has been deleted, and “FFF-1” and “FFF-2” have been stored.

(7) First Transmission/Reception Unit 207

The first transmission/reception unit 207 outputs the information received from the portable phone 100 through an infrared communication to the registration unit 204.

The first transmission/reception unit 207 transmits the information received from the registration unit 204 to the portable phone 100 through an infrared communication.

(8) Second Transmission/Reception Unit 208

The second transmission/reception unit 208 outputs the information received from the portable phone 100 via the Internet to the data acquiring unit 205.

The second transmission/reception unit 208 transmits the information received from the data acquiring unit 205 to the portable phone 100 via the Internet.

1.4 Operation of Bookmark System 1

The following describes the operation of the bookmark system 1.

(1) Outline of Bookmark Information Registration

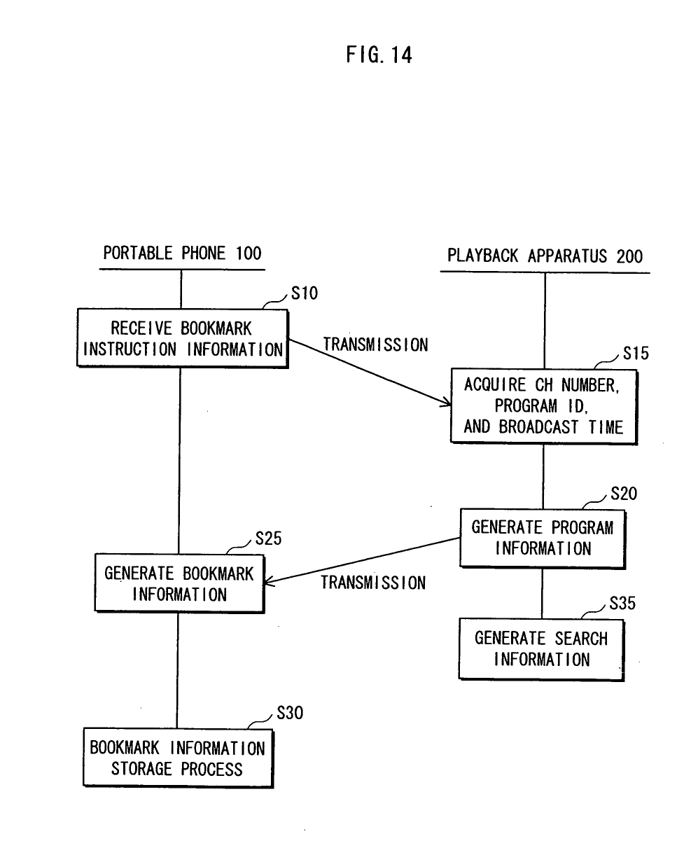

The outline of the operation of bookmark information registration will be described with reference to the flowchart shown in FIG. 14.

When the portable phone 100 receives the bookmark instruction information from the user, the portable phone 100 transmits the received bookmark instruction information to the playback apparatus 200 (step S10).

Upon receiving the bookmark instruction information from the portable phone 100, the playback apparatus 200 acquires a CH number, a program ID, and the broadcast time of the bookmarked image data (step S15), generates program information using the acquired broadcast time, CH number, and program ID, and transmits the generated program information to the portable phone 100 (step S20). It should be noted here that in step S15, the broadcast time can be acquired by calculating an elapse time being a time period that has elapsed at the time when the bookmark instruction information is received, and adding the calculated elapse time to the recording start time of the program content being played back.

The portable phone 100 receives the program information from the playback apparatus 200 and an identification name from the input unit 108, and generates bookmark information using the bookmark instruction information received in step S10, the received identification name, and the received program information (step S25). The portable phone 100 then stores the generated bookmark information into the bookmark storing unit 101 by performing the bookmark information storage process, which differs depending on the contents of the additional information included in the generated bookmark information (step S30). It should be noted here that in step S10, only if the portable phone 100 receives regional code information together with the bookmark instruction information from the user, the regional code indicated by the received regional code information is recorded in the regional code included in the generated bookmark information.

The playback apparatus 200 generates search information using the bookmark instruction information received in step S15, and the broadcast time, CH number, and program ID acquired in step S15, and stores the generated search information into the search information storing unit 202 (step S35).

(2) Operation Outline of Specification Display

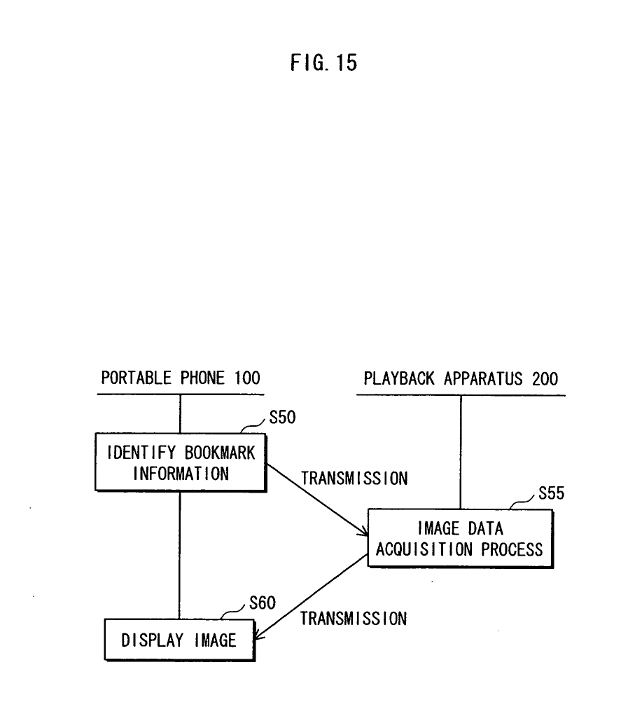

Here will be described the outline of the operation of the specification display, with reference to the flowchart shown in FIG. 15.

When it receives an identification name that is selected and input by the user, the portable phone 100 transmits to the playback apparatus 200 the bookmark information, which corresponds to the received identification name, and the display start information (step S50).

Upon receiving the bookmark information and the display start information from the portable phone 100, the playback apparatus 200 acquires image data that corresponds to the received bookmark information by performing the image data acquisition process, and transmits the acquired image data to the portable phone 100 (step S55).

Upon receiving the image data from the playback apparatus 200, the portable phone 100 displays an image based on the received image data (step S60).

(3) Operation Outline of Region Display

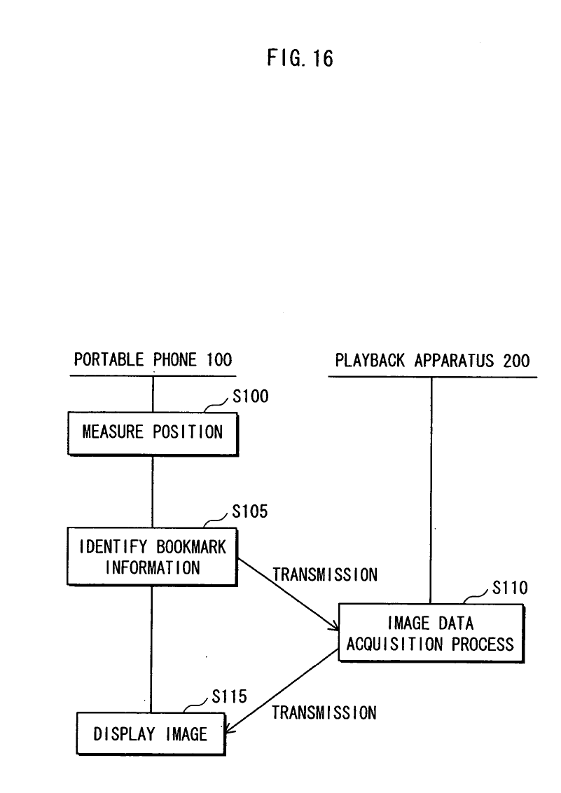

Here will be described the outline of the operation of the region display, with reference to the flowchart shown in FIG. 16.

When it receives regional display information from the user, the portable phone 100 measures the current position using the GPS function, and acquires a regional code of a region in which the portable phone 100 is currently positioned, from he measurement result (step S100). The portable phone 100 then acquires from the bookmark storing unit 101 the bookmark information that includes the acquired regional code, and transmits the acquired bookmark information and the display start information to the playback apparatus 200 (step S105).

Upon receiving the bookmark information from the portable phone 100, the playback apparatus 200 acquires image data that corresponds to the received bookmark information by performing the image data acquisition process, and transmits the acquired image data to the portable phone 100 (step S110).

Upon receiving the image data from the playback apparatus 200, the portable phone 100 displays an image based on the received image data (step S115).

It should be noted here that if the portable phone 100 acquires a plurality of pieces of bookmark information in step S105, the portable phone 100 transmits all the acquired pieces of bookmark information to the playback apparatus 200, then in step S110, the playback apparatus 200 acquires image data that corresponds to each of the received pieces of bookmark information and transmits the all the acquired image data to the portable phone 100, and in step S115, the portable phone 100 receives the preceding image information or the subsequent image information and controls the displaying of the image.

(4) Operation of Bookmark Information Storage Process

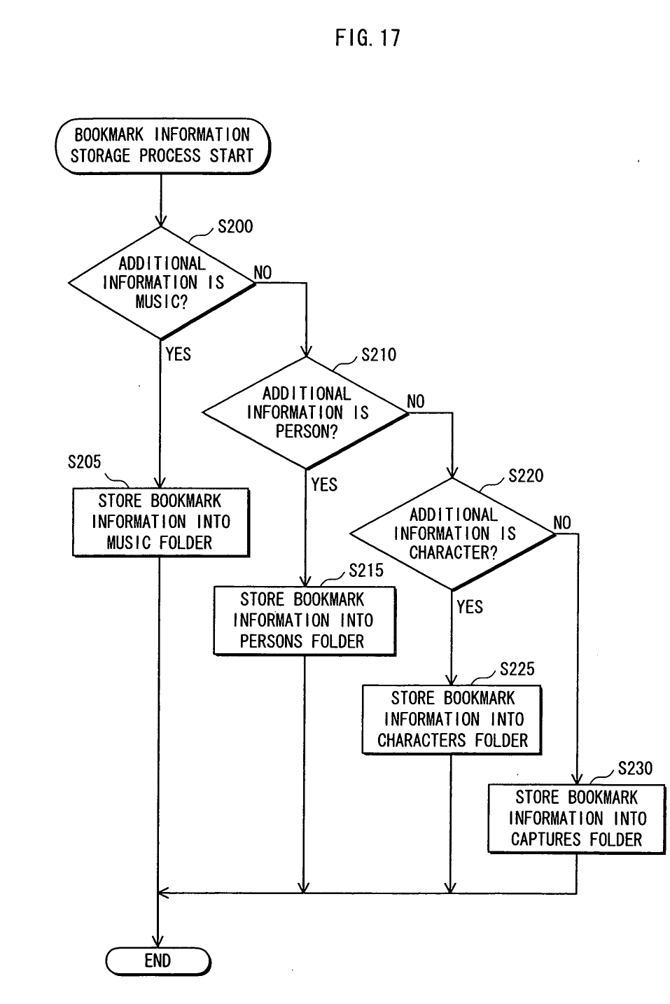

Here will be described the operation of the bookmark information storage process performed by the portable phone 100, with reference to the flowchart shown in FIG. 17.

The control unit 107 judges whether or not the additional information included in the bookmark information is “music” (step S200).

If it judges that the additional information is “music”, the control unit 107 writes the bookmark information into the music folder 120 (step S205), and if it judges that the additional information is not “music”, the control unit 107 judges whether or not the additional information is “person” (step S210).

If it judges that the additional information is “person”, the control unit 107 writes the bookmark information into the persons folder 121 (step S215), and if it judges that the additional information is not “person”, the control unit 107 judges whether or not the additional information is “character” (step S220).

If it judges that the additional information is “character”, the control unit 107 writes the bookmark information into the characters folder 122 (step S225), and if it judges that the additional information is not “character”, that is to say, if it judges that the additional information is “capture”, the control unit 107 writes the bookmark information into the captures folder 123 (step S230).

(5) Image Data Acquisition Process

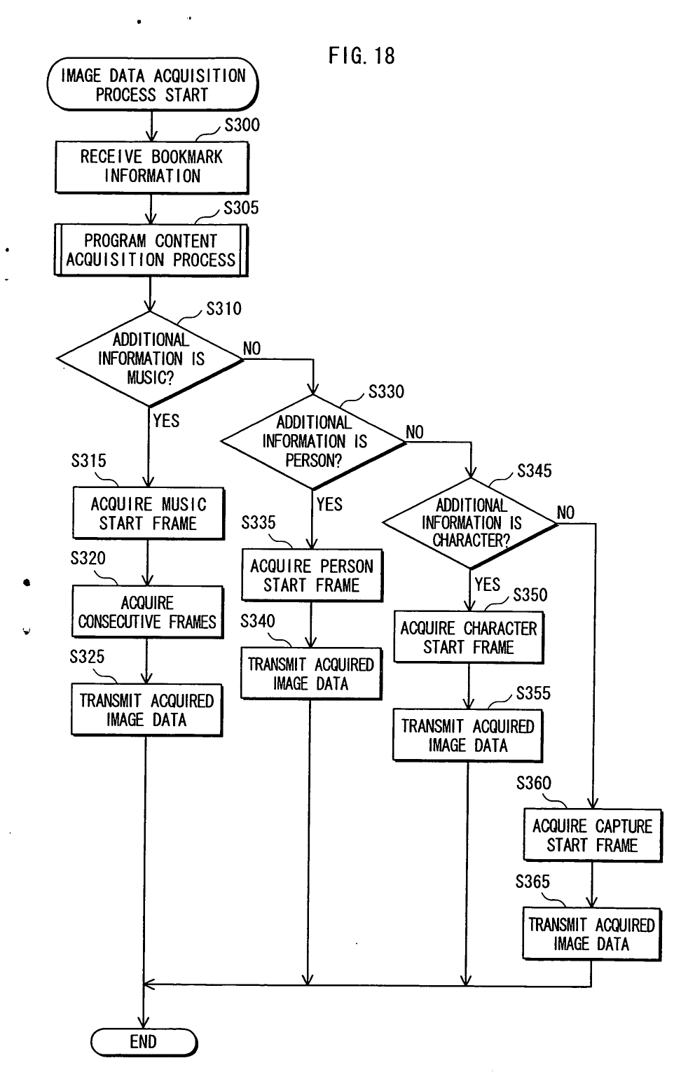

Here will be described the operation of the image data acquisition process performed by the playback apparatus 200, with reference to the flowchart shown in FIG. 18.

The data acquiring unit 205 receives the bookmark information from the portable phone 100 (step S300), and performs the program content acquisition process using the received bookmark information so as to acquire a program content corresponding to the received bookmark information from the program content storing unit 201 (step S305).

The data acquiring unit 205 then judges whether or not the additional information included in the received bookmark information is “music” (step S310).

If it judges that the additional information is “music”, the data acquiring unit 205 performs the music recognition process to detect and acquire a music start frame from the acquired program content (step S315). The data acquiring unit 205 further acquires (a) a predetermined number of consecutive frames starting with the acquired music start frame by copying and (b) the sound/voice data by copying (step S320). The data acquiring unit 205 transmits, as image data, the consecutive frames starting with the acquired music start frame, namely a moving image starting with the music start frame, together with the sound/voice data related to the moving image, to the portable phone 100 (step S325). It should be noted here that in step S315, the data acquiring unit 205 acquires the sound/voice data of the acquired music start frame by means of copying.

If it judges that the additional information is not “music” in step S310, the data acquiring unit 205 judges whether or not the additional information is “person” (step S330).

If it judges that the additional information is “person”, the data acquiring unit 205 performs the person recognition process to detect and acquire a person start frame from the acquired program content (step S335). The data acquiring unit 205 transmits, as image data, a still image that is composed of the acquired person start frame, to the portable phone 100 (step S340).

If it judges that the additional information is not “person” in step S330, the data acquiring unit 205 judges whether or not the additional information is “character” (step S345).

If it judges that the additional information is “character”, the data acquiring unit 205 performs the character recognition process to detect and acquire a character start frame from the acquired program content (step S350). The data acquiring unit 205 transmits, as image data, a still image that is composed of the acquired character start frame, to the portable phone 100 (step S355).

If it judges that the additional information is not “character” in step S345, that is to say, if it judges that the additional information is “capture”, the data acquiring unit 205 performs the capture recognition process to detect and acquire a capture start frame from the acquired program content (step S360). The data acquiring unit 205 transmits, as image data, a still image that is composed of the acquired capture start frame, to the portable phone 100 (step S365).

It should be noted here that if the data acquiring unit 205 receives a plurality of pieces of bookmark information in step S300, the data acquiring unit 205 repeats the operation of steps S305 to S365 as many times as the number of received pieces of bookmark information.

Also, it should be noted here that to detect and acquire a frame means to detect a frame and acquire the detected frame by copying.

(6) Program Content Acquisition Process

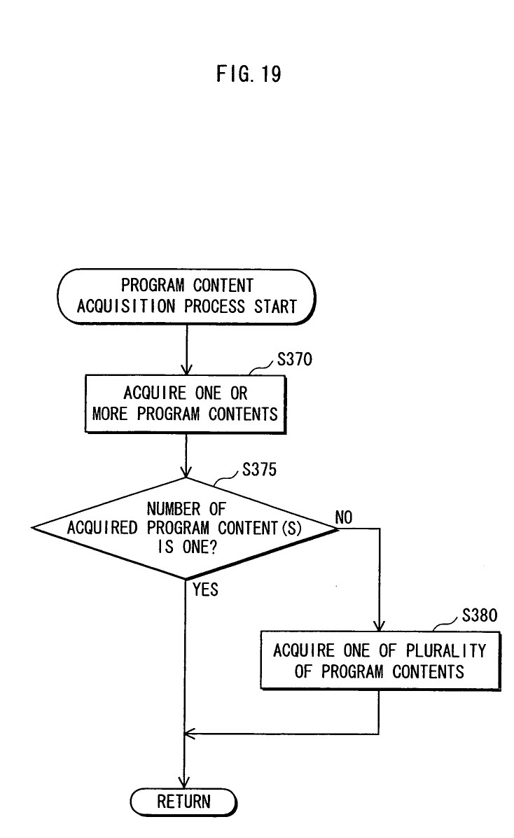

Here will be described the operation of the program content acquisition process performed in step S305 of the image data acquisition process shown in FIG. 18, with reference to the flowchart shown in FIG. 19.

The data acquiring unit 205 acquires one or more program contents corresponding to the BM CH number and BM program ID of the received bookmark information, from the program content storing unit 201 (step S370), and judges whether or not the number of acquired program content(s) is one (step S375). If the data acquiring unit 205 judges that the number of acquired program content(s) is one, the process is ended; and if the data acquiring unit 205 judges that the number of acquired program content(s) is not one, the data acquiring unit 205 acquires, among the plurality of acquired program contents, a program content whose recording start time matches the time indicated by the BM display time included in the bookmark information (step S380).

(7) Deletion Process

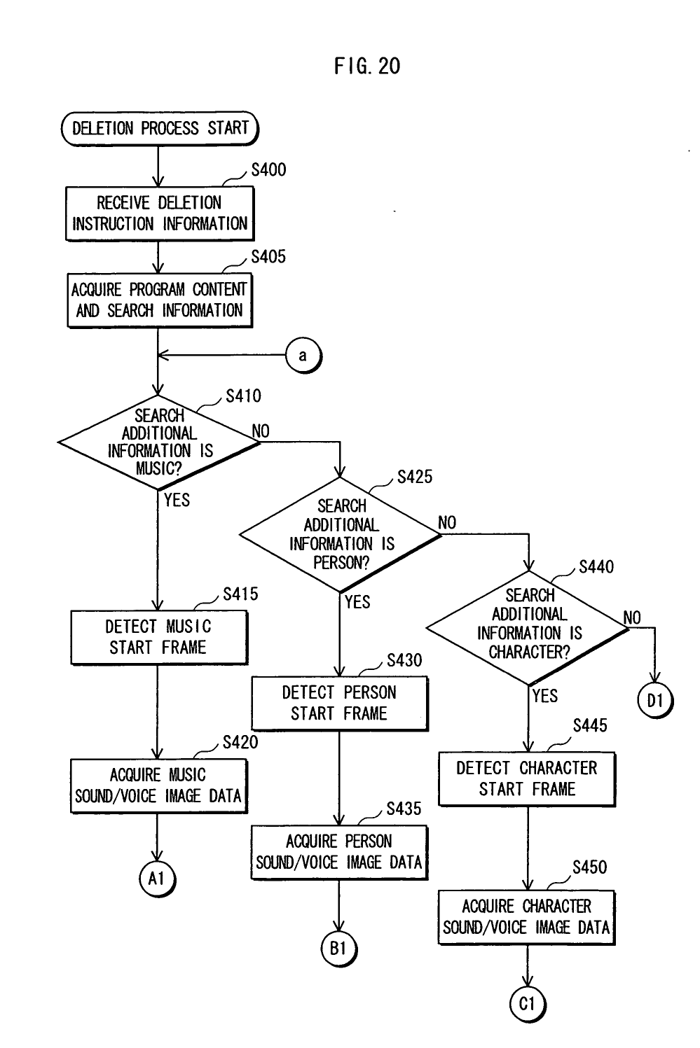

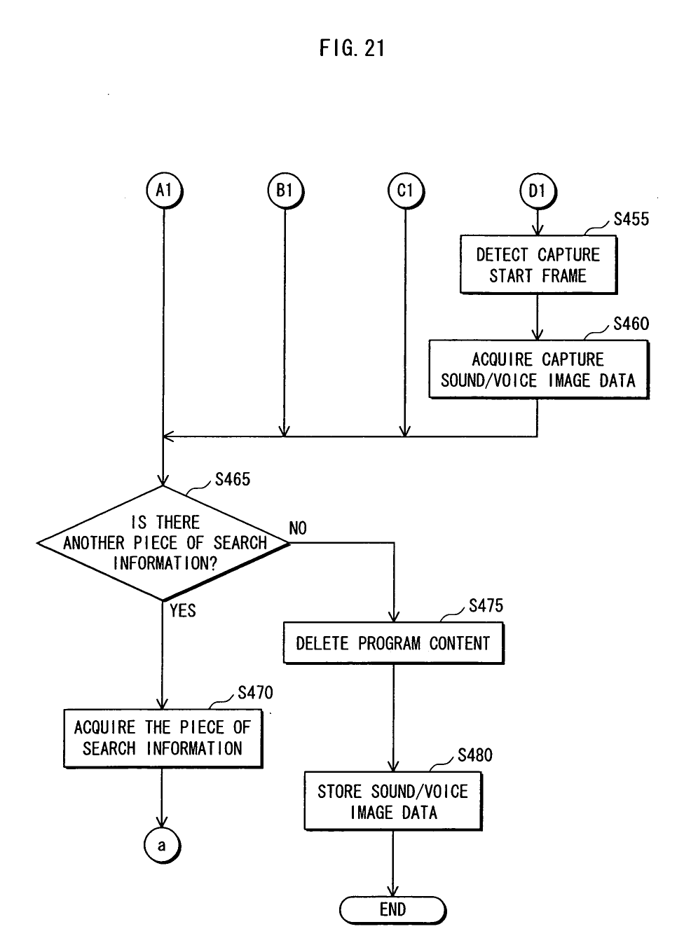

Here will be described the operation of a deletion process for deleting a program content performed by the playback apparatus 200, with reference to the flowcharts shown in FIGS. 20 and 21.

When it receives the deletion instruction information (step S400), the deletion unit 206 acquires, from the program content storing unit 201, a program content that corresponds to the program ID included in the received deletion instruction information, and acquires, from the search information storing unit 202, all pieces of search information that correspond to the program ID (step S405).

The deletion unit 206 judges whether or not the search additional information included in one of the acquired pieces of search information is “music” (step S410).

If it judges that the search additional information is “music”, the deletion unit 206 performs the music recognition process to detect a music start frame (step S415), acquires the music sound/voice image data by copying with use of the detected music start frame, and temporarily stores the acquired music sound/voice image data with indication of correspondence with the program ID, CH number, and search display time (step S420).

If it judges that the search additional information is not “music” in step S410, the deletion unit 206 judges whether or not the search additional information is “person” (step S425).

If it judges that the search additional information is “person”, the deletion unit 206 performs the person recognition process to detect a person start frame (step S430), acquires the person sound/voice image data by copying with use of the detected person start frame, and temporarily stores the acquired person sound/voice image data with indication of correspondence with the program ID, CH number, and search display time (step S435).

If it judges that the search additional information is not “person” in step S425, the deletion unit 206 judges whether or not the search additional information is “character” (step S440).

If it judges that the search additional information is “character”, the deletion unit 206 performs the character recognition process to detect a character start frame (step S445), acquires the character sound/voice image data by copying with use of the detected character start frame, and temporarily stores the acquired character sound/voice image data with indication of correspondence with the program ID, CH number, and search display time (step S450).

If it judges that the search additional information is not “character” in step S440, that is to say, if it judges that the search additional information is “capture”, the deletion unit 206 performs the capture recognition process to detect a capture start frame (step S455), acquires the capture sound/voice image data by copying with use of the detected capture start frame, and temporarily stores the acquired capture sound/voice image data with indication of correspondence with the program ID, CH number, and search display time (step S460).

The deletion unit 206 judges whether or not there is, among the pieces of search information acquired in step S405, a piece of search information for which steps S410 to S460 have not been performed (step S465). If it judges that there is such a piece of search information, the deletion unit 206 acquires the piece of search information that has not been processed (step S470), then returns to step S410 to perform step S410 and onwards for the acquired piece of search information.

If it judges in step S465 that there is no piece of search information for which steps S410 to S460 have not been performed, that is to say, if it judges that steps S410 to S460 have been performed for all the pieces of search information acquired in step S405, the deletion unit 206 deletes the program content (step S475), and stores the temporarily stored sound/voice image data into the program content storing unit 201 with indication of correspondence with the program ID, CH number, and search display time (step S480).

1.5 Conclusion

As described above, according to the present invention, while the playback apparatus is playing back a content, the bookmark system performs the bookmarking using the portable phone, generates bookmark information, and stores the generated bookmark information. This makes it possible to display the bookmarked image data on the portable phone later using the stored bookmark information.

Also, the playback apparatus can acquire the image data at high speeds using the bookmark information received from the portable phone.

It may happen that the actually bookmarked image data is different from the image data that the user intended to bookmark at the bookmark registration, due to the time required between the transmission and reception of the bookmark instruction information. However, the above-described playback apparatus can acquire the image data, which the user desires, in a more accurate manner than conventional apparatuses by performing, at the image data acquisition, a recognition process, among the music recognition process, person recognition process, character recognition process, and capture recognition process, that corresponds to the information contained in the additional information, and can send the acquired image data to the portable phone.

Also, when it performs bookmarking, the portable phone can receive information such as the broadcast time and program ID of the bookmarked image data, from the playback apparatus through an interactive communication.

Also, the portable phone makes it easy to arrange the bookmark information since it automatically assigns the generated bookmark information to the folders in accordance with its contents.

1.6 Modification on Storage Destination of Bookmark Information

In the above-described embodiment, the bookmark information is stored in the portable phone. In the present modification, the bookmark information is stored only in the playback apparatus.

The following describes a playback apparatus 1000 and a mobile phone 1100 in the present modification.

1.6.1 Playback Apparatus 1000

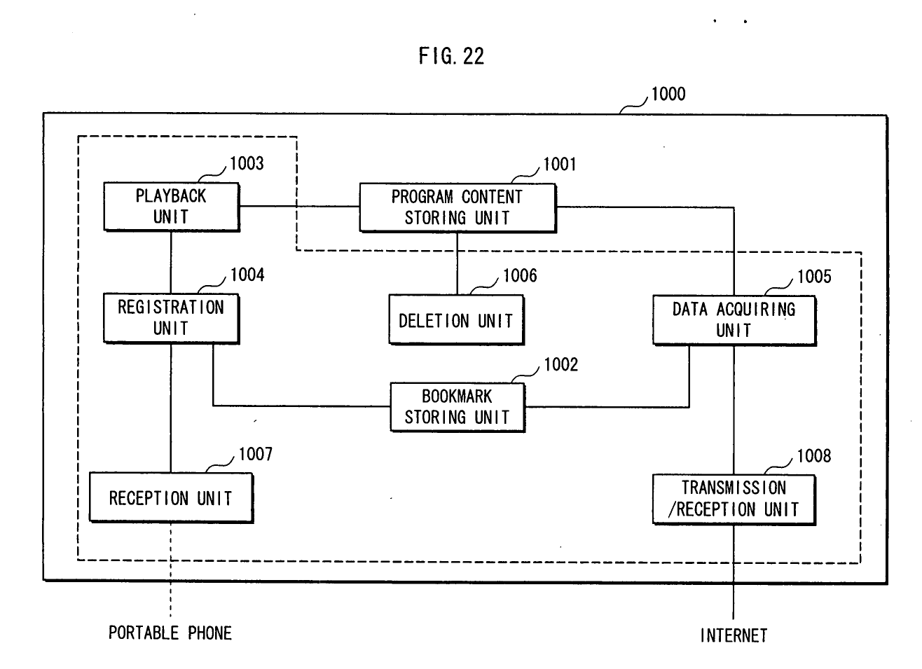

The playback apparatus 1000 includes, as shown in FIG. 22, a program content storing unit 1001, a bookmark storing unit 1002, a playback unit 1003, a registration unit 1004, a data acquiring unit 1005, a deletion unit 1006, a reception unit 1007, and a transmission/reception unit 1008.

The playback apparatus 1000 is specifically a computer system that includes a microprocessor, ROM, RAM, a hard disk unit and the like. A computer program is stored in the ROM. The microprocessor operates in accordance with the computer program and causes the playback apparatus 1000 to achieve the functions.

(1) Program Content Storing Unit 1001

The program content storing unit 1001 is the same as the program content storing unit 201 described above, and description thereof is omitted.

(2) Bookmark Storing Unit 1002

The bookmark information storing unit 1002 has the same folder construction as the above-described bookmark storing unit 101. The bookmark information storing unit 1002 differs from the bookmark storing unit 101 in the above-described embodiment in that the bookmark information includes a phone ID for identifying a portable phone, as well as the data described in the above-described embodiment.

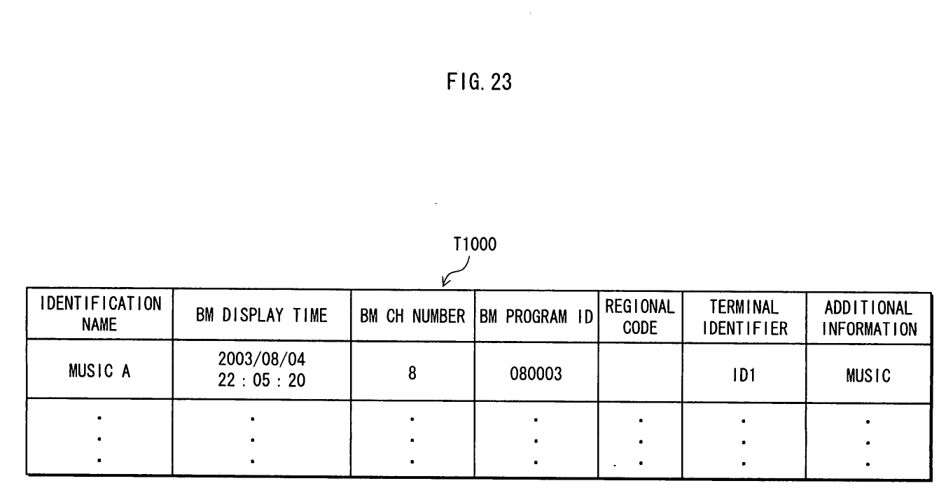

The music folder includes a music information table T1000, an example of which is shown in FIG. 23.

The music information table T1000 has an area for storing one or more sets of: an identification name; a BM display time; a BM CH number; a BM program ID; a regional code; a terminal identifier; and additional information.

The terminal identifier is a phone ID for identifying a portable phone. The other items are the same as those in the above-described embodiment, and description thereof is omitted.

(3) Playback Unit 1003

The playback unit 1003 is the same as the playback unit 203 described above, and description thereof is omitted.

(4) Registration Unit 1004

The registration unit 1004 counts the number of frames played back in a playback of a program content by the playback unit 1003.

The registration unit 1004 receives, during a playback of a program content, the bookmark instruction information and the phone ID for identifying the portable phone 1100, from the portable phone 1100 via the reception unit 1007.

The registration unit 1004 acquires the broadcast time of the bookmarked image data by performing the same operation as the registration unit 204 described above, and further acquires from the playback apparatus 200 the CH number and program ID that correspond to the program content being played back.

It is possible to identify a frame at the time when the bookmark instruction information is received, from the acquired broadcast time by taking into consideration the relationship between the acquired broadcast and the number of frames that are played back per second. These functions constitute a position acquiring unit that acquires information (in the present example, the broadcast time) that indicates a position in the program content corresponding to the time when the bookmark instruction information is received.

The registration unit 1004 further receives the identification name from the portable phone 1100 via the reception unit 1007.

The registration unit 1004 generates bookmark information from: the acquired broadcast time; the correspondence information included in the received bookmark instruction information; the received phone ID and identification name; and the CH number and program ID acquired from the playback unit 1003, and writes the generated bookmark information into a folder in the bookmark storing unit 1002 corresponding to the additional information contained in the bookmark information. If it receives a regional code after receiving the bookmark instruction information, the registration unit 1004 generates bookmark information from: the acquired broadcast time; the correspondence information included in the received bookmark instruction information; the received phone ID, regional code and identification name; and the CH number and program ID acquired from the playback unit 1003, and writes the generated bookmark information into a folder in the bookmark storing unit 1002 corresponding to the additional information contained in the bookmark information.

These functions constitute a writing unit that writes the bookmark information.

Also, in the registration unit 1004, as described above, the functions constitute an information receiving unit that receives information (correspondence information) that indicates a type of an object of bookmarking, a phone ID, an identification name and a regional code.

(5) Data Acquiring Unit 1005

The data acquiring unit 1005 preliminarily stores: the number of still images (for example, 300) that constitute a moving image to be transmitted to the portable phone 1100; a program that performs a music recognition process; a program that performs a person recognition process; a program that performs a character recognition process; a program that performs a capture recognition process. The data acquiring unit 1005 has an ID storage area for temporarily storing the phone ID received from the portable phone 1100.

Upon receiving the phone ID and the display start information that indicates starting display of bookmarked image data, from the portable phone 1100 via the transmission/reception unit 1008, the data acquiring unit 1005 assigns different numbers to folder names of the folders included in the bookmark storing unit 1002, generates a storage destination list composed of pairs of an assigned number and a folder name, and transmits the generated storage destination list to the portable phone 1100 via the transmission/reception unit 1008. The data acquiring unit 1005 also stores the received phone ID into the ID storage area. The description of the screen image of the storage destination list is omitted since it is the same as that shown in FIG. 9A.

The data acquiring unit 1005 receives selected folder information, which indicates a selected storage destination, from the portable phone 1100 via the transmission/reception unit 1008. Here, the selected folder information is composed of a number assigned to the selected folder.

The data acquiring unit 1005 further acquires all the bookmark information that includes the phone ID stored in the ID storage area, among the bookmark information recorded in the folder indicated in the selected folder information, and acquires identification names from each piece of the acquired bookmark information. The data acquiring unit 1005 generates a list composed of all the acquired identification names, and transmits the generated list to the portable phone 1100 via the transmission/reception unit 1008. Here, the list includes different numbers assigned to each identification name. The description of the screen image of the storage destination list is omitted since it is the same as that shown in FIG. 9B.

The data acquiring unit 1005 receives selected identification name information, which indicates a selected identification name, from the portable phone 1100 via the transmission/reception unit 1008.

These functions constitute a reception unit that receives information that indicates a display instruction.

The data acquiring unit 1005 acquires, from the bookmark storing unit 1002, bookmark information that corresponds to the identification name indicated in the received selected identification name information. Here, the selected identification name information is composed of a number assigned to the selected identification name.

The data acquiring unit 1005 acquires, from the program content storing unit 1001, a program content that corresponds to the BM CH number and the BM program ID that are included in the acquired bookmark information. Here, if the data acquiring unit 1005 acquires a plurality of program contents that correspond to the BM CH number and the BM program ID, the data acquiring unit 1005 acquires from those a program content that has a recording start time that matches the time indicated by the BM display time included in the bookmark information.

After this, the data acquiring unit 1005 acquires a still image or a moving image by copying from the acquired program content by the acquisition method described above. Also, when it acquires a moving image, the data acquiring unit 1005 acquires the corresponding sound/voice by copying. The data acquiring unit 1005 performs the degrading onto the acquired still image or moving image to degrade the image quality of the image to be transmitted to the portable phone 1100. The degrading is achieved by, for example, converting 16-bit data into 8-bit data. These functions constitute a partial content acquiring unit that acquires a bookmarked still image or moving image from the program content.

The data acquiring unit 1005 transmits the degraded still image or moving image to the portable phone 1100 via the transmission/reception unit 1008, as image data. When it transmits image data of a moving image, the data acquiring unit 1005 also transmits sound/voice data related to the moving image. These functions constitute a content transmitting unit that transmits a partial content composed of a still image, or a partial content composed of a moving image and sound/voice data.

The data acquiring unit 1005 receives, from the portable phone 1100 via the transmission/reception unit 1008, image data request information that requests bookmarked image data relating to the current region, a regional code and a phone ID. These functions constitute an identifier receiving unit that receives image data request information and a regional code.

The data acquiring unit 1005 acquires, from the bookmark storing unit 1002, all the bookmark information that matches both the received regional code and phone ID.

The data acquiring unit 1005 acquires a still image or a moving image that corresponds to the correspondence information included in each piece of the acquired bookmark information, by the acquisition method described above.

The data acquiring unit 1005 performs the degrading as described above, and transmits image data of each degraded picture to the portable phone 1100 via the transmission/reception unit 1008. When it transmits image data of a moving image, the data acquiring unit 1005 also transmits sound/voice data related to the moving image to the portable phone 1100 via the transmission/reception unit 1008. As is the case with the above description, these functions constitute a content transmitting unit.

(6) Deletion Unit 1006

The deletion unit 1006 is the same as the deletion unit 206 described above, and description thereof is omitted.

(7) Reception Unit 1007

The reception unit 1007 outputs the information received from the portable phone 1100 through an infrared communication to the registration unit 1004.

(8) Transmission/Reception Unit 1008

The transmission/reception unit 1008 outputs the information received from the portable phone 1100 via the Internet to the data acquiring unit 1005.

The transmission/reception unit 1008 transmits the information received from the data acquiring unit 1005 to the portable phone 1100 via the Internet.

1.6.2 Portable Phone 1100

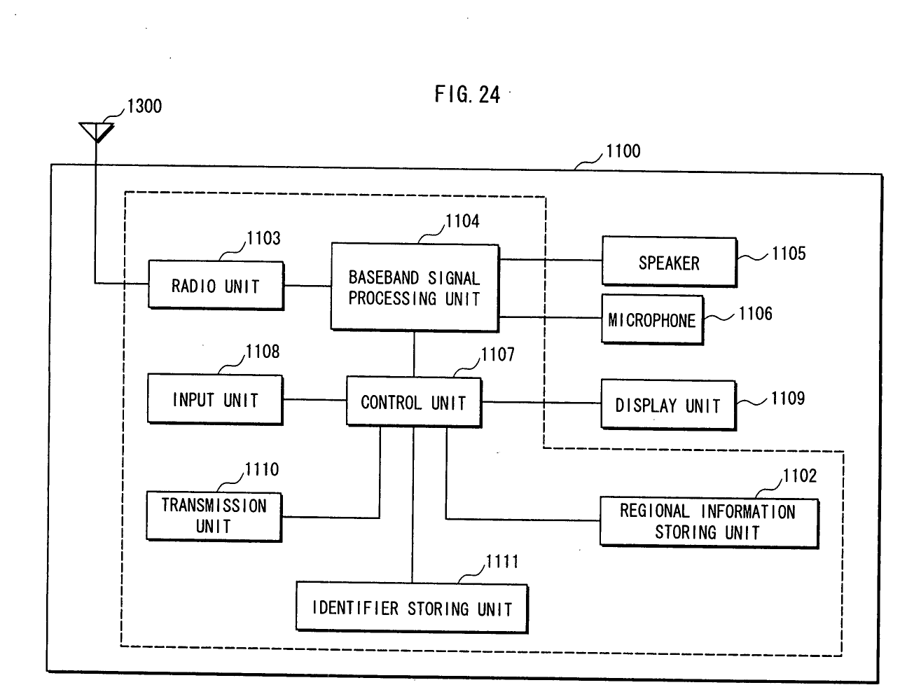

The portable phone 1100 includes, as shown in FIG. 24, a regional information storing unit 1102, a radio unit 1103, a baseband signal processing unit 1104, a speaker 1105, a microphone 1106, a control unit 1107, an input unit 1108, a display unit 1109, a transmission unit 1110, and an identifier storing unit 1111.

The portable phone 1100 is specifically a computer system that includes a microprocessor, ROM, RAM, a display unit and the like. A computer program is stored in the ROM. The microprocessor operates in accordance with the computer program and causes the portable phone 1100 to achieve the functions.

(1) Regional Information Storing Unit 1102

The regional information storing unit 1102 is the same as the regional information storing unit 102 described above, and description thereof is omitted.

(2) Identifier Storing Unit 1111

The identifier storing unit 1111 stores a phone ID for identifying the portable phone 1100.

(3) Radio Unit 1103

The radio unit 1103, having an antenna 1300, performs transmission/reception of radio signals.

(4) Baseband Signal Processing Unit 1104

The baseband signal processing unit 1104 performs signal processing to output a signal, which was received from the radio unit 1103, to the speaker 1105. The baseband signal processing unit 1104 also performs signal processing to output sound/voice, which was received from the microphone 1106, to the radio unit 1103.

The baseband signal processing unit 1104 further receives information via the Internet, a public radio communication network, and the radio unit 1103, and outputs the received information to the control unit 1107.

Upon receiving from the control unit 1107 the display start information, selected folder information, selected identification name information, and image data request information, the baseband signal processing unit 1104 transmits the received display start information, selected folder information, selected identification name information, and image data request information to the playback apparatus 1000 via the radio unit 1103, public radio communication network, and Internet. Upon receiving the image data request information from the control unit 1107, the baseband signal processing unit 1104 further receives a regional code, and transmits the received image data request information together with the received regional code to the playback apparatus 1000 via the public radio communication network and Internet. The baseband signal processing unit 1104 further receives sound/voice data from the control unit 1107, and performs signal processing to output the received sound/voice data to the speaker 1105.

(5) Speaker 1105

The speaker 1105 is the same as the speaker 105 described above, and description thereof is omitted.

(6) Microphone 106

The microphone 1106 is the same as the microphone 106 described above, and description thereof is omitted.

(7) Control Unit 1107

The control unit 1107 preliminarily has a GPS (Global Positioning System) function for measuring positions, and controls the entire portable phone 1100.

The following describes the controls on the registration of the bookmark information, the specification display, and the regional display.

<Registration of Bookmark Information>

The control unit 1107 receives the bookmark instruction information from the input unit 1108. When the input unit 1108 receives, from the user, regional code information that indicates a regional code, the control unit 1107 receives, from the input unit 108, the regional code information together with the bookmark instruction information.

The control unit 1107 then transmits the received bookmark instruction information and the phone ID stored in the identifier storing unit 1111 to the playback apparatus 1000 via the transmission unit 1110 through an infrared communication. If it has also received a regional code from the input unit 1108, the control unit 1107 transmits the regional code, together with the bookmark instruction information, to the playback apparatus 1000 via the transmission unit 1110.

If it receives an identification name from the input unit 1108, the control unit 1107 transmits the received identification name to the playback apparatus 1000 via the transmission unit 1110 through an infrared communication.

These functions constitute an information transmitting unit that transmits information (correspondence information) that indicates a type of an object of bookmarking, a phone ID, a regional code, and an identification name.

<Specification Display>

The control unit 1107, upon receiving the display start information from the input unit 108, acquires a phone ID, and transmits the received display start information and the acquired phone ID to the playback apparatus 1000 via the radio unit 1103 using the Internet and the public radio communication network.

If it receives a storage destination list from the playback apparatus 1000 via the Internet and the public radio communication network, the control unit 1107 outputs the received storage destination list to the display unit 1109.

If it receives selected folder information from the input unit 1108 that was input by the user through key operations, the control unit 1107 outputs the received selected folder information to the baseband signal processing unit 1104.

If it receives a list from the playback apparatus 1000 via the Internet and the public radio communication network, the control unit 1107 outputs the received list to the display unit 1109.

If it receives selected identification name information from the input unit 1108 that was input by the user through key operations, the control unit 1107 outputs the received selected identification name information to the baseband signal processing unit 1104.

These functions constitute an instruction transmitting unit.

The control unit 1107 receives image data of a still image or a moving image corresponding to the bookmark information containing the selected identification name, from the playback apparatus 1000 via the Internet and the public radio communication network. When it receives image data of a moving image, the control unit 1107 also receives sound/voice data related to the moving image. These functions constitute a content receiving unit that receives a partial content composed of a still image or a partial content composed of a moving image and sound/voice.

The control unit 1107 displays, via the display unit 1109, a still image or a moving image based on the received image data of the still image or the received image data of the moving image. When it also receives sound/voice data related to the moving image, the control unit 1107 outputs the received sound/voice data to the speaker 1105 via the baseband signal processing unit 1104. This enables the control unit 1107 to play back the received moving image. These functions constitute a content outputting unit.

<Regional Display>

The control unit 1107, upon receiving the regional display information from the input unit 1108, measures the current position using the GPS function. The control unit 1107 acquires from the regional information storing unit 1102 a regional code that corresponds to the region detected by the measurement. The control unit 1107 further acquires a phone ID from the identifier storing unit 1111.

The control unit 1107 outputs the acquires regional code and phone ID to the baseband signal processing unit 1104 together with the image data request information.

When the control unit 1107 receives image data of a still image or a moving image related to the transmitted regional code from the playback apparatus 1000 via the Internet and the public radio communication network, the control unit 1107 displays, via the display unit 1109, a still image or a moving image based on the received image data of the still image or the received image data of the moving image.

When it receives image data of a moving image, the control unit 1107 also receives sound/voice data related to the moving image, and outputs the received sound/voice data to the speaker 1105 via the baseband signal processing unit 1104. This enables the control unit 1107 to play back the received moving image. These functions constitute a content outputting unit.

When it receives a plurality of still images or moving images, the control unit 1107 receives the preceding image information or the subsequent image information from the input unit 1108, and controls still or moving images to be displayed on the display unit 1109.

(8) Input Unit 1108

The input unit 1108 includes a keyboard equipped with numerical input keys and the like for input functions and receives instructions input by the user.

The input unit 1108 receives the bookmark instruction information, and outputs the received bookmark instruction information to the control unit 1107. The input unit 1108 also receives the regional code information, and outputs the received regional code information to the control unit 1107. It should be noted here that the regional code information is received together with the bookmark instruction information, and is output to the control unit 1107 together with the bookmark instruction information.

The input unit 1108 further receives the identification name information, and outputs the received identification name information to the control unit 1107.

Upon receiving the display start information, the input unit 1108 outputs the received display start information to the control unit 1107. The input unit 1108 further receives the selected folder information and the selected identification name information, and outputs the received selected folder information and selected identification name information to the control unit 1107.

Upon receiving the regional display information, the input unit 1108 outputs the received regional display information to the control unit 1107. Upon receiving the preceding image information or the subsequent image information, the input unit 1108 outputs the received preceding or subsequent image information to the control unit 1107.

These functions constitute a reception unit.

(9) Display Unit 1109

The display unit 1109, upon receiving the storage destination list from the control unit 1107, displays the received storage destination list.

The display unit 1109, upon receiving the list from the control unit 1107, displays the received list.

The display unit 1109 further displays a still image or a moving image received from the control unit 1107. It should be noted here that the image displayed by the display unit 1109 is lower in quality due to the degrading performed by the playback apparatus 1000.

(10) Transmission Unit 1110

The transmission unit 1110 transmits information, which has been received from the control unit 1107, to the playback apparatus 1000 through an infrared communication.

1.6.3 Outline of Bookmark Information Registration

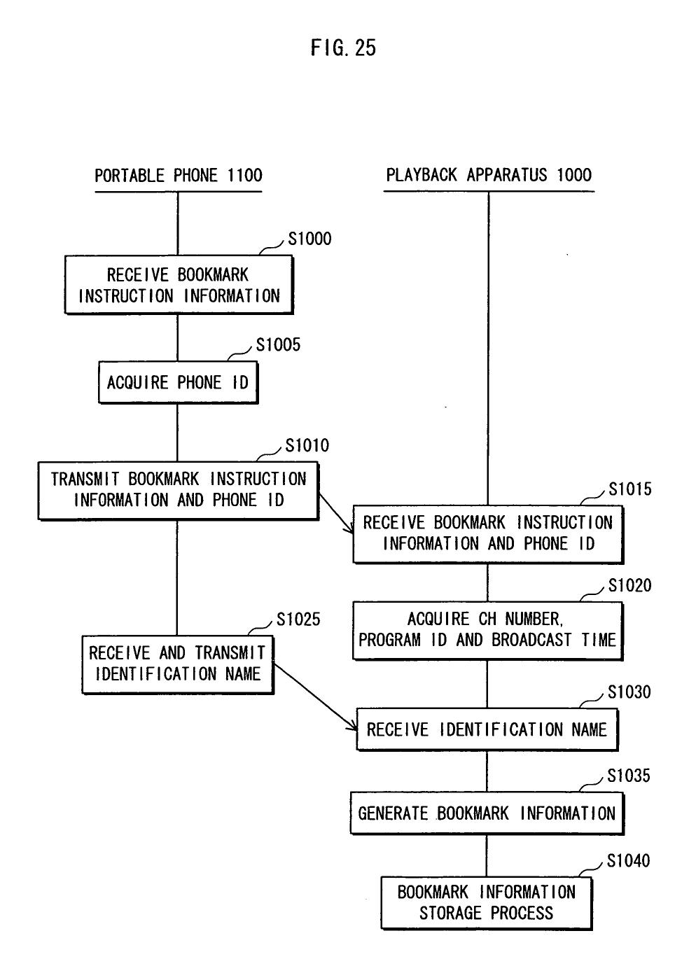

The outline of the operation of bookmark information registration will be described with reference to the flowchart shown in FIG. 25.

When the portable phone 1100 receives the bookmark instruction information from the user (step S1000), the portable phone 1100 acquires a phone ID from the identifier storing unit 1111 (step S1005). The portable phone 1100 transmits the bookmark instruction information and the phone ID to the playback apparatus 1000 (step S1010). If it receives a regional code in step S1000 in addition to the bookmark instruction information, the portable phone 1100 transmits the received regional code as well in step Upon receiving the bookmark instruction information and the phone ID from the portable phone 1100 (step S1015), the playback apparatus 1000 acquires a CH number, a program ID, and the broadcast time of the bookmarked imaged data (step S1020).

The portable phone 1100 further receives an identification name, and transmits the received identification name to the playback apparatus 1000 (step S1025).

The playback apparatus 1000 receives the identification name from the portable phone 1100 (step S1030), and generates bookmark information using the received identification name, correspondence information, and phone ID and the acquired broadcast time, CH number, and program ID (step S1035), and performs the bookmark information storage process for storing the generated bookmark information into a folder that corresponds to the additional information contained in the generated bookmark information (step S1040). It should be noted here that if it receives the regional code information as well from the portable phone 1100 in step S1015, the playback apparatus 1000 generates the bookmark information using the correspondence information contained in the received bookmark instruction information, the received phone ID, regional code, and identification name, the acquired broadcast time, and the CH number and program ID acquired from the playback unit 1003, and stores the generated bookmark information into a folder that corresponds to the correspondence information contained in the bookmark information.

Detailed description of the bookmark information storage process is omitted here since it is the same as the operation shown in FIG. 17.

1.6.4 Operation Outline of Specification Display

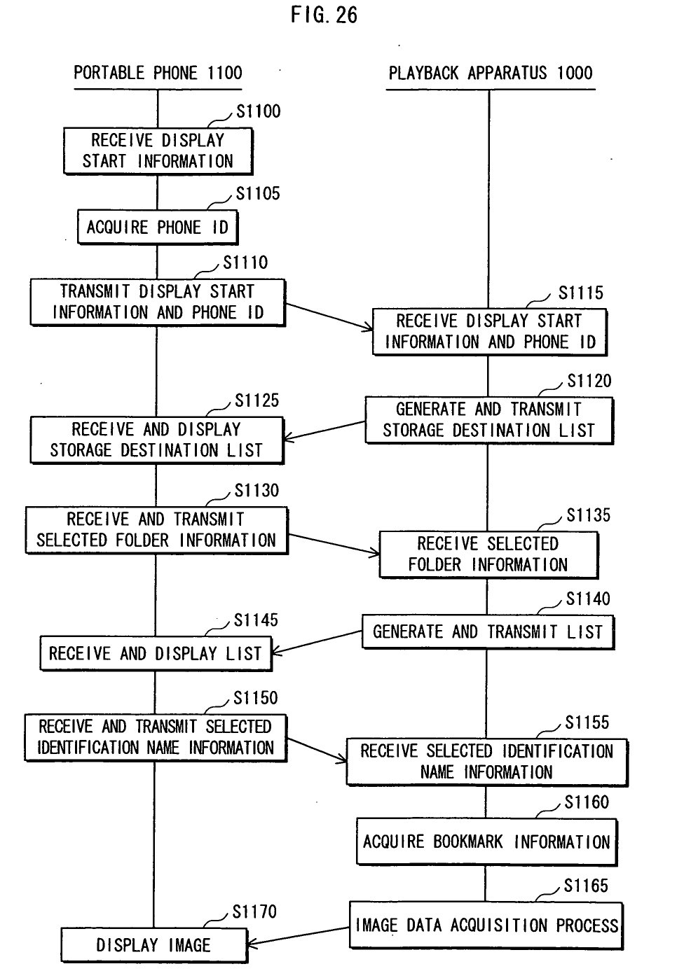

Here will be described the outline of the operation of the specification display, with reference to the flowchart shown in FIG. 26.

When it receives the display start information (step S1100), the portable phone 1100 acquires a phone ID (step S1105), and transmits the received display start information and the acquired phone ID to the playback apparatus 1000 (step S1110).

Upon receiving the display start information and the phone ID from the portable phone 1100 (step S1115), the playback apparatus 1000 generates the storage destination list, and transmits the generated storage destination list to the portable phone 1100, and stores the received phone ID in the ID storage area (step S1120).

Upon receiving the storage destination list from the playback apparatus 1000 via the Internet and the public radio communication network, the portable phone 1100 displays the received storage destination list (step S1125).

The portable phone 1100 receives the selected folder information from the user through key operations, and transmits the received selected folder information to the playback apparatus 1000 (step S1130).

The playback apparatus 1000 receives the selected folder information from the portable phone 1100 (step S1135).

The playback apparatus 1000 generates the list by acquiring all the bookmark information that includes the phone ID stored in the ID storage area, among the bookmark information recorded in the folder indicated in the selected folder information, and acquiring identification names from each piece of the acquired bookmark information, and transmits the generated list to the portable phone 1100 (step S1140).

Upon receiving the list from the playback apparatus 1000 via the Internet and the public radio communication network, the portable phone 1100 displays the received list (step S1145).

The portable phone 1100 receives the selected identification name information from the user through key operations, and transmits the received selected identification name information to the playback apparatus 1000 (step S1150).

The playback apparatus 1000 receives the selected identification name information from the portable phone 1100 (step S1155), and acquires, from the bookmark storing unit 1002, the bookmark information that corresponds to the identification name indicated in the received selected identification name information (step S1160).

The playback apparatus 1000 performs the image data acquisition process for acquiring the bookmarked still image or moving image, using the BM CH number and BM program ID contained in the acquired bookmark information (step S1165).

The portable phone 1100 receives the still image or moving image that corresponds to the bookmark information containing the selected identification name from the playback apparatus 1000 via the Internet and the public radio communication network, and displays the received still image or moving image (step S1170).

When it receives the moving image, the portable phone 1100 receives sound/voice data related to the moving image as well, and outputs the received sound/voice data as well.

1.6.5 Operation Outline of Region Display

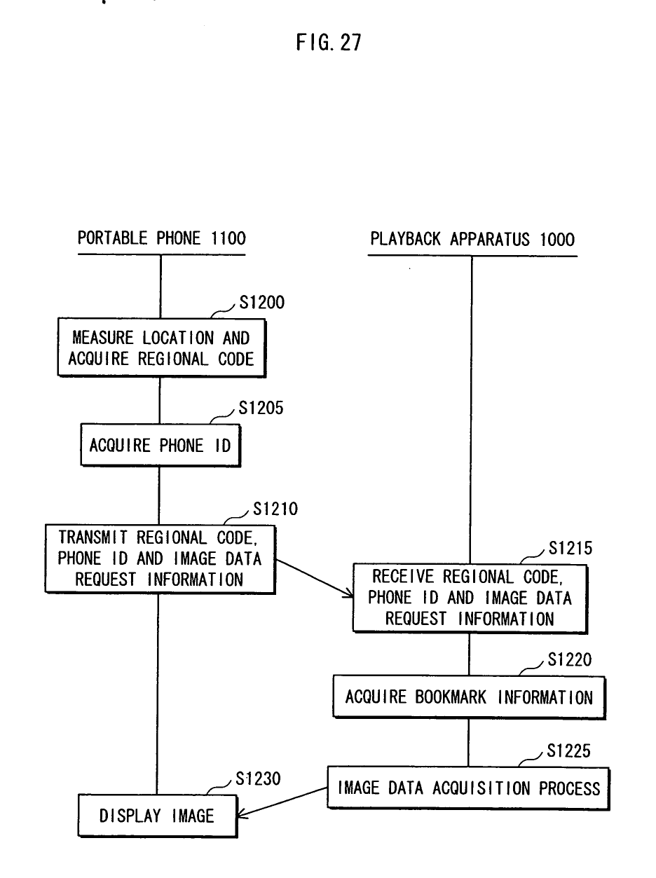

Here will be described the outline of the operation of the region display, with reference to the flowchart shown in FIG. 27.

When it receives the regional display information from the user, the portable phone 1100 measures the current position using the GPS function, acquires, from the identifier storing unit 1111, a regional code that corresponds to a region detected from the measurement result (step S1200), and further acquires phone ID from the identifier storing unit 1111 (step S1205).

The portable phone 1100 transmits the acquired regional code and phone ID to the playback apparatus 1000 together with the image data request information (step S1210).

The playback apparatus 1000 receives the image data request information, regional code and phone ID from the portable phone 1100 (step S1215), and acquires, from the bookmark storing unit 1002, all the bookmark information that matches both the received regional code and phone ID (step S1220).

The playback apparatus 1000 performs the image data acquisition process (step S1225).

The portable phone 1100 receives still images or moving images that correspond to each piece of the bookmark information related to the transmitted regional code, from the playback apparatus 1000 via the Internet and the public radio communication network, and displays the received still images or moving images (step S1230).

When it receives the moving image, the portable phone 1100 receives sound/voice data related to the moving image as well, and outputs the received sound/voice data as well.

It should be noted here that if the playback apparatus 1000 acquires a plurality of pieces of bookmark information in step S1220, the portable phone 1100 receives still images or moving images that correspond to all the acquired pieces of bookmark information from the playback apparatus 1000. In such a case, the portable phone 1100 receives the preceding image information or the subsequent image information as well and controls image data to display.

1.6.6 Image Data Acquisition Process

Here will be described the operation of the image data acquisition process performed in step S1165 of FIG. 26, by explaining only the differences from the image data acquisition process shown in FIG. 18.

The differences from the image data acquisition process shown in FIG. 18 are as follows. Step S300 is deleted. Step S305 is performed using the bookmark information acquired in step S1160 of FIG. 26. One or more frames acquired in steps S315, S320, S335, S350, and S360 are subjected to the degrading so as to be degraded in image quality, and image data with lower image quality is transmitted in steps S325, S340, S355, and S366.

The above-described modifications are also applied to the image data acquisition process performed in step S1225 of FIG. 27. It should be noted here that step S305 and the succeeding steps are performed using all the bookmark information acquired in step S1220 of FIG. 27.

1.6.7 Modifications

The above-described modification on storage destination of bookmark information is provided as a specific example of the present invention. The present invention is not limited to the above-described embodiment example, but maybe achieved in various manners within the scope of the present invention. The following, for example, should be construed as the present invention.

(1) In the above description, the data acquiring unit 1005 performs the degrading to degrade the image quality of the acquired still or moving images related to the bookmark information. However, the present invention is not limited to this.

A predetermined character set (for example, “sample”) may be added to the acquired still or moving image, and the still or moving image with the predetermined character set may be transmitted to the portable phone 1100. The portable phone 1100 displays the still or moving image with the predetermined character set.

When the playback apparatus 1000 transmits a moving image, the playback apparatus 1000 may perform the degrading onto the sound/voice data as well to degrade the sound/voice quality. Alternatively, when a moving image is transmitted, only the sound/voice data may be degraded.

The playback apparatus 1000 may assign an expiration time to the still or moving image that is transmitted. In line with this, after transmitting an acquired image, the data acquiring unit 1005 of the playback apparatus 1000 stores an expiration time of the transmitted image into the bookmark storing unit 1002 with indication of a correspondence with the bookmark information corresponding to the transmitted image, with the phone ID, and with the program ID of the program content that includes the transmitted image. These functions constitute an expiration time writing unit that writes an expiration time into the bookmark storing unit 1002.

The playback apparatus 1000 may transmit an image corresponding to the same bookmark information it stores, to the portable phone corresponding to the phone ID it stores, only before the expiration time. Furthermore, before the expiration time, the playback apparatus may not transmit the image of the bookmark information corresponding to the program ID it stores, to other portable phones. The playback apparatus 1000 may or may not transmit an image, which corresponds to the program ID it stores and corresponds to bookmark information that is different from the bookmark information it stores, to a portable phone corresponding to the phone ID it stores.

(2) In the above-described modification, the system includes the playback apparatus 1000 and the portable phone 1100. However, the present invention is not limited to this.

The system may be achieved by a home network. In this system, the playback apparatus 1000 is used as a home server, and one or more client apparatuses (for example, digital TVs or DVD recorders) are provided in place of the portable phone 1100. Each of the one or more client apparatuses stores an apparatus identifier for identifying the client apparatus.

Each client apparatus plays back a program content stored in the playback apparatus 1000, and if, during the playback, it receives the bookmark instruction information input by the user through operations of a remote controller equipped in the client apparatus, the client apparatus transmits the received bookmark instruction information and the apparatus identifier to the playback apparatus 1000. Description of the registration of the bookmark information is omitted here since it is the same as that in the above-described modification.

Each client apparatus, upon receiving the display start information input by the user, transmits the received display start information and the apparatus identifier to the playback apparatus 1000. The operations subsequent to this are the same as those in the above-described modification, and description of them is omitted here. It should be noted here that this construction differs from the above-described modification in that it uses a home network instead of the Internet and the public radio communication network.

(3) A user ID assigned to each user may be used in place of the phone ID used in the above-described modification. In such a case, the portable phone 1100 transmits a user ID as well to the playback apparatus 1000 when it transmits the bookmark instruction information thereto. Description of the registration of the bookmark information is omitted here since it is the same as that in the above-described modification.

The portable phone 1100 transmits a user ID as well to the playback apparatus 1000 when it transmits the display start information thereto. The operations subsequent to this are the same as those in the above-described modification, and description of them is omitted here.

(4) The present invention may be any combination of the above-described embodiment and modifications.

1.6.8 Conclusion

As described above, according to the present modification, the playback apparatus 1000 can manage the bookmark information collectively. Furthermore, with the phone ID added to the bookmark information, the playback apparatus 1000 can deal with bookmark instructions received from a plurality of portable phones.

Also, the playback apparatus 1000 can impose restrictions based on the copyright protection by degrading the quality of the image related to the bookmark information.

1.7 Other Modifications

Up to now, the present invention has been explained through an embodiment thereof. However, the present invention is not limited to the embodiment. The following, for example, should be construed as the present invention.

(1) In the above-described embodiment, the bookmarked image data is received from the playback apparatus 200, and the received image data is displayed. However, not limited to this, the portable phone 100 may be provided with a storage unit for storing the received image data, and may store the received image data into the storage unit. Here, the storage unit is achieved by a memory in the portable phone 100 or a recording medium (for example, an SD card) that is attachable/detachable to/from a portable phone.

(2) In the above-described embodiment, the portable phone is used as a portable communication terminal. However, not limited to this, another portable communication terminal may be used.

For example, a PDA (Personal Digital Assistant) or a terminal dedicated to the bookmark system may be used.

(3) The bookmark information may be transferred (transmitted/received) among a plurality of portable phones. In such a case, the transfer (transmission/reception) of the bookmark information is performed through infrared communications. For doing this, an information transmission unit provided in the control unit 107 transmits the bookmark information stored in the bookmark storing unit 101 to another portable phone via the transmission/reception unit 110. When receiving the bookmark information from another portable phone, a time reception unit provided in the control unit 107 receives the bookmark information from another portable phone via the transmission/reception unit 110. The bookmark information received from another portable phone is written into the bookmark storing unit 101 by an information writing unit provided in the control unit 107.

The following describes the operation of the above in the playback apparatus 200, using the portable phone 100. Upon receiving the bookmark information from the portable phone 100, the playback apparatus 200 judges whether or not a program content that matches a BM program ID contained in the received bookmark information is stored in the program content storing unit 201. If it judges that such a program content is stored in the program content storing unit 201, the playback apparatus 200 acquires image data corresponding to the received bookmark information, and transmits the acquired image data to the portable phone 100. When transmitting a moving image, the playback apparatus 200 transmits sound/voice as well.

If it judges that such a program content is not stored in the program content storing unit 201, the playback apparatus 200 transmits, to the portable phone 100, a message that no image data corresponding to the received bookmark information is present in the playback apparatus 200.

(4) In the above-described embodiment, when a bookmark registration is performed, the object of bookmarking is indicated by the correspondence information. However, not limited to this, the object of bookmarking may not be indicated.

In this case, the correspondence information is blank, and the additional information contained in the bookmark information generated by the portable phone 100 is also blank. Upon receiving the bookmark information with blank additional information, the playback apparatus 200 detects a corner that includes image data corresponding to the bookmark information, and acquires the detected corner by copying. Alternatively, not a corner, but a start position of a program content may be detected.

It should be noted here that the corner is a video section that includes a specific content. For example, the corner may be a section between (a) a position at which a commercial message switches to a program and (b) a position at which the program switches to a commercial message. Therefore, in the case of business broadcasting, one program has a plurality of sections corresponding to the corners; and in the case of non-business broadcasting, one program has one section corresponding to the corner. In general, in both business and non-business broadcasting, a specific frame (for example, a silent frame) is broadcast immediately before a corner starts or immediately after a corner ends. Accordingly, a program content has one or more corners and each specific frame immediately before or after each corner.

(5) In the above-described embodiment, after the playback apparatus 200 receives the bookmark information, the playback apparatus 200 performs a recognition process corresponding to the additional information contained in the received bookmark information to acquire a start frame. However, not limited to this, after the playback apparatus 200 receives the bookmark instruction information, the playback apparatus 200 may perform a recognition process corresponding to the correspondence information contained in the received bookmark instruction information to acquire the broadcast time of the start frame, generate search information using the acquired broadcast time and the bookmark instruction information, and store the generated search information.

Here, the music recognition process corresponds to the case where the correspondence information is “music”, the person recognition process corresponds to the case where the correspondence information is “person”, the character recognition process corresponds to the case where the correspondence information is “character”, and the capture recognition process corresponds to the case where the correspondence information is “capture”.

(6) In the above-described embodiment, the registration of a bookmark is performed during a playback of a program content. However, not limited to this, the registration of a bookmark may be performed during recording of a program content.

(7) In the above-described embodiment, a program ID is assigned by the playback apparatus 200 during recording of a program content. However, not limited to this, the playback apparatus 200 may receive, from a broadcasting station, a data broadcast such as an electronic program guide (hereinafter, EPG) that includes a program genre name, a program name, a broadcast time and the like, and may use an identifier of a program in the received EPG as a program ID.

(8) In the above-described embodiment, the portable phone 100 and the playback apparatus 200 perform an infrared communication during the registration of a bookmark. However, not limited to this, any radio communication may be performed instead.

For example, Bluetooth may be used for the purpose.

(9) In the above-described embodiment, in the image data acquisition process, the playback apparatus 200 acquires a start frame of image data corresponding to the additional information contained in the received bookmark information, using the BM display time contained in the bookmark information. However, not limited to this, a frame corresponding to the BM display time may be acquired as the start frame.

Similarly, when a program content is deleted, a frame corresponding to the search display time contained in the deletion information may be used as the start frame.

(10) In the above-described embodiment, the portable phone 100 displays a still or moving image to indicate a bookmarked portion. However, not limited to this, information composed of character data may be displayed. The information composed of character data is, for example, information composed of subtitles contained in the image data. The playback apparatus 200 transmits the character data composed of subtitles to the portable phone 100, and the portable phone 100 displays the received character data.

Alternatively, the playback apparatus 200 may acquire only sound/voice data related to the moving image, as information related to the bookmarked portion, and transmit the acquired sound/voice data to the portable phone 100, and the portable phone 100 may output the received sound/voice data via the speaker 105.

(11) The search information and the bookmark information may be correlated with each other only by the broadcast time of the bookmarked image data.

In this case, the bookmark information is composed of the identification name, BM display time, regional code, and additional information, and the search information is composed of the search display time, search CH number, search program ID, and search additional information.

With such a construction, the playback apparatus 200, upon receiving the bookmark information from the portable phone 100, acquires search information whose search display time matches the BM display time of the received bookmark information, and acquires image data using the acquired search information.

(12) In the above-described embodiment, music, person, character, and capture are used as the types of the object of bookmarking. However, not limited to these, information other than these may be used as the types of the object of bookmarking. For example, information indicating a commercial message program may be used for the purpose. When this information is used, the portable phone 100 is provided with a folder, which corresponds to the information indicating a commercial message program, in the bookmark storing unit 101. And if the correspondence information contained in the bookmark instruction information received during a bookmark registration is the information indicating a commercial message program, the portable phone 100 stores the bookmark information into the folder that corresponds to the information indicating a commercial message program. The playback apparatus 200 preliminarily stores a program for performing a commercial message program recognition process. And if the additional information contained in the bookmark information received from the portable phone 100 is the information indicating a commercial message program, the playback apparatus 200 executes the program for performing the commercial message program recognition process using the BM display time of the bookmark information and a program content acquired from the program content storing unit 201 to acquire a commercial message start frame that is immediately before the BM display time in the program content. The playback apparatus 200 then acquires an “edge” of the commercial message program from the acquired commercial message start frame, that is to say, acquires image data of the commercial message program. The playback apparatus 200 further acquires sound/voice data related to the acquired image data. It should be noted here that the commercial message program recognition process is a process that detects a commercial message start frame positioned at the start of a section in which a silent section repeatedly appears at intervals of a predetermined time (for example, 15 seconds), using a predetermined algorithm.

In the program content deletion process, if the search additional information contained in the search information is the information indicating a commercial message program, the playback apparatus 200 executes the program for performing the commercial message program recognition process to acquire a commercial message start frame, and acquires image data and sound/voice data that continue for a predetermined time (for example, three minutes) starting with the acquired commercial message start frame.

(13) The information indicating the object of bookmarking may be classified in more detail. For example, the capture may be classified into restaurant and resort. In this case, the portable phone 100 is provided with folders, which respectively correspond to restaurant and resort, in the bookmark storing unit 101. And if the correspondence information contained in the bookmark instruction information received during a bookmark registration is “restaurant”, the portable phone 100 stores the bookmark information into the folder that corresponds to restaurant, and if the correspondence information is “resort”, the portable phone 100 stores the bookmark information into the folder that corresponds to resort. If the additional information contained in the received bookmark information is “restaurant” or “resort”, the playback apparatus 200 operates in the same manner as when the additional information is capture. Description of this case is therefore omitted here.

Also, In the program content deletion process, if the search additional information contained in the search information is “restaurant” or “resort”, the playback apparatus 200 operates in the same manner as when the search additional information is capture. Description of this case is therefore omitted here.

(14) In the above-described embodiment, when bookmarked image data is displayed, a moving image is displayed only if the additional information is music. However, not limited to this, a moving image may be displayed when the additional information is other than music. Adversely, a still image may be displayed if the additional information is music.

Alternatively, the portable phone 100 may receive a selection between a still image and a moving image as the image data to be displayed when it receives the display start information. Further, the portable phone 100 may receive a selection between a still image and a moving image as the image data to be displayed when it receives the regional display information.

(15) The portable phone 100 may receive a specification of a folder to be searched when it receives the regional display information. In this case, the portable phone 100 acquires, from the specified folder, bookmark information that contains a regional code that matches a region detected by the measurement using the GPS function.

(16) In the above-described embodiment, the music recognition process, person recognition process, character recognition process, and capture recognition process are stored in both the data acquiring unit 205 and the deletion unit 206. However, the present invention is not limited to this.

The music recognition process, person recognition process, character recognition process, and capture recognition process may be stored only in the data acquiring unit 205, and the deletion unit 206 may use each recognition process stored in the data acquiring unit 205.

Alternatively, the playback apparatus 200 may be provided with a recognition process storing unit for storing the music recognition process, person recognition process, character recognition process, and capture recognition process, and the data acquiring unit 205 and the deletion unit 206 may use each recognition process stored in the recognition process storing unit.

(17) In the above-described embodiment, the music recognition process, person recognition process, character recognition process, and capture recognition process are each a program. However, not limited to this, these recognition processes may not be a program, but be a circuit for performing each recognition process.

(18) In the above-described embodiment, a program content is correlated with a CH number, a program ID, and a recording start time. However, not limited to this, a program content may be correlated with a program ID and a recording start time.

In this case, the program information is composed of the BM program ID and the BM display time, the bookmark information is composed of the identification name, BM display time, BM program ID, regional code, and additional information, and the search information is composed of the search display time, search program ID, and search additional information. When playing back a program content, the playback unit 203 stores a program ID and a recording start time that correspond to the program content to be played back, and deletes a program ID and a recording start time that were stored when a playback of a program content ended.

Also, upon receiving the bookmark instruction information from the portable phone 100, the registration unit 204 acquires, from the playback unit 203, a program ID and a recording start time that correspond to a program content being played back, acquires a broadcast time of image data that was played back when the bookmark instruction information was received, generates program information using the acquired broadcast time and program ID, and transmits the generated program information to the portable phone 100.

Also, upon receiving the bookmark information, the data acquiring unit 205 acquires, from the program content storing unit 201, a program content that corresponds to the BM program ID contained in the received bookmark information, acquires image data corresponding to the received bookmark information from the acquired program content, and transmits the acquired image data to the portable phone 100. Here, if there are a plurality of program contents that correspond to the program ID, the data acquiring unit 205 further acquires, from the plurality of program contents, a program content that has a recording start time that matches the BM display time contained in the received bookmark information.

(19) The playback apparatus may preliminarily store image data related to a bookmarked portion.

A playback apparatus 200A in this case will be described in the following.

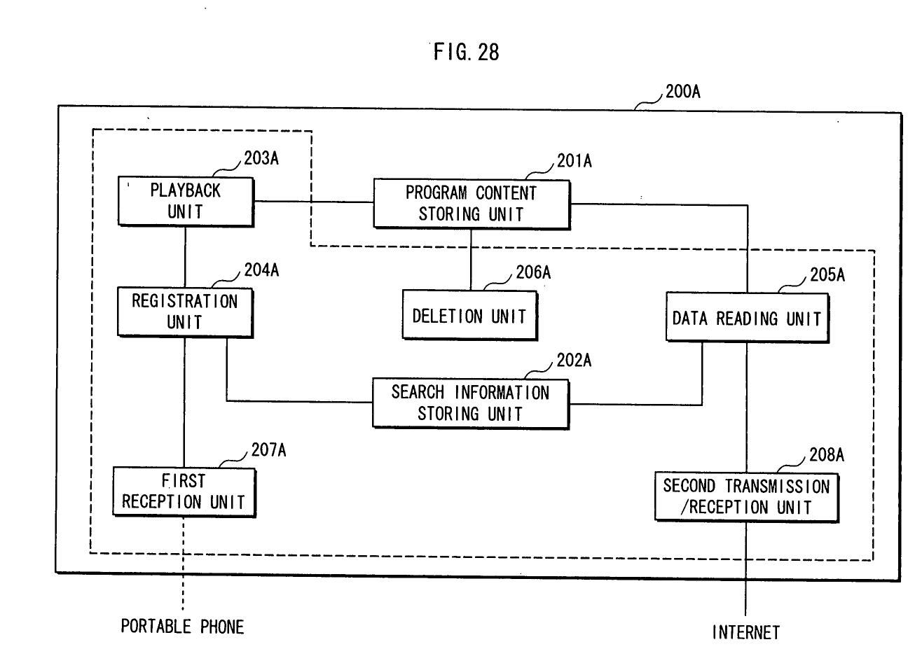

As shown in FIG. 28, the playback apparatus 200A includes a program content storing unit 201A, a search information storing unit 202A, a playback unit 203A, a registration unit 204A, a data reading unit 205A, a deletion unit 206A, a first transmission/reception unit 207A, and a second transmission/reception unit 208A.

The playback apparatus 200A is specifically a computer system that includes a microprocessor, ROM, RAM, a hard disk unit and the like. A computer program is stored in the ROM. The microprocessor operates in accordance with the computer program and causes the playback apparatus 200A to achieve the functions.

The program content storing unit 201A, playback unit 203A, first transmission/reception unit 207A, and second transmission/reception unit 208A are the same as the program content storing unit 201, playback unit 203, first transmission/reception unit 207, and second transmission/reception unit 208 described above, and description thereof is omitted.

The search information storing unit 202A includes an area for storing a bookmarked portion of image data with indication of corresponding search information. These functions constitute a bookmark storing unit that stores bookmarked image data.

The registration unit 204A preliminarily stores the music recognition process, person recognition process, character recognition process, and capture recognition process.

The registration unit 204A counts the number of frames played back in a playback of a program content by the playback unit 203A.

Upon receiving the bookmark instruction information from the portable phone 100 during a playback of a program content, the registration unit 204A calculates, by the same method as that of the registration unit 204 above described, an elapse time for a section that extends between image data at the start of the program content and image data being played back by the playback unit 203A when the bookmark instruction information is received. The registration unit 204A acquires the recording start time stored in the playback unit 203A, and adds the calculated elapse time to the acquired recording start time to acquire the broadcast time of the bookmarked image data. The registration unit 204A further acquires the CH number and program ID that correspond to the program content being played back by the playback unit 203A.

The registration unit 204A generates program information from the acquired broadcast time, the CH number and the program ID, and transmits the generated program information to the portable phone 100. The registration unit 204A also generates search information from the acquired broadcast time, the CH number and program ID, and the correspondence information contained in the received bookmark instruction information.

The registration unit 204A detects a start frame corresponding to the correspondence information contained in the received bookmark instruction information by performing a recognition process corresponding to the correspondence information using the correspondence information and the acquired broadcast time.

If the correspondence information is “music”, the registration unit 204A acquires, by copying, consecutive frames of a preliminarily set time period starting with the detected music start frame. The registration unit 204A also acquires sound/voice data by copying and stores, as image data, the plurality of acquired frames and sound/voice data into the search information storing unit 202A with indication of correspondence with the generated search information. If the correspondence information is “person”, the registration unit 204A acquires the detected person start frame by copying, and stores, as image data, the acquired person start frame into the search information storing unit 202A with indication of correspondence with the generated search information. If the correspondence information is “character”, the registration unit 204A acquires the detected character start frame by copying, and stores, as image data, the acquired character start frame into the search information storing unit 202A with indication of correspondence with the generated search information. If the correspondence information is “capture”, the registration unit 204A acquires the detected capture start frame by copying, and stores, as image data, the acquired capture start frame into the search information storing unit 202A with indication of correspondence with the generated search information. These functions constitute a writing unit that writes a bookmarked image.

Upon receiving the bookmark information from the portable phone 100, the data acquiring unit 205A acquires search information that corresponds to the received bookmark information, reads image data that corresponds to the acquired search information, and transmits the read image data to the portable phone 100.

The deletion unit 206A receives, from the user, deletion instruction information that indicates performing deletion of a program content recorded in the program content storing unit 201A. The deletion instruction information is information that includes a program ID. The deletion unit 206A deletes a program content, which corresponds to a program ID contained in the received deletion instruction information, from the program content storing unit 201A.

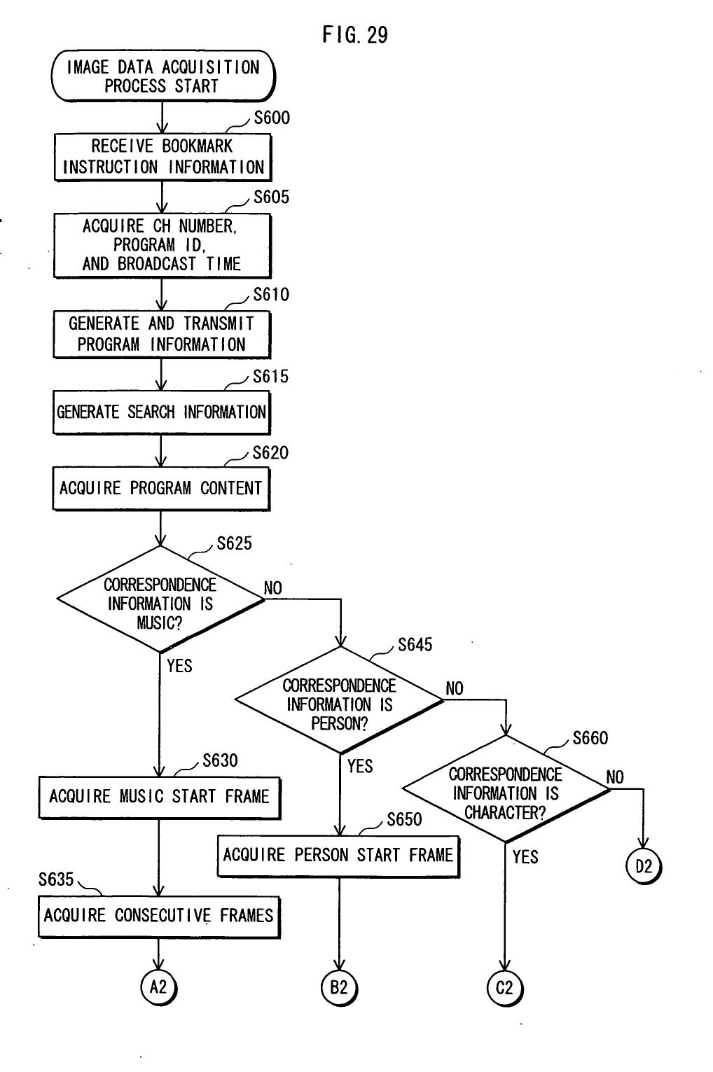

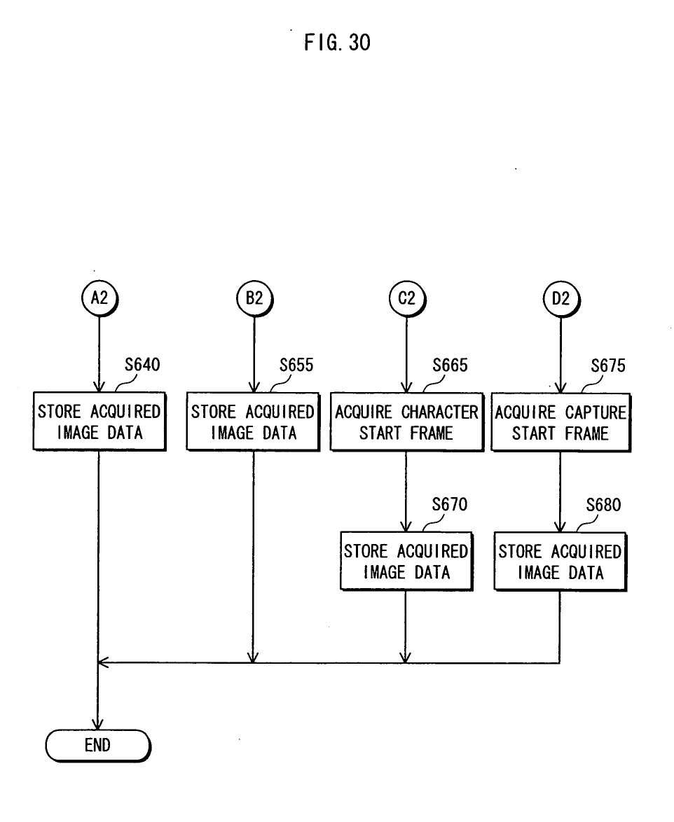

Here will be described the operation of the image data acquisition process performed by the registration unit 204A when the bookmark instruction information is received, with reference to the flowcharts shown in FIGS. 29 and 30.

The registration unit 204A receives the bookmark instruction information from the portable phone 100 (step S600), acquires, from the playback unit 203A, a CH number, program ID, and recording start time that correspond to the program content being played back and acquires a broadcast time of the bookmarked image data using the acquired recording start time (step S605), generates program information using the acquired broadcast time, CH number, and program ID, and transmits the generated program information to the portable phone 100 (step S610). The registration unit 204A then generates search information using the bookmark instruction information received instep S600, the broadcast time acquired in step S605, and the CH number and program ID (step S615).

The registration unit 204A then acquires, from the program content storing unit 201A, a program content that corresponds to the CH number and the program ID (step S620).

The registration unit 204A then judges whether or not the correspondence information included in the received bookmark instruction information is “music” (step S625).

If it judges that the correspondence information is “music”, the registration unit 204A performs the music recognition process to detect and acquire a music start frame from the acquired program content (step S630). The registration unit 204A further acquires (a) consecutive frames of a preliminarily set time period starting with the acquired music start frame by copying, and (b) the sound/voice data (step S635). The registration unit 204A stores, as image data, the consecutive frames starting with the acquired music start frame, namely a moving image starting with the music start frame, together with the sound/voice data related to the moving image, into the search information storing unit 202A with indication of correspondence with the search information generated in step S615 (step S640). It should be noted here that in step S630, the registration unit 204A acquires the sound/voice data of the acquired music start frame by means of copying.

If it judges that the correspondence information is not “music” in step S625, the registration unit 204A judges whether or not the correspondence information is “person” (step S645).

If it judges that the correspondence information is “person”, the registration unit 204A performs the person recognition process to detect and acquire a person start frame from the acquired program content (step S650). The registration unit 204A stores a still image, which is composed of the acquired person start frame, into the search information storing unit 202A as image data, with indication of correspondence with the search information generated in step S615 (step S655).

If it judges that the correspondence information is not “person” in step S645, the registration unit 204A judges whether or not the correspondence information is “character” (step S660).

If it judges that the correspondence information is “character”, the registration unit 204A performs the character recognition process to detect and acquire a character start frame from the acquired program content (step S665). The registration unit 204A stores a still image, which is composed of the acquired character start frame, into the search information storing unit 202A as image data, with indication of correspondence with the search information generated in step S615 (step S670).

If it judges that the correspondence information is not “character” in step S660, that is to say, if it judges that the correspondence information is “capture”, the registration unit 204A performs the capture recognition process to detect and acquire a capture start frame from the acquired program content (step S675). The registration unit 204A stores a still image, which is composed of the acquired capture start frame, into the search information storing unit 202A as image data, with indication of correspondence with the search information generated in step S615 (step S680).

With this construction, the playback apparatus 200A needs not search the program content for image data after it receives the bookmark information from the portable phone 100. Accordingly, this construction reduces the time required for transmitting the image data after receiving the bookmark information.

It should be noted here that the operation of acquiring image data by copying and storing the acquired image data into the search information storing unit 202A with indication of corresponding search information may be performed after playback of the program content. In this case, the generated search information is temporarily stored in the registration unit 204A until playback of the program content ends.

Also, to detect and acquire a frame means detecting a frame and acquiring the detected frame by copying.

(20) In the above-described embodiment, when the specification display is performed, the bookmark information is transmitted from the portable phone 100 to the playback apparatus 200. However, not limited to this, the bookmark information may be transmitted to another apparatus (for example, a server apparatus that manages program contents in a broadcast station) that manages program contents, and the apparatus that manages program contents may acquire image data and transmit the acquired image data to the portable phone 100.

(21) When receiving the bookmark instruction information, the portable phone 100 may store only a reception time at which it received the bookmark instruction information, and transmit the bookmark instruction information and the reception time to the playback apparatus 200.

In this case, upon receiving the bookmark instruction information and the reception time, the playback apparatus 200 generates search information and stores the generated search information into the search information storing unit 202 with indication of correspondence with the received reception time.

The portable phone 100 transmits the stored reception time to the playback apparatus 200. The playback apparatus 200 acquires image data using search information that corresponds to the received reception time, and transmits the acquired image data to the portable phone 100.

If it receives the regional code information together with the bookmark instruction information, the portable phone 100 transmits the regional code information to the playback apparatus 200 together with the bookmark instruction information and the reception time. The playback apparatus 200 generates search information and stores the generated search information into the search information storing unit 202 with indication of correspondence with the received reception time and the regional code information. When the region is displayed, the portable phone 100 transmits to the playback apparatus 200 the reception time it stores, and the regional code information indicating a regional code that corresponds to the region detected by the measurement using the GPS function. The playback apparatus 200 acquires image data using search information that corresponds to both the received reception time and regional code information, and transmits the acquired image data to the portable phone 100.

(22) The portable phone 100 may store only a search information identifier for identifying search information stored in the playback apparatus 200.

In this case, the portable phone 100 transmits the bookmark instruction information to the playback apparatus 200. Upon receiving the bookmark instruction information, the playback apparatus 200 generates search information and further acquires a search information identifier that identifies the generated search information. The playback apparatus 200 then stores the generated search information into the search information storing unit 202 with indication of correspondence with the acquired search information identifier, and transmits the acquired search information identifier to the portable phone 100. The portable phone 100 stores the received search information identifier.

The portable phone 100 transmits the stored search information identifier to the playback apparatus 200. The playback apparatus 200 acquires image data using search information that corresponds to the received search information identifier, and transmits the acquired image data to the portable phone 100.

If it receives the regional code information together with the bookmark instruction information, the portable phone 100 transmits the regional code information to the playback apparatus 200 together with the bookmark instruction information. The playback apparatus 200 generates search information and further acquires a search information identifier that identifies the generated search information. The playback apparatus 200 then stores the generated search information into the search information storing unit 202 with indication of correspondence with the acquired search information identifier and the received regional code information, and, and transmits the acquired search information identifier to the portable phone 100. The portable phone 100 stores the received search information identifier.

When the region is displayed, the portable phone 100 transmits to the playback apparatus 200 the search information identifier it stores, and the regional code information indicating a regional code that corresponds to the region detected by the measurement using the GPS function. The playback apparatus 200 acquires image data using search information that corresponds to both the received search information identifier and regional code information, and transmits the acquired image data to the portable phone 100.

(23) The present invention may be any combination of the above-described embodiment and modifications.

### 2. Embodiment 2

In the above-described embodiment, the bookmark information is stored in the portable phone. In the present embodiment, only the playback apparatus is used to instruct the bookmarking, storing the bookmark information.

2.1 Construction of Bookmark System 2

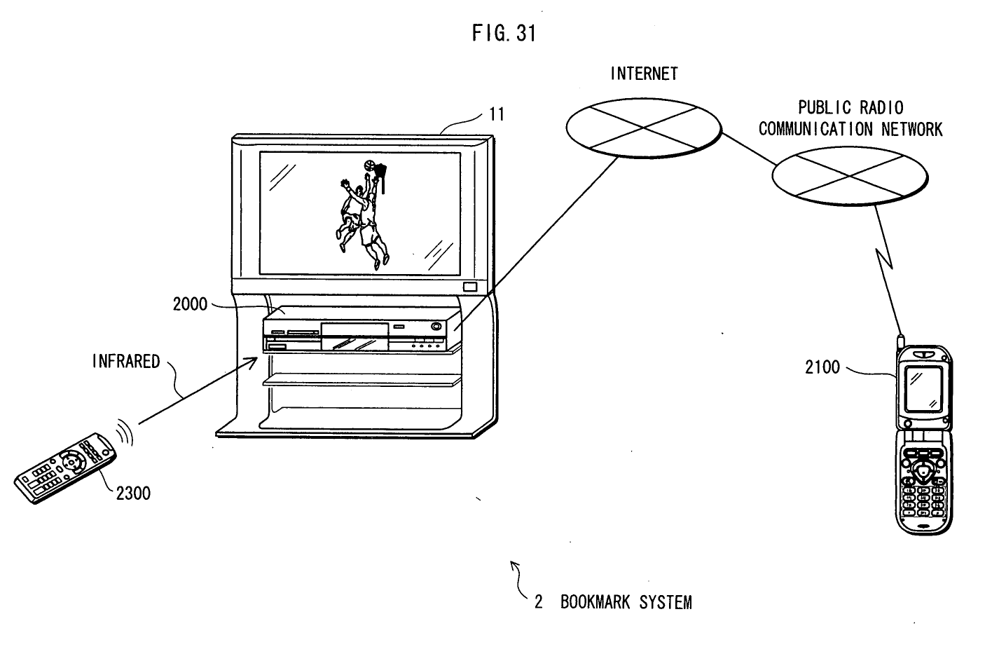

FIG. 31 shows a use form of a bookmark system 2. The bookmark system 2 includes: a playback apparatus 2000 connected to a monitor 11; and a portable phone 2100.

The playback apparatus 2000 records a program content that is broadcast by a broadcast station, and plays back the recorded program content. To the recorded program content assigned are: a channel number (hereinafter, CH number) of a channel on which the program content was broadcast; a program ID for identifying the program content; and a recording start time at which the recording of the program content was started.

Communication by the Internet and a public radio communication network is available between the portable phone 2100 and the playback apparatus 2000.

The playback apparatus 2000 is provided with a remote controller 2300. While the playback apparatus 2000 is playing back on the monitor 11 a program content having been recorded by the playback apparatus 2000, it is possible, with use of the remote controller 2300, to transmit information that indicates performing registration of information related to the image data desired to be referred to later, receive the information related to the image data desired to be referred to later from the playback apparatus 2000, and stores the received information. It should be noted here that specifying image data desired to be referred to later is called “bookmarking”.

Furthermore, when requested, using the remote controller 2300, to display a bookmarked image, the playback apparatus 2000 displays a still image or a moving image related to the bookmarked image on the monitor 11.

Also, when requested, using the portable phone 2100 via the public radio communication network and the Internet, to display a bookmarked image, the playback apparatus 2000 transmits a still image or a moving image related to the bookmarked image to the portable phone 2100 via the Internet and the public radio communication network, and the portable phone 2100 displays the received still image or moving image.

2.2 Construction of Playback Apparatus 2000 and Remote Controller 2300

The following describes the construction of the playback apparatus 2000 and the remote controller 2300.

2.2.1 Playback Apparatus 2000

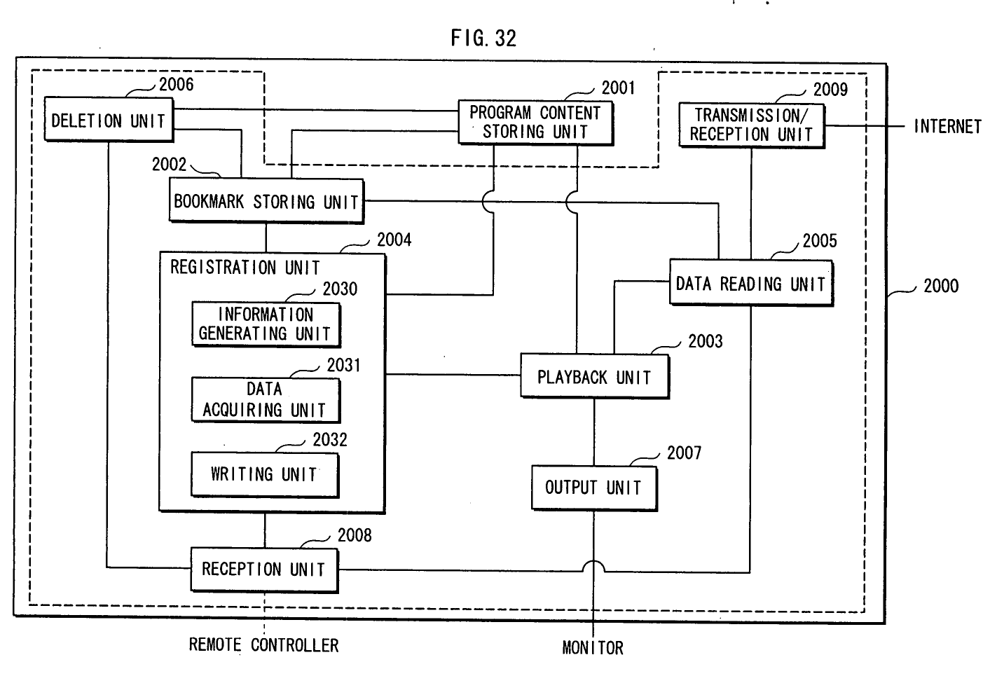

The playback apparatus 2000 includes, as shown in FIG. 32, a program content storing unit 2001, a bookmark storing unit 2002, a playback unit 2003, a registration unit 2004, a data reading unit 2005, a deletion unit 2006, an output unit 2007, a reception unit 2008, and a transmission/reception unit 2009.

The playback apparatus 2000 is specifically a computer system that includes a microprocessor, ROM, RAM, a hard disk unit and the like. A computer program is stored in the ROM. The microprocessor operates in accordance with the computer program and causes the playback apparatus 2000 to achieve the functions.

(1) Program Content Storing Unit 2001

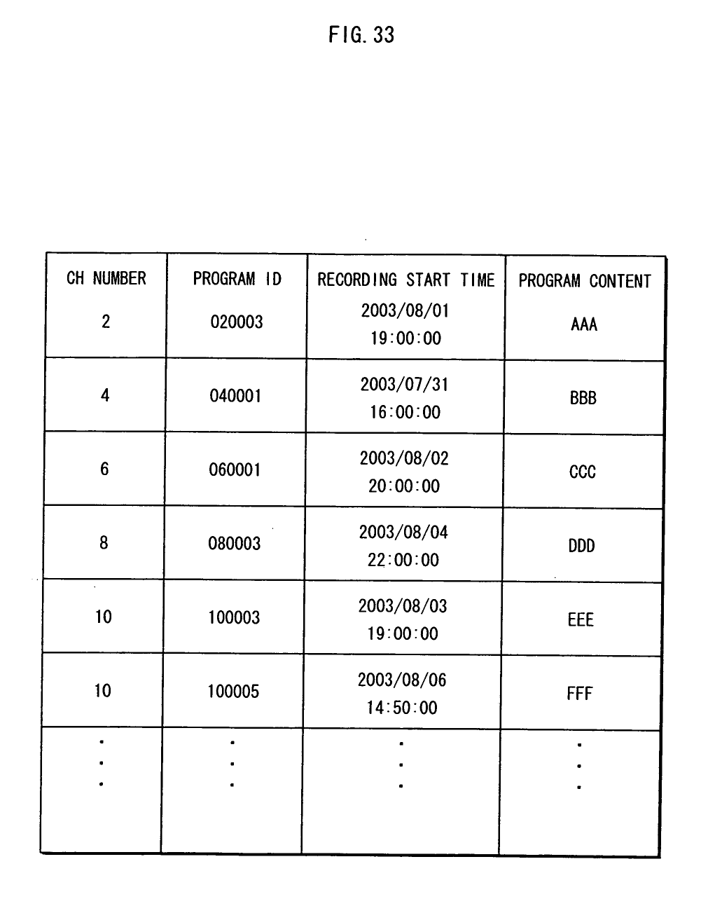

The program content storing unit 2001, as shown in FIG. 33 as an example, has an area for storing one or more recorded program contents each with indication of correspondence with a CH number, a program ID, and a recording start time.

Each of the program contents recorded in the program content storing unit 2001 includes: image data composed of a plurality of consecutive frames (still images) aligning along a time axis; and sound/voice data that indicates sound/voice of each frame. It should be noted here that when it records a program content, the playback apparatus 2000 assigns a program ID to the program content.

These functions constitute a content storing unit that preliminarily records therein program contents.

(2) Bookmark Storing Unit 2002

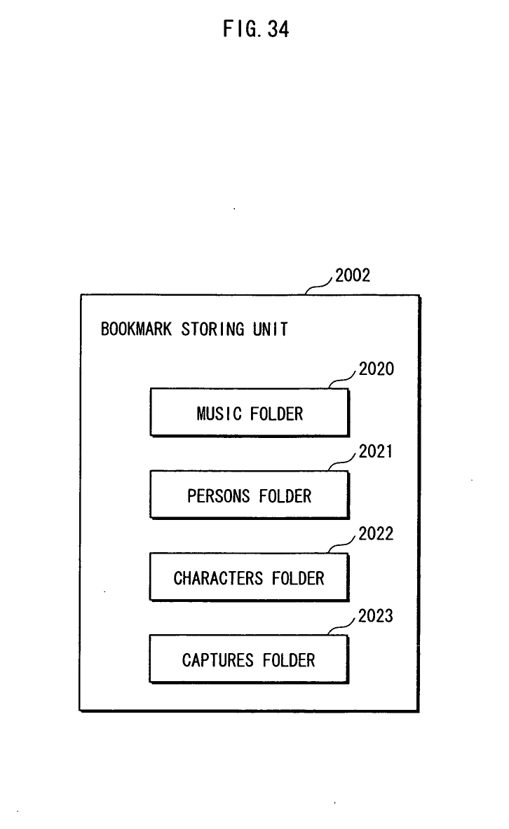

The bookmark storing unit 2002 includes, as shown in FIG. 34, a music folder 2020, a persons folder 2021, a characters folder 2022, and a captures folder 2023.

<Music Folder 2020>

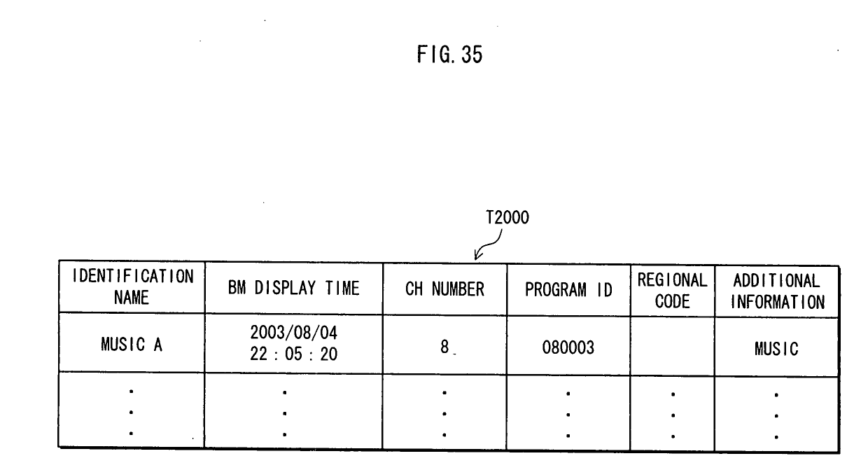

The music folder 2020 includes a music information table T2000, an example of which is shown in FIG. 35.

The music information table T2000 has an area for storing one or more sets of: an identification name; a BM display time; a CH number; a program ID; a regional code; and additional information. It should be noted here that information composed of an identification name, a BM display time, a BM CH number, a BM program ID, a regional code, and additional information is referred to as bookmark information.

The identification name is a name used for identifying each piece of stored bookmark information. The BM display time is a broadcast time at which bookmarked imaged data was broadcast, and includes a date and a time. The CH number is a channel number of a channel on which the bookmarked program content was broadcast; a CH number that corresponds to a bookmarked program content. The program ID is an identifier for identifying the bookmarked program content. The regional code is information for identifying a region, and corresponds to the local area code for the telephone numbers of the region. The additional information is information that indicates an object of bookmarking.

Here, the regional code may not necessarily be recorded, but may be recorded as necessary.

It should be noted here that the additional information in the music information table T2000 is always “music”.

<Persons Folder 2021>

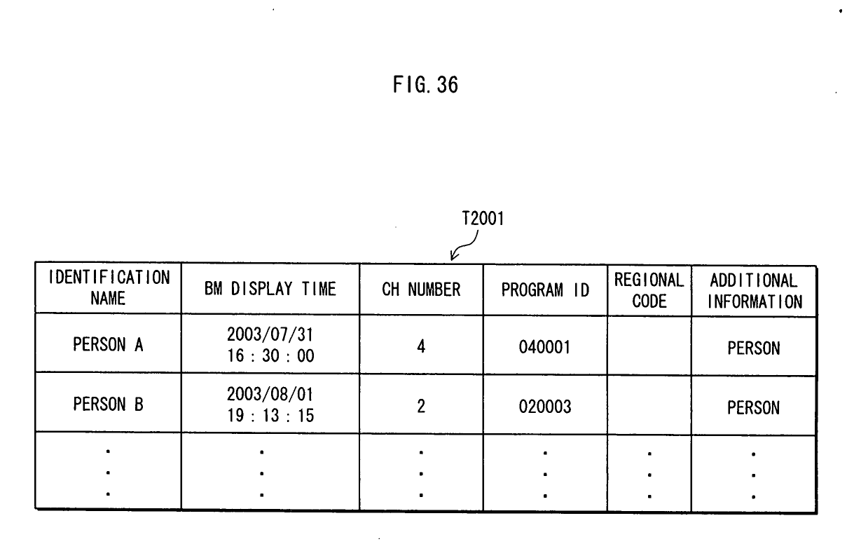

The persons folder 2021 includes a persons information table T2001, an example of which is shown in FIG. 36.

The description of data structure of the persons information table T2001 is omitted since it is the same as that of the music information table T2000.

It should be noted here that the additional information in the persons information table T2001 is always “person”.

<Characters Folder 2022>

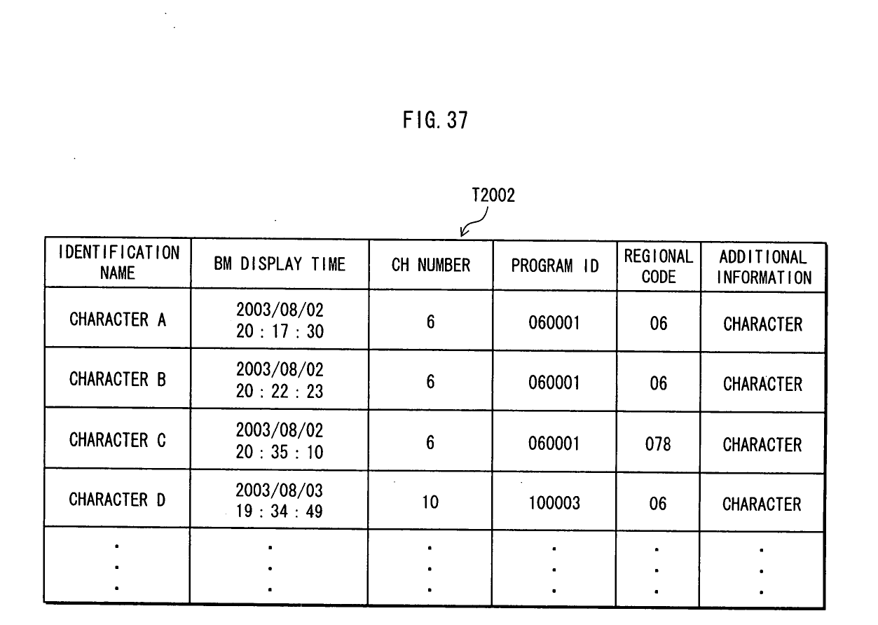

The characters folder 2022 includes a characters information table T2002, an example of which is shown in FIG. 37.

The description of data structure of the characters information table T2002 is omitted since it is the same as that of the music information table T2000.

It should be noted here that the additional information in the characters information table T2002 is always “character”.

<Captures Folder 2023>

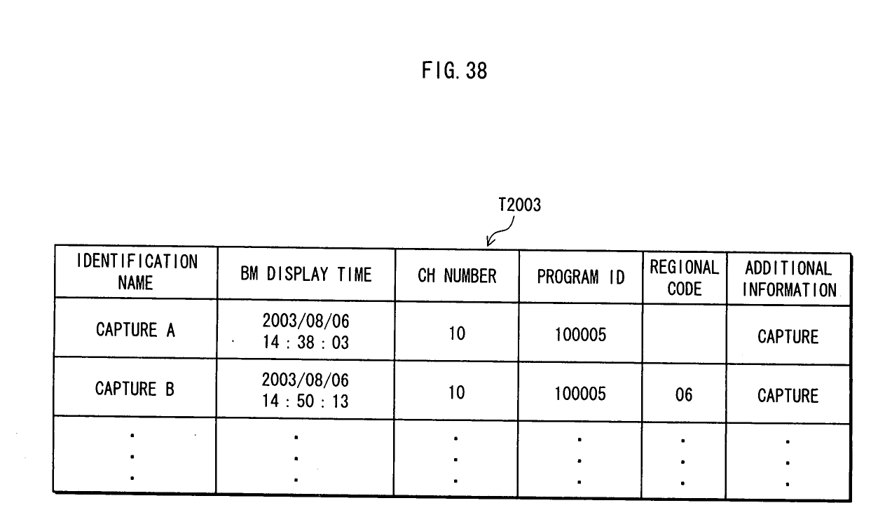

The captures folder 2023 includes a captures information table T2003, an example of which is shown in FIG. 38.

The description of data structure of the captures information table T2003 is omitted since it is the same as that of the music information table T2000.

It should be noted here that the additional information in the captures information table T2003 is always “capture”.

(3) Playback Unit 2003

The playback unit 2003 includes a playback information storage area for storing CH numbers, program IDs, and recording start times that correspond to program contents to be played back, respectively.

The playback unit 2003 plays back a program content stored in the program content storing unit 2001. When it plays back a program content, the playback unit 2003 outputs the program content to the monitor 11 via the output unit 2007.

Also, when it receives a still or moving image corresponding to the bookmark information from the data reading unit 2005, the playback unit 2003 outputs the received still or moving image to the monitor 11 via the output unit 2007. When the playback unit 2003 outputs a moving image, it outputs the corresponding sound/voice as well. This enables the still or moving image corresponding to the bookmark information to be played back.

Upon receiving, from the registration unit 2004, BM screen data specifying a bookmark, during a playback of a program content, the playback unit 2003 outputs the received BM screen data together with the program content to be played back to the monitor 11 via the output unit 2007 to display them.

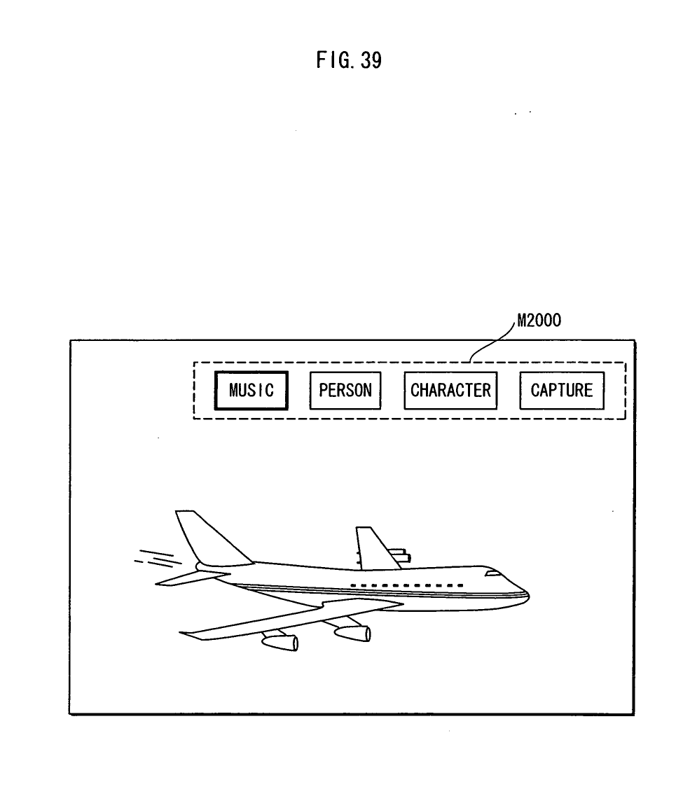

FIG. 39 shows an example of a screen displaying BM screen data and the program content being played back. A BM image M2000 shown in FIG. 39 is an image that is displayed based on the BM screen data, and includes four items: music, person, character, and capture. Among these items, the item encircled by the thick frame is the object of bookmarking. It should be noted here that immediately after a BM image starts to be displayed, the music item is encircled by the thick frame, and then the object of bookmarking is changed by the user through operations on the remote controller 2300.

When it plays back a program content, the playback unit 2003 stores into the playback information storage area a CH number, a program ID, and a recording start time that correspond to the program content to be played back, and deletes the CH number, program ID, and recording start time when it ends the playback of the program content.

(4) Registration Unit 2004

The registration unit 2004 includes an information generating unit 2030, a data acquiring unit 2031, and a writing unit 2032. The following describes the information generating unit 2030, data acquiring unit 2031, and writing unit 2032.

(a) Information Generating Unit 2030

The information generating unit 2030 preliminarily stores the BM screen data, and has an object storage area for storing information of an object of bookmarking.

The information generating unit 2030 counts the number of frames played back in a playback of a program content by the playback unit 2003.

When, during a playback of a program content, the information generating unit 2030 receives, from the remote controller 2300 via the reception unit 2008, BM start information that indicates starting of bookmarking, the information generating unit 2030 outputs the BM screen data to the playback unit 2003, and stores information indicating “music” into the object storage area, as the initial state.

When it receives move-to-right information or move-to-left information from the remote controller 2300 via the reception unit 2008, the information generating unit 2030 changes the item encircled by the thick frame according to the received information, and updates the information stored in the object storage area to the information corresponding to the new item encircled by the thick frame. For example, when it receives move-to-right information when the item “music” is encircled by the thick frame (when the object storage area stores information indicating “music”), the information generating unit 2030 changes the item encircled by the thick frame to “person”, and updates the information stored in the object storage area to the information indicating “person”.

While displaying the BM image M2000, the information generating unit 2030 receives from the remote controller 2300 via the reception unit 2008 any of (i) bookmark instruction information including a first registration instruction, (ii) bookmark instruction information including a second registration instruction, (iii) bookmark instruction information including the second registration instruction and a regional code, and (iv) bookmark instruction information including the first registration instruction and a regional code. These functions constitute an information receiving unit that receives (a) information that indicates a type of an object of bookmarking (correspondence information) and (b) a regional code.

The information generating unit 2030 calculates, from the number of frames counted until before the bookmark instruction information is received, an elapse time for a section that extends between image data at the start of the program content and image data being played back by the playback unit 2003 when the bookmark instruction information is received. The information generating unit 2030 acquires the recording start time stored in the playback unit 2003, and adds the calculated elapse time to the acquired recording start time to acquire the BM display time of the bookmarked image data. The information generating unit 2030 further acquires the CH number and program ID that correspond to the program content being played back by the playback unit 2003. This makes it possible to identify a frame at the time when the bookmark instruction information is received, from the acquired broadcast time by taking into consideration the relationship between the acquired broadcast time and the number of frames that are played back per second. These functions constitute a position acquiring unit that acquires information (in the present example, the broadcast time) that indicates a position in the program content corresponding to the time when the bookmark instruction information is received.

The information generating unit 2030 further receives the identification name from the remote controller 2300 via the reception unit 2008.

If it receives bookmark instruction information including the first or second registration instruction, the information generating unit 2030 generates bookmark information from the received identification name, the acquired BM display time, the CH number and program ID, and the information stored in the object storage area. In this case, no information is recorded as the regional code.

If it receives bookmark instruction information including a regional code and the first or second registration instruction, the information generating unit 2030 generates bookmark information from the received identification name, the acquired BM display time, the CH number and program ID, the received regional code, and the information stored in the object storage area.

(b) Data Acquiring Unit 2031

The data acquiring unit 2031 preliminarily stores: the number of still images (for example, 300) that constitute a moving image; a program that performs a music recognition process (hereinafter the program is referred to as “music recognition process”); a program that performs a person recognition process (hereinafter the program is referred to as “person recognition process”); a program that performs a character recognition process (hereinafter the program is referred to as “character recognition process”); a program that performs a capture recognition process (hereinafter the program is referred to as “capture recognition process”); and a program that performs a corner recognition process (hereinafter the program is referred to as “corner recognition process”).

The music recognition process is a process in which a music start frame, which is positioned at the start of a music section that is a section in which a characteristic sound is repeated cyclically, is searched using a predetermined algorithm. The person recognition process is a process in which a person start frame, in which a person indicated by the image data corresponding to the BM display time included in the bookmark information appears for the first time in the image data of the program content, is searched using a predetermined algorithm. The character recognition process is a process in which a character start frame, in which a subtitle appears for the first time in the image data of the program content, is searched using a predetermined algorithm. The capture recognition process is a process in which a capture start frame, which is a start frame of a scene switched from another scene, is searched using a predetermined algorithm, where each scene is composed of a plurality of frames that were shot consecutively in time. The corner recognition process is a process in which a video section that includes a specific content is searched using a predetermined algorithm. For example, the corner may be a section between (a) a position at which a commercial message switches to a program and (b) a position at which the program switches to a commercial message. As explained above, a program content has one or more corners, and a specific frame (for example, a silent frame) is present immediately before a corner starts or immediately after a corner ends. Accordingly, the corner recognition process can detect a corner by detecting such a specific frame. In the corner recognition process, a corner is detected by first detecting a position in a program content that corresponds to the BM display information, and then detecting a specific frame that is before or after the detected position in the program content.

The data acquiring unit 2031 acquires from the program content storing unit 2001 a program content that corresponds to the CH number and the program ID included in the bookmark information that was generated by the information generating unit 2030.

If the information generating unit 2030 receives the first registration instruction, the data acquiring unit 2031 acquires a still image or a moving image from the acquired program content by using by the BM display time and performing a recognition process that corresponds to the information indicated by the additional information. The acquisition method will be described later. It should be noted here that hereinafter, a program content that corresponds to the CH number and program ID contained in the bookmark information is referred to as “BM object content”.

If the information generating unit 2030 receives the second registration instruction, the data acquiring unit 2031 detects, in the acquired BM object content, a corner including image data that corresponds to the information stored in the object storage area of the information generating unit 2030, using the BM display time and performing the corner recognition process, and acquires all the image data included in the detected corner by copying, namely, acquires a moving image. These functions constitute a partial content acquiring unit that acquires a bookmarked still image or moving image from a program content.

<Acquisition Method>

The data acquiring unit 2031 judges whether or not the additional information included in the bookmark information generated by the information generating unit 2030 is “music”. If it judges that the additional information is “music”, the data acquiring unit 2031 detects in the BM object content a music start frame that is before and closest to the frame indicated by the BM display time, by performing the music recognition process using the BM display time included in the bookmark information and the BM object content. The data acquiring unit 2031 then acquires, by copying, 300 consecutive frames starting with the detected music start frame. The data acquiring unit 2031 also acquires, by copying, sound/voice data that corresponds to each of the acquired frames. That is to say, the data acquiring unit 2031 acquires 300 frames including the music start frame and the sound/voice data corresponding to the frames, by copying. This indicates that the data acquiring unit 2031 acquires a moving image and the sound/voice by copying.

If it judges that the additional information is not “music”, the data acquiring unit 2031 judges whether or not the additional information is “person”. If it judges that the additional information is “person”, the data acquiring unit 2031 detects in the BM object content a person start frame that is before and closest to the frame indicated by the BM display time, by performing the person recognition process using the BM display time included in the bookmark information and the BM object content. The data acquiring unit 2031 then acquires the detected person start frame by copying.

If it judges that the additional information is not “person”, the data acquiring unit 2031 judges whether or not the additional information is “character”. If it judges that the additional information is “character”, the data acquiring unit 2031 detects in the BM object content a character start frame that is before and closest to the frame indicated by the BM display time, by performing the character recognition process using the BM display time included in the bookmark information and the BM object content. The data acquiring unit 2031 then acquires the detected character start frame by copying.

If it judges that the additional information is not “character”, that is to say, if it judges that the additional information is “capture”, the data acquiring unit 2031 detects in the BM object content a capture start frame that is before and closest to the frame indicated by the BM display time, by performing the capture recognition process using the BM display time included in the bookmark information and the BM object content. The data acquiring unit 2031 then acquires the detected capture start frame by copying.

It should be noted here that the phrase “being before the frame” means that the position in question is between the program content start position and the position indicated by the BM display time.

(C) Writing Unit 2032

The writing unit 2032 records the bookmark information and the still or moving image acquired by the data acquiring unit 2031 into the music information table T2000, person information table T2001, character information table T2002, or capture information table T2003, with indication of correspondence between them, in accordance with the additional information included in the bookmark information generated by the information generating unit 2030. When a moving image is stored, sound/voice data related to the moving image is stored as well.

The correspondence between the bookmark information and the still image is indicated by, for example, correlating the bookmark information with the storage address of the still image. Also, The correspondence between the bookmark information and the moving image is indicated by, for example, correlating the bookmark information with the storage address of the image that is at the start of the moving image.

These functions constitute a writing unit that writes the bookmarked image.

(5) Data Reading Unit 2005

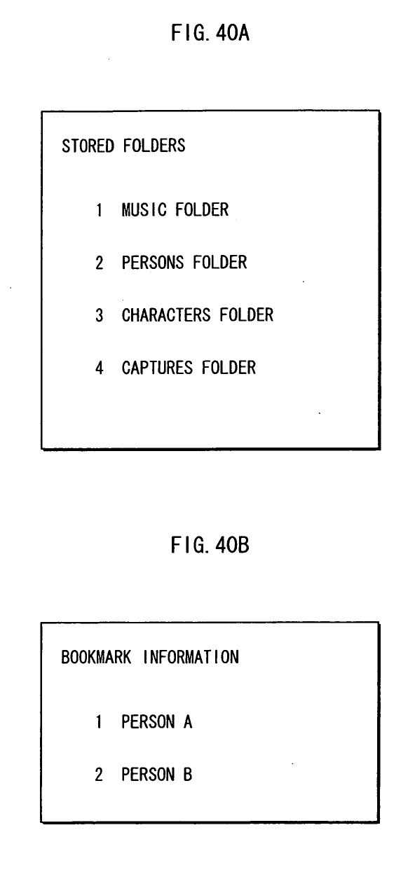

The data reading unit 2005, upon receiving, from the remote controller 2300 via the reception unit 2008, display start information that indicates starting display of bookmarked image data, assigns, as shown in FIG. 40A as one example, different numbers to folder names of the folders stored in the bookmark storing unit 2002, generates a storage destination list composed of pairs of an assigned number and a folder name, and displays the generated storage destination list on the monitor 11 via the output unit 2007, to urge selection of a storage destination of the bookmark information. The data reading unit 2005 receives selected folder information, which indicates a selected storage destination, from the remote controller 2300 via the reception unit 2008. Here, the selected folder information is composed of a number assigned to the selected folder.

The data reading unit 2005 further acquires identification names from each piece of bookmark information recorded in the folder indicated by the selected folder information. For example, if the selected folder information indicates the persons folder, the data reading unit 2005 acquires identification names “person A” and “person B” from all the bookmark information recorded in the persons folder 2021 of the bookmark storing unit 2002.

The data reading unit 2005 generates a list composed of all the acquired identification names, and displays the generated list on the monitor 11 via the output unit 2007. One example of the displayed list is shown in FIG. 40B. Here, the list includes different numbers assigned to each identification name.

The data reading unit 2005 receives selected identification name information, which indicates a selected identification name, from the remote controller 2300 via the reception unit 2008.

These functions constitute a request receiving unit that receives an output request for the bookmarked image.

The data reading unit 2005 acquires, from the bookmark storing unit 2002, bookmark information that corresponds to the identification name indicated in the received selected identification name information. Here, the selected identification name information is composed of a number assigned to the selected identification name.

The data reading unit 2005 reads, from the bookmark storing unit 2002, a still or moving image that corresponds to the acquired bookmark information. These functions constitute a reading unit that reads a still image, or a moving image and a sound/voice, from the bookmark storing unit 2002.

The data reading unit 2005 displays the read still or moving image on the monitor 11 via the playback unit 2003 and the output unit 2007. when it displays a moving image, the data reading unit 2005 acquires the corresponding sound/voice data from the bookmark storing unit 2002, and outputs the acquired sound/voice data from the monitor 11 via the playback unit 2003 and the output unit 2007. Upon receiving the sound/voice data, the monitor 11 outputs a sound/voice based on the sound/voice data. These functions constitute an output unit that outputs a partial content composed of a still image read from the bookmark storing unit 2002, or a partial content composed of a moving image and a sound/voice read from the bookmark storing unit 2002.

Also, upon receiving the display start information from the portable phone 2100 via the transmission/reception unit 2009, the data reading unit 2005 generates the storage destination list and transmits the generated storage destination list to the portable phone 2100 via the transmission/reception unit 2009. Upon receiving the selected folder information from the portable phone 2100 via the transmission/reception unit 2009, the data reading unit 2005 acquires identification names from each piece of bookmark information recorded in the folder indicated by the selected folder information.

The data reading unit 2005 generates a list composed of all the acquired identification names, and transmits the generated list to the portable phone 2100 via the transmission/reception unit 2009.

The data reading unit 2005 receives the selected identification name information from the portable phone 2100 via the transmission/reception unit 2009.

These functions constitute a reception unit that receives information that indicates a display instruction.

The data reading unit 2005 acquires, from the bookmark storing unit 2002, bookmark information that corresponds to the identification name indicated in the received selected identification name information.

The data reading unit 2005 reads, from the bookmark storing unit 2002, a still or moving image that corresponds to the acquired bookmark information. These functions constitute a reading unit that is the same as the above-described reading unit.

The data reading unit 2005 transmits the read still or moving image to the portable phone 2100 via the transmission/reception unit 2009. When it transmits a moving image, the data reading unit 2005 transmits sound/voice data related to the moving image to the portable phone 2100 via the transmission/reception unit 2009 as well. These functions constitute a content transmitting unit that transmits a partial content composed of a still image read from the bookmark storing unit 2002, or a partial content composed of a moving image and a sound/voice read from the bookmark storing unit 2002.

When it receives, from the portable phone 2100 via the transmission/reception unit 2009, a regional code and image data request information that requests bookmarked image data relating to a region including the current position, the data reading unit 2005 acquires from the bookmark storing unit 2002 all the bookmark information that includes a regional code matching the received regional code. For example, if the current position is Osaka City, the data reading unit 2005 acquires all the bookmark information that includes a regional code “06”. In this case, the data reading unit 2005 acquires from the characters folder 2022 the bookmark information that includes identification names “character A”, “character B”, and “character D”, and acquires from the captures folder 2023 the bookmark information that includes identification name “capture B”.

The data reading unit 2005 acquires a still image or a moving image that corresponds to each piece of the acquired bookmark information, using all the acquired bookmark information. The data reading unit 2005 transmits each of the read images to the portable phone 2100 via the transmission/reception unit 2009. When it transmits a moving image, the data reading unit 2005 transmits sound/voice data related to the moving image to the portable phone 2100 via the transmission/reception unit 2009 as well.

(6) Deletion Unit 2006

The deletion unit 2006 receives, from the remote controller 2300 via the reception unit 2008, deletion instruction information that indicates performing deletion of a program content recorded in the program content storing unit 2001. Here, the deletion instruction information is information that includes a program ID. These functions constitute a deletion receiving unit that receives a deletion instruction.

The deletion unit 2006 deletes a program content that corresponds to the program ID included in the received deletion instruction information. Therefore, the deletion unit 2006 can delete the program content from the program content storing unit 2001, leaving the images stored in the bookmark storing unit 2002. These functions constitute a deletion unit that deletes a program content.

(7) Output Unit 2007

The output unit 2007 receives data of a program content to be played back from the playback unit 2003, and outputs the received data to the monitor 11. This causes the monitor 11 to display the played-back program content.

The output unit 2007 receives data from the data reading unit 2005 via the playback unit 2003, and outputs the received data to the monitor 11. This causes the monitor 11 to display a still or moving image that corresponds to the bookmark information.

(8) Reception Unit 2008

The reception unit 2008, upon receiving, from the remote controller 2300, the BM start information, move-to-right information, move-to-left information, bookmark instruction information, and identification name, the reception unit 2008 outputs the received BM start information, move-to-right information, move-to-left information, bookmark instruction information, and identification name to the registration unit 2004.

Upon receiving the display start information, selected folder information, and selected identification name information

When the BM button 2311 is depressed, the remote controller 2300 transmits the bookmark instruction information including the first registration instruction information to the playback apparatus 2000 via the radiation unit 2303. When the BM button 2311 is depressed and a regional code is input by operating the character operation unit 2302, the remote controller 2300 transmits the bookmark instruction information composed of the first registration instruction information and the regional code to the playback apparatus 2000 via the radiation unit 2303.

When the corner button 2312 is depressed, the remote controller 2300 transmits the bookmark instruction information including the second registration instruction information to the playback apparatus 2000 via the radiation unit 2303. When the corner button 2312 is depressed and a regional code is input by operating the character operation unit 2302, the remote controller 2300 transmits the bookmark instruction information composed of the second registration instruction information and the regional code to the playback apparatus 2000 via the radiation unit 2303.

When the input button 2321 is depressed and then the buttons of the character operation unit 2302 are depressed, the remote controller 2300 recognizes the input data as an identification name. And then when the enter button 2322 is depressed, the remote controller 2300 transmits the received identification name to the playback apparatus 2000 via the radiation unit 2303.

When the request button 2315 is depressed, the remote controller 2300 transmits the display start information to the playback apparatus 2000 via the radiation unit 2303.

Having selected a storage destination of the bookmark information, the user depresses a button with a number assigned to a folder selected by the user, and then the remote controller 2300 transmits the number of the depressed button to the playback apparatus 2000 via the radiation unit 2303 as the selected folder information.

Having selected an identification name included in the bookmark information, the user depresses a button with a number assigned to the identification name selected by the user, and then the remote controller 2300 transmits the number of the depressed button to the playback apparatus 2000 via the radiation unit 2303 as the selected identification name information.

When the deletion button 2320 is depressed, the remote controller 2300 transmits the deletion instruction information to the playback apparatus 2000 via the radiation unit 2303.

2.3 Construction of Portable Phone 2100

Here, the construction of the portable phone 2100 will be described.

The portable phone 2100 is a portable communication terminal apparatus and includes, as shown in FIG. 2, a regional information storing unit 2102, a radio unit 2103, a baseband signal processing unit 2104, a speaker 2105, a microphone 2106, a control unit 2107, an input unit 2108, an input unit 2108, and a display unit 2109.

The portable phone 2100 is specifically a computer system that includes a microprocessor, ROM, RAM, a display unit and the like. A computer program is stored in the ROM. The microprocessor operates in accordance with the computer program and causes the portable phone 2100 to achieve the functions.

(1) Regional Information Storing unit 2102

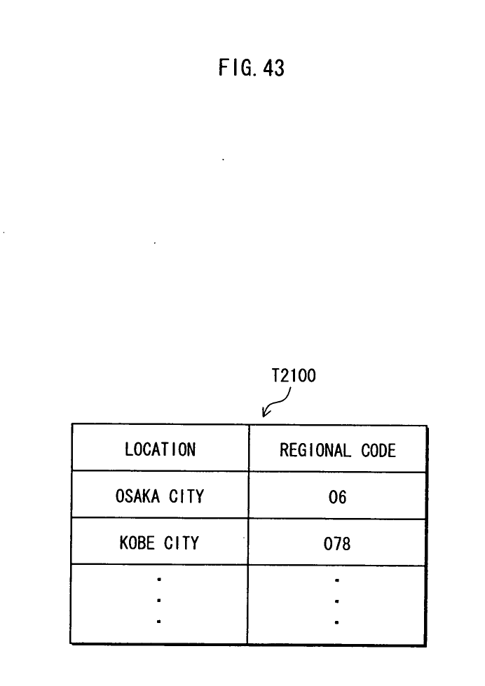

The regional information storing unit 2102 includes a regional information table T2100, an example of which is shown in FIG. 43.

The regional information table T2100 has an area for storing one or more sets of: a location; and a regional code.

Here, the location is information that indicates a name of a region such as Osaka City or Kobe City. The description of the regional code is omitted since it is the same as the regional code provided in the music information table T2000.

(2) Radio Unit 2103

The radio unit 2103, having an antenna 2400, performs transmission/reception of radio signals.

(3) Baseband Signal Processing Unit 2104

The baseband signal processing unit 2104 performs signal processing to output a signal, which was received from the radio unit 2103, to the speaker 2105. The baseband signal processing unit 2104 also performs signal processing to output sound/voice, which was received from the microphone 2106, to the radio unit 2103.

The baseband signal processing unit 2104 further receives information, which has been received via the Internet and the public radio communication network, from the radio unit 2103, and outputs the received information to the control unit 2107.

The baseband signal processing unit 2104 further receives the display start information, selected folder information, selected identification name information, and image data request information from the control unit 2107, and transmits the received display start information, selected folder information, selected identification name information, and image data request information to the playback apparatus 2000 via the radio unit 2103, the public radio communication network and the Internet. Upon receiving the image data request information from the control unit 2107, the baseband signal processing unit 2104 further receives a regional code, and transmits the received regional code together with the image data request information to the playback apparatus 2000 via the public radio communication network and the Internet. Upon receiving sound/voice data from the control unit 2107, the baseband signal processing unit 2104 performs signal processing to output the received sound/voice data to the speaker 2105.

(4) Speaker 2105

The speaker 2105 outputs signals, which have been processed and output by the baseband signal processing unit 2104, as sound/voice.

(5) Microphone 2106

The microphone 2106 receives sound/voice of the user, and outputs the received sound/voice to the baseband signal processing unit 2104.

(6) Control Unit 2107

The control unit 2107 preliminarily has a GPS (Global Positioning System) function for measuring positions, and controls the entire portable phone 2100.

The following describes the display of bookmarked image data according to a specification by the user (hereinafter referred to as “specification display”), and the display of bookmarked image data in relation to a region including the current position (hereinafter referred to as “regional display”).

<Specification Display>

The control unit 2107, upon receiving the display start information from the input unit 2108, outputs the received display start information to the baseband signal processing unit 2104.

Upon receiving the storage destination list from the playback apparatus 2000, the control unit 2107 outputs the received storage destination list to the display unit 2109.

Upon receiving the selected folder information, which the user inputs through key operations, from the input unit 2108, the control unit 2107 outputs the received selected folder information to the baseband signal processing unit 2104.

Upon receiving the list from the playback apparatus 2000 via the Internet and the public radio communication network, the control unit 2107 outputs the received list to the display unit 2109.

Upon receiving the selected identification name information, which the user inputs through key operations, from the input unit 2108, the control unit 2107 outputs the received selected identification name information to the baseband signal processing unit 2104.

Upon receiving the still or moving image that corresponds to the bookmark information including the selected identification name from the playback apparatus 2000 via the Internet and the public radio communication network, the control unit 2107 outputs the received still or moving image to the display unit 2109.

When it receives the moving image, the control unit 2107 also receives sound/voice data related to the moving image, and outputs the received sound/voice data to the speaker 2105 via the baseband signal processing unit 2104. This causes the control unit 2107 to play back the received moving image.

<Regional Display>

The control unit 2107, upon receiving from the input unit 2108 regional display information that indicates a display of bookmarked image data related to a region containing the current position, measures the current position using the GPS function. The control unit 2107 acquires from the regional information storing unit 2102 a regional code that corresponds to the region detected by the measurement.

The control unit 2107 outputs the acquired regional code and the image data request information to the baseband signal processing unit 2104.

Upon receiving, from the playback apparatus 2000 via the Internet and the public radio communication network, the still or moving image that corresponds to the bookmark information related to the transmitted regional code, the control unit 2107 outputs the received still or moving image to the display unit 2109.

When it receives the moving image, the control unit 2107 also receives sound/voice data related to the moving image, and outputs the received sound/voice data to the speaker 2105 via the baseband signal processing unit 2104. This causes the control unit 2107 to play back the received moving image.

Upon receiving a plurality of still or moving images, the control unit 2107 receives preceding image information that instructs to switch to a preceding still or moving image, or receives subsequent image information that instructs to switch to a subsequent still or moving image, and controls still or moving images to be output to the display unit 2109.

(7) Input Unit 2108

The input unit 2108 includes a keyboard equipped with numerical input keys and the like for input functions and receives instructions input by the user.

Upon receiving the display start information, selected folder information, selected identification name information, and image data request information, the input unit 2108 outputs the received display start information, selected folder information, selected identification name information, and image data request information to the control unit 2107. Upon receiving the image data request information, the input unit 2108 further receives a regional code, and outputs the received regional code together with the image data request information to the control unit 2107.

Upon receiving the preceding image information, the input unit 2108 outputs the received preceding image information to the control unit 2107. Also, upon receiving the subsequent image information, the input unit 2108 outputs the received subsequent image information to the control unit 2107.

(8) Display Unit 2109

The display unit 2109, upon receiving the storage destination list from the control unit 2107, displays the received storage destination list.

The display unit 2109, upon receiving the list from the control unit 2107, displays the received list.

The display unit 2109 further displays a still image or a moving image received from the control unit 2107.

2.4 Operation of Bookmark System 2

The following describes the operation of the bookmark system 2.

2.4.1 Operation of BM Registration Process

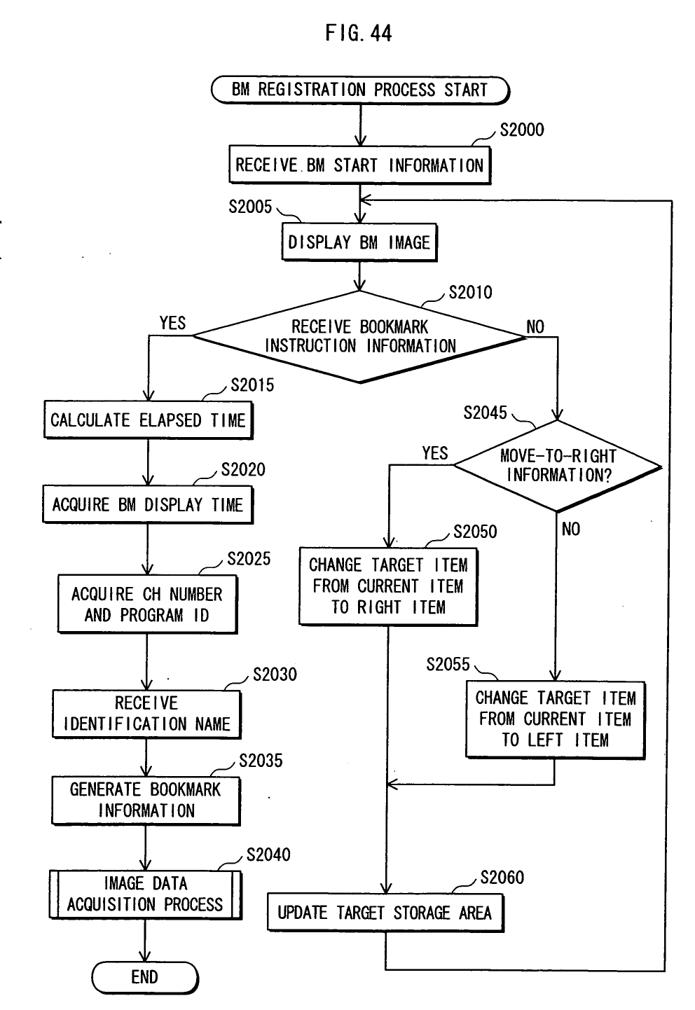

Here, operation of the BM registration process for registering the bookmark information will be described with reference to the flowchart shown in FIG. 44.

When the information generating unit 2030 of the playback apparatus 2000 receives the BM start information from the user via the 2300, the information generating unit 2030 outputs the BM screen data, which is preliminarily stored, to the playback unit 2003, and stores information indicating “music” into the object storage area, as the initial state (step S2000). The playback unit 2003 displays a BM image on the monitor 11 via the output unit 2007, based on the BM screen data received from the information generating unit 2030 (step S2005).

The information generating unit 2030 judges whether or not the information received from the user via the remote controller 2300 is the bookmark instruction information (step S2010).

If it judges that the information is the bookmark instruction information (“YES” in step S2010), the information generating unit 2030 calculates an elapse time from the image data at the start of the program content to the image data that was being played back by the playback unit 2003 when the bookmark instruction information was received (step S2015).

The information generating unit 2030 acquires the recording start time from the playback unit 2003, and acquires the BM display time of the bookmarked image data by adding the calculated elapse time to the acquired recording start time (step S2020). The information generating unit 2030 further acquires from the playback unit 2003 the CH number and program ID that correspond to the program content being played back (step S2025).

The information generating unit 2030 further receives an identification name from the remote controller 2300 via the reception unit 2008 (step S2030).

Upon receiving the bookmark instruction information including the first registration instruction or the second registration instruction, the information generating unit 2030 generates the bookmark information using the received identification name, the acquired BM display time, CH number, and program ID, and the information stored in the object storage area (step S2035). At this point in time, the regional code has no information. Also, if it receives the bookmark instruction information including the first registration instruction and a regional code, or if it receives the bookmark instruction information including the second registration instruction and a regional code, the information generating unit 2030, in step S2035, generates the bookmark information using the received identification name, the acquired BM display time, CH number, and program ID, the received regional code, and the information stored in the object storage area.

After generating the bookmark information, the playback apparatus 2000 acquires a still or moving image that corresponds to the generated bookmark information, and performs the image data acquisition process (step S2040).

If it judges that the information is not the bookmark instruction information (“NO” in step S2010), the information generating unit 2030 judges whether or not the received information is the move-to-right information (step S2045).

If it judges that the information is the move-to-right information (“YES” in step S2045), the information generating unit 2030 changes the bookmarking target item from the current item to the right item in the currently displayed BM image (step S2050). If it judges that the information is not the move-to-right information (“NO” in step S2045), the information generating unit 2030 changes the bookmarking target item from the current item to the left item in the currently displayed BM image (step S2055) The information generating unit 2030 then updates the information currently stored in the object storage area to information corresponding to the item after the change (step S2060), and returns to step S2005.

2.4.2 Image Data Acquisition Process

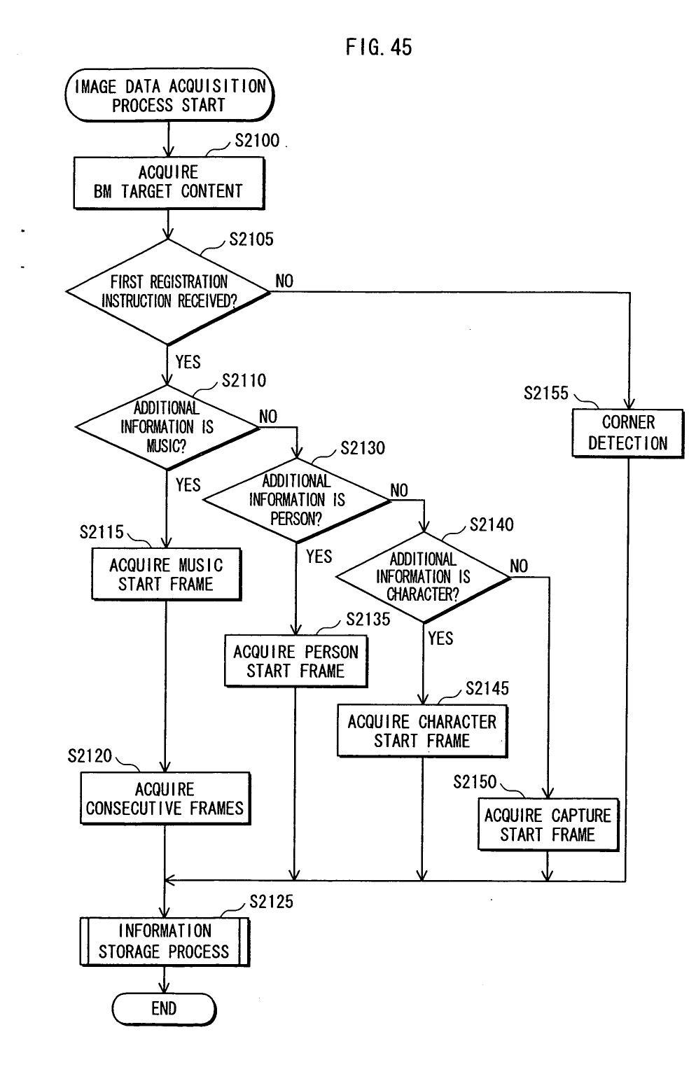

Here will be described the operation of the image data acquisition process performed by the playback apparatus 2000, with reference to the flowchart shown in FIG. 45.

The data acquiring unit 2031 of the playback apparatus 2000 acquires, from the program content storing unit 2001, a BM object content that corresponds to the CH number and program ID included in the bookmark information generated by the information generating unit 2030 (step S2100).

The data acquiring unit 2031 judges whether or not the instruction included in the bookmark instruction information received by the information generating unit 2030 is the first registration instruction (step S2105).

If it judges that it is the first registration instruction (“YES” in step S2105), the data acquiring unit 2031 judges whether or not the additional information included in the bookmark information generated by the information generating unit 2030 is “music” (step S2110). If it judges that the additional information is “music” (“YES” in step S2110), the data acquiring unit 2031 detects and acquires a music start frame from the acquired program content, by performing the music recognition process using the BM display time included in the bookmark information and the BM object content (step S2115). The data acquiring unit 2031 then acquires, by copying, a predetermined number of consecutive frames starting with the acquired music start frame, and also acquires sound/voice data by copying (step S2120). In step S2115, sound/voice data corresponding to the acquired music start frame is also acquired by copying.

The writing unit 2032 of the playback apparatus 2000 performs the information storage process in which it records the bookmark information generated by the information generating unit 2030 and consecutive frames starting with the acquired music start frame, namely a moving image starting with the music start frame into the music information table T2000, person information table T2001, character information table T2002, or capture information table T2003, with indication of correspondence between them, in accordance with the additional information included in the bookmark information (step S2125). It should be noted here that when a moving image is stored, sound/voice data related to the moving image is stored as well.

If it judges that the additional information included in the bookmark information is not “music” (“NO” in step S2110), the data acquiring unit 2031 judges whether or not the additional information is “person” (step S2130).

If it judges that the additional information is “person” (“YES” in step S2130), the data acquiring unit 2031 detects and acquires a person start frame from the acquired program content, by performing the person recognition process using the BM display time included in the bookmark information and the BM object content (step S2135), and performs step S2125.

If it judges that the additional information is not “person” (“NO” in step S2130), the data acquiring unit 2031 judges whether or not the additional information is “character” (step S2140) If it judges that the additional information is “character” (“YES” in step S2140), the data acquiring unit 2031 detects and acquires a character start frame from the acquired program content, by performing the character recognition process using the BM display time included in the bookmark information and the BM object content (step S2145), and performs step S2125.

If it judges that the additional information is not “character” (“NO” in step S2140), that is to say, if it judges that the additional information is “capture”, the data acquiring unit 2031 detects and acquires a capture start frame from the acquired program content, by performing the capture recognition process (step S2150), and performs step S2125.

If it judges that the instruction is not the first registration instruction (“NO” in step S2105), the data acquiring unit 2031 detects, in the acquired BM object content, a corner including image data that corresponds to the information stored in the object storage area of the information generating unit 2030, using the BM display time and performing the corner recognition process, and acquires all the image data included in the detected corner, namely, acquires a moving image (step S2155), and performs step S2125.

It should be noted here that the phrase “to detect and acquire a frame” means to detect a frame and acquire the detected frame by copying.

2.4.3 Operation of Bookmark Information Storage Process

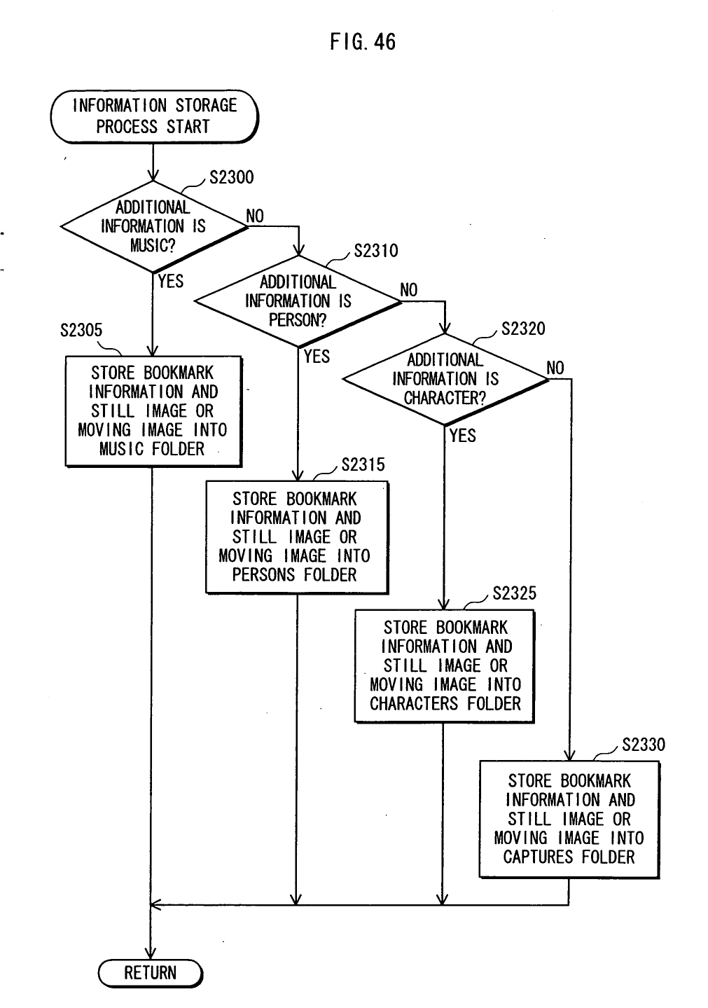

Here will be described the operation of the information storage process performed by the playback apparatus 2000, with reference to the flowchart shown in FIG. 46.

The writing unit 2032 judges whether or not the additional information included in the bookmark information generated by the information generating unit 2030 is “music” (step S2300).

If it judges that the additional information is “music” (“YES” in step S2300), the writing unit 2032 writes the bookmark information and the still or moving image acquired by the data acquiring unit 2031 into the music folder 2020 (step S2305), and if it judges that the additional information is not “music” (“NO” in step S2300), the writing unit 2032 judges whether or not the additional information is “person” (step S2310).

If it judges that the additional information is “person”, the writing unit 2032 writes the bookmark information and the still or moving image acquired by the data acquiring unit 2031 into the persons folder 2021 (step S2315), and if it judges that the additional information is not “person”, the writing unit 2032 judges whether or not the additional information is “character” (step S2320).

If it judges that the additional information is “character” (“YES” in step S2320), the writing unit 2032 writes the bookmark information and the still or moving image acquired by the data acquiring unit 2031 into the characters folder 2022 (step S2325), and if it judges that the additional information is not “character” (“NO” in step S2320), that is to say, if it judges that the additional information is “capture”, the writing unit 2032 writes the bookmark information and the still or moving image acquired by the data acquiring unit 2031 into the captures folder 2023 (step S2330).

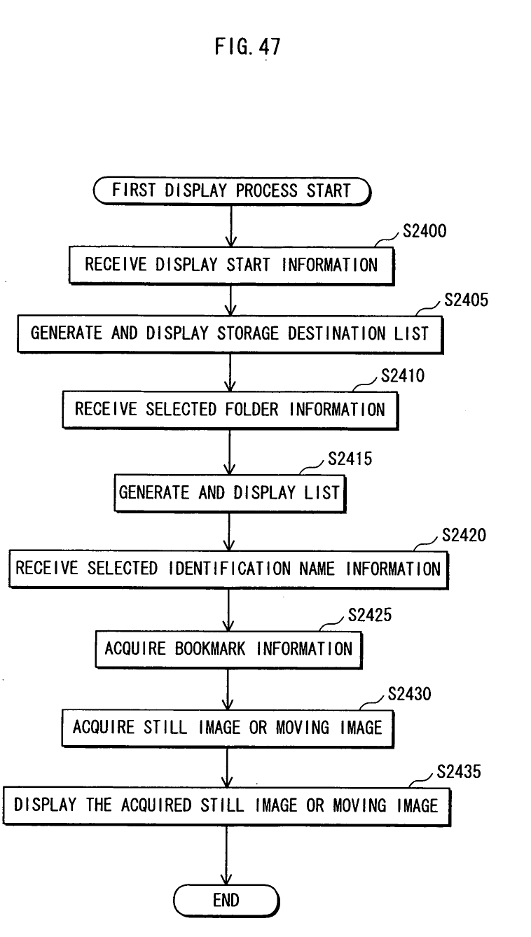

It should be noted here that when the writing unit 2032 write a moving image into the corresponding folder, it writes sound/voice data as well. 2.4.4 Operation of First Display Process Here will be described the operation of the first display process that is performed by the playback apparatus 2000 when it receives the display start information from the remote controller 2300, with reference to the flowchart shown in FIG. 47.

The data reading unit 2005, upon receiving, from the remote controller 2300 via the reception unit 2008, display start information (step S2400), generates a storage destination list and displays the generated storage destination list on the monitor 11 via the output unit 2007, to urge selection of a storage destination of the bookmark information (step S2405).

The data reading unit 2005 receives selected folder information from the remote controller 2300 via the reception unit 2008 (step S2410).

The data reading unit 2005 further acquires all the identification names from each piece of bookmark information recorded in the folder indicated by the selected folder information, generates a list composed of all the acquired identification names, and displays the generated list on the monitor 11 via the output unit 2007 (step S2415).

The data reading unit 2005 receives selected identification name information from the remote controller 2300 via the reception unit 2008 (step S2420), and then acquires, from the bookmark storing unit 2002, bookmark information that corresponds to the identification name indicated in the received selected identification name information (step S2425).

The data reading unit 2005 reads, from the bookmark storing unit 2002, a still or moving image that corresponds to the acquired bookmark information (step S2430, and then displays the read still or moving image on the monitor 11 via the playback unit 2003 and the output unit 2007 (step S2435). when it displays a moving image, the data reading unit 2005 outputs the corresponding sound/voice data from the monitor 11 via the output unit 2007.

In the above description, the display process is explained through an operation performed between the playback apparatus 2000 and the remote controller 2300. However, a similar operation may be performed between the playback apparatus 2000 and the portable phone 2100, with only differences in the routes of various types of information. The various types of information that the data reading unit 2005 receives from the remote controller 2300 are sent from the portable phone 2100 via the public radio communication network, the Internet and the transmission/reception unit 2009, and the information that the data reading unit 2005 displays on the monitor 11 via the playback unit 2003 and the output unit 2007 are transmitted to the portable phone 2100 via the Internet, the public radio communication network, and the transmission/reception unit 2009.

2.4.5 Operation of Second Display Process

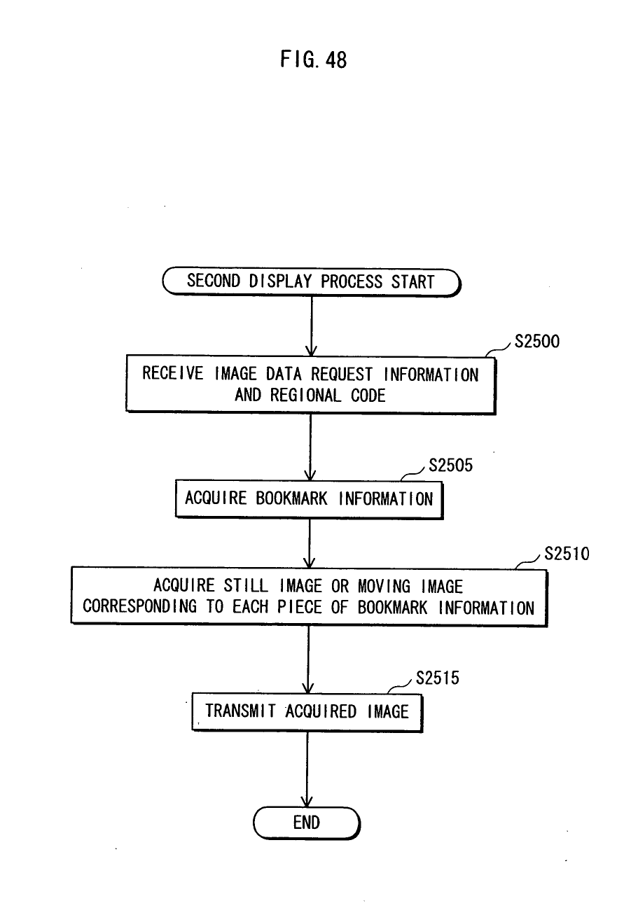

Here will be described the operation of the second display process that is performed by the playback apparatus 2000 when it receives the image data request information and a regional code from the portable phone 2100, with reference to the flowchart shown in FIG. 48.

When it receives the image data request information and a regional code from the portable phone 2100 via the transmission/reception unit 2009 (step S2500), the data reading unit 2005 acquires from the bookmark storing unit 2002 all the bookmark information that includes a regional code matching the received regional code (step S2505).

The data reading unit 2005 acquires a still image or a moving image that corresponds to each piece of the acquired bookmark information, using all the acquired bookmark information (step S2510). The data reading unit 2005 transmits each of the read images to the portable phone 2100 via the transmission/reception unit 2009. When it transmits a moving image, the data reading unit 2005 transmits sound/voice data related to the moving image to the portable phone 2100 via the transmission/reception unit 2009 as well (step S2515).

2.5 Conclusion

As described above, according to the present invention, when it receives a bookmark instruction from a remote controller while playing back a content, the playback apparatus generates bookmark information, acquires a still or moving image corresponding to the generated bookmark information, and stores the generated bookmark information and the acquired still or moving image with indication of the correspondence between them. This enables the playback apparatus to, when it receives an instruction later from the remote controller or the portable phone, display a still or moving image corresponding to the stored bookmark information.

It may happen that the actually bookmarked image data is different from the image data that the user intended to bookmark at the bookmark registration, due to the time required between the transmission and reception of the bookmark instruction information. However, the above-described playback apparatus can acquire the image data, which the user desires, in a more accurate manner than conventional apparatuses by performing, at the image data acquisition, are cognition process, among the music recognition process, person recognition process, character recognition process, and capture recognition process, that corresponds to the information contained in the additional information, and can store the acquired image data.

Also, the playback apparatus makes it easy to arrange the bookmark information since it automatically assigns the generated bookmark information to the folders in accordance with its contents.

2.6 Modification on Image Acquisition

In the above-described embodiment, when the bookmark information is generated, a still or moving image corresponding to the bookmark information is acquired, and the generated bookmark information and the acquired still or moving image are stored with indication of the correspondence between them. The present modification is a modification of the acquisition of an image corresponding to the bookmark information that is performed when a display request is received.

The following describes a playback apparatus 3000 in the present modification.

It should be noted here that the remote controller and the portable phone used in the modification are the same as the remote controller 2300 and the portable phone 2100 having been described above, and that the description thereof is omitted. In the following description, the monitor 11, remote controller 2300, and portable phone 2100 are used.

2.6.1 Playback apparatus 3000

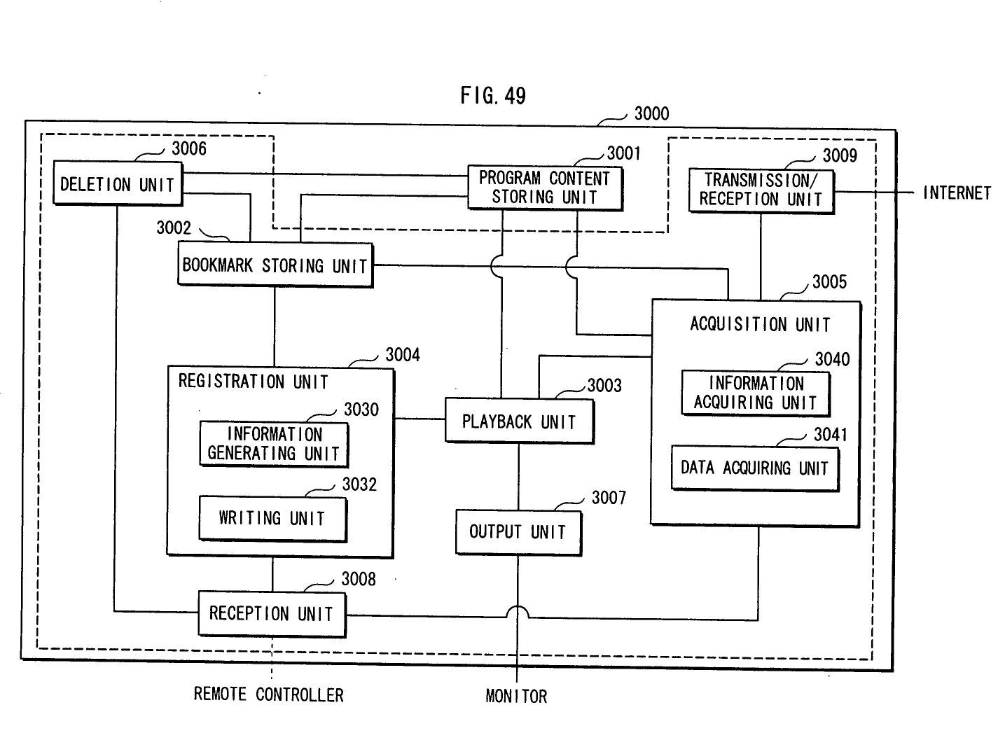

The playback apparatus 3000 includes, as shown in FIG. 49, a program content storing unit 3001, a bookmark storing unit 3002, a playback unit 3003, a registration unit 3004, an acquisition unit 3005, a deletion unit 3006, an output unit 3007, a reception unit 3008, and a transmission/reception unit 3009.

The playback apparatus 3000 is specifically a computer system that includes a microprocessor, ROM, RAM, a hard disk unit and the like. A computer program is stored in the ROM or the hard disk unit. The microprocessor operates in accordance with the computer program and causes the playback apparatus 3000 to achieve the functions.

(1) Program Content Storing Unit 3001

The program content storing unit 3001 is the same as the program content storing unit 2001 described above, and description thereof is omitted.

(2) Bookmark Storing Unit 3002

The bookmark storing unit 3002 has the same folder structure as the above-described bookmark storing unit 2002. The bookmark storing unit 3002 differs from the bookmark storing unit 2002 in that it additionally includes a flag that indicates whether or not to perform a corner detection.

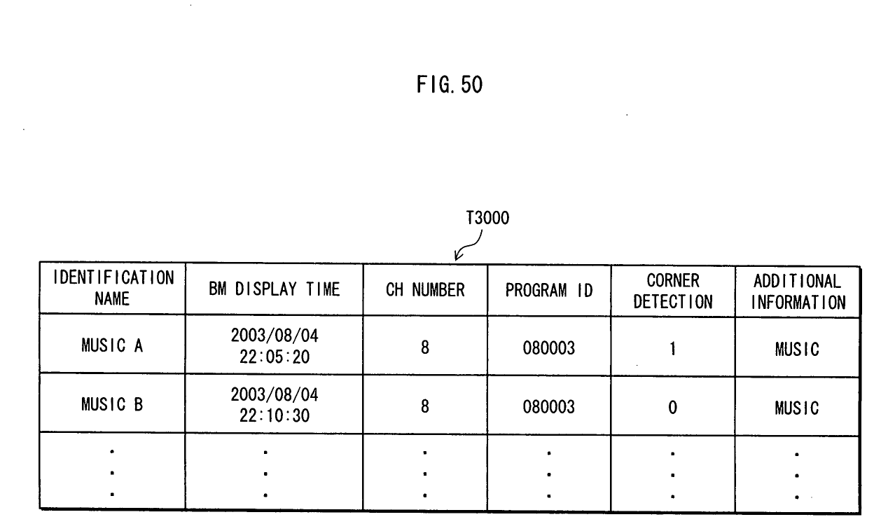

FIG. 50 shows one example of a music information table T3000.

The music information table T3000 has an area for storing one or more sets of: an identification name; a BM display time; a CH number; a program ID; a regional code; a corner detection; and additional information.

The corner detection is a flag that indicates whether or not to perform a corner detection. Value “1” in this flag indicates that the corner detection is performed; and value “0” indicates that the corner detection is not performed, but that an image corresponding to the additional information is acquired. The remaining items of the table are the same as those in Embodiment 2, and description thereof is omitted.

Also, the tables respectively stored in the other folders are constructed in the same manner as the music information table T3000, and description thereof is omitted.

(3) Playback Unit 3003

The playback unit 3003 is the same as the playback unit 2003 described above, and description thereof is omitted. In the following description, a BM image M2000 is used.

(4) Registration Unit 3004

The registration unit 3004 includes an information generating unit 3030 and a writing unit 3032. The following describes the information generating unit 3030 and the writing unit 3032.

(a) Information Generating Unit 3030

The information generating unit 3030 preliminarily stores the BM screen data, and has an object storage area for storing information of an object of bookmarking.

The information generating unit 3030 counts the number of frames played back in a playback of a program content by the playback unit 3003.

When the information generating unit 3030 receives the BM start information during a playback of a program content from the remote controller 2300 via the reception unit 3008, the information generating unit 3030 outputs the BM screen data to the playback unit 3003, and stores information indicating “music” into the object storage area, as the initial state.

When it receives move-to-right information or move-to-left information from the remote controller 2300 via the reception unit 3008, the information generating unit 3030 changes the item encircled by the thick frame according to the received information, and updates the information stored in the object storage area to the information corresponding to the new item encircled by the thick frame.

While displaying the BM image M2000, the information generating unit 3030 receives from the remote controller 2300 via the reception unit 3008 any of (i) bookmark instruction information including a first registration instruction, (ii) bookmark instruction information including a second registration instruction, (iii) bookmark instruction information including the second registration instruction and a regional code, and (iv) bookmark instruction information including the first registration instruction and a regional code. These functions constitute an information receiving unit that receives (a) information that indicates a type of an object of bookmarking (correspondence information) and (b) a regional code.

The information generating unit 3030 calculates, from the number of frames counted until before the bookmark instruction information is received, an elapse time for a section that extends between image data at the start of the program content and image data being played back by the playback unit 3003 when the bookmark instruction information is received. The information generating unit 3030 acquires the recording start time stored in the playback unit 3003, and adds the calculated elapse time to the acquired recording start time to acquire the BM display time of the bookmarked image data. The information generating unit 3030 further acquires the CH number and program ID that correspond to the program content being played back by the playback unit 3003. This makes it possible to identify a frame at the time when the bookmark instruction information is received, from the acquired broadcast time by taking into consideration the relationship between the acquired broadcast time and the number of frames that are played back per second. These functions constitute a position acquiring unit that acquires information (in the present example, the broadcast time) that indicates a position in the program content corresponding to the time when the bookmark instruction information is received.

The information generating unit 3030 further receives the identification name from the remote controller 2300 via the reception unit 3008.

If it receives bookmark instruction information including the first registration instruction, the information generating unit 3030 generates bookmark information from the received identification name, the acquired BM display time, the CH number and program ID, the information stored in the object storage area, and the corner detection flag “0”. In this case, no information is recorded as the regional code.

If it receives bookmark instruction information including the second registration instruction, the information generating unit 3030 generates bookmark information from the received identification name, the acquired BM display time, the CH number and program ID, the information stored in the object storage area, and the corner detection flag “1”. In this case, no information is recorded as the regional code.

If it receives bookmark instruction information including the first registration instruction and a regional code, the information generating unit 3030 generates bookmark information from the received identification name, the acquired BM display time, the CH number and program ID, the received regional code, the information stored in the object storage area, and the corner detection flag “0”.

If it receives bookmark instruction information including the second registration instruction and a regional code, the information generating unit 3030 generates bookmark information from the received identification name, the acquired BM display time, the CH number and program ID, the received regional code, the information stored in the object storage area, and the corner detection flag “1”.

(b) Writing Unit 3032

The writing unit 3032 writes into a folder in the bookmark storing unit 3002 according to the additional information included in the bookmark information generated by the information generating unit 3030.

(5) Acquisition Unit 3005

The acquisition unit 3005 is composed of an information acquiring unit 3040 and a data acquiring unit 3041. The following describes the information acquiring unit 3040 and the data acquiring unit 3041.

(a) Information Acquiring Unit 3040

The information acquiring unit 3040, upon receiving the display start information from the remote controller 2300 via the reception unit 3008, generates a storage destination list, and displays the generated storage destination list on the monitor 11 via the output unit 3007, to urge selection of a storage destination of the bookmark information. The information acquiring unit 3040 receives the selected folder information from the remote controller 2300 via the reception unit 3008.

The information acquiring unit 3040 further acquires identification names from each piece of bookmark information recorded in the folder indicated by the selected folder information.

The information acquiring unit 3040 generates a list composed of all the acquired identification names, and displays the generated list on the monitor 11 via the output unit 3007.

The information acquiring unit 3040 receives selected identification name information, which indicates a selected identification name, from the remote controller 2300 via the reception unit 3008.

These functions constitute a request receiving unit that receives an output request for the bookmarked image.

The information acquiring unit 3040 acquires, from the bookmark storing unit 3002, bookmark information that corresponds to the identification name indicated in the received selected identification name information.

Also, upon receiving the display start information from the portable phone 2100 via the transmission/reception unit 3009, the information acquiring unit 3040 generates the storage destination list and transmits the generated storage destination list to the portable phone 2100 via the transmission/reception unit 3009. Upon receiving the selected folder information from the portable phone 2100 via the transmission/reception unit 3009, the information acquiring unit 3040 acquires identification names from each piece of bookmark information recorded in the folder indicated by the selected folder information.

The information acquiring unit 3040 generates a list composed of all the acquired identification names, and transmits the generated list to the portable phone 2100 via the transmission/reception unit 3009.

Upon receiving the selected identification name information from the portable phone 2100 via the transmission/reception unit 3009, the information acquiring unit 3040 acquires the bookmark information corresponding to the identification name indicated in the received selected identification name information from the bookmark storing unit 2002.

When it receives the image data request information and a regional code from the portable phone 2100 via the transmission/reception unit 3009, the information acquiring unit 3040 acquires from the bookmark storing unit 2002 all the bookmark information that includes a regional code matching the received regional code.

(b) Data Acquiring Unit 3041.

The data acquiring unit 3041 preliminarily stores: the number of still images (for example, 300) that constitute a moving image; and programs respectively corresponding to “music recognition process”, “person recognition process”, “character recognition process”, “capture recognition process”, and “corner recognition process”.

The data acquiring unit 3041 acquires from the program content storing unit 3001 a program content that corresponds to the CH number and the program ID included in the bookmark information acquired by the information acquiring unit 3040. Here, there is a possibility that there are a plurality of program contents that correspond to the CH number and the program ID, due to deletion of program contents which will be described later. In such a case, the data acquiring unit 3041 acquires a program content, among the plurality of program contents, that has a recording start time that matches the time indicated by the display time included in the bookmark information.

The data acquiring unit 3041 judges whether or not the corner detection flag included in the acquired bookmark information is “0”.

If it judges that the corner detection flag is “0”, the data acquiring unit 3041 acquires, by copying, a still or moving image from the acquired program content by using the BM display time and performing a recognition process that corresponds to the information indicated by the additional information. When it acquires a moving image, the data acquiring unit 3041 acquires, by copying, sound/voice data related to the moving image as well. The acquisition method is the same as the acquisition method of Embodiment 2, and description thereof is omitted.

If it judges that the corner detection flag is not “0”, namely that the flag is “1”, the data acquiring unit 3041 detects, from the acquired program content by using the BM display time and performing a corner recognition process, a corner including image data that corresponds to the information indicated by the additional information, and acquires all the image data included in the detected corner by copying, namely, acquires a moving image.

When there are a plurality of pieces of bookmark information that were acquired by the information acquiring unit 3040, the above-described operation is repeated as many times as the number of acquired pieces of bookmark information.

Upon receiving the display start information from the remote controller 2300, the data acquiring unit 3041 displays the acquired image on the monitor 11 via the playback unit 3003 and the output unit 3007. When it displays a moving image, the data acquiring unit 3041 outputs sound/voice data related to the moving image from the monitor 11 via the playback unit 3003 and the output unit 3007. These functions constitute an output unit that outputs a partial content composed of a still image, or a partial content composed of a moving image and a sound/voice.

Upon receiving the display start information from the portable phone 2100, the data acquiring unit 3041 transmits the acquired image to the portable phone 2100 via the transmission/reception unit 3009. When it transmits a moving image, the data acquiring unit 3041 transmits sound/voice data related to the moving image to the portable phone 2100 via the transmission/reception unit 3009, as well. These functions constitute a content transmitting unit that transmits a partial content a partial content composed of a still image read from the bookmark storing unit 3002, or a partial content composed of a moving image and a sound/voice.

Upon receiving the image data request information from the portable phone 2100, the data acquiring unit 3041 transmits each of the acquired images to the portable phone 2100 via the transmission/reception unit 3009. When it transmits a moving image, the data acquiring unit 3041 transmits sound/voice data related to the moving image to the portable phone 2100 via the transmission/reception unit 3009, as well.

(6) Deletion Unit 3006

The deletion unit 3006, as is the case with the data acquiring unit 3041, preliminarily stores programs respectively corresponding to “music recognition process”, “person recognition process”, “character recognition process”, and “capture recognition process”.

The deletion unit 3006 receives, from the remote controller 2300 via the reception unit 3008, deletion instruction information that indicates performing deletion of a program content recorded in the program content storing unit 3001. Here, the deletion instruction information is information that includes a program ID.

The deletion unit 3006 acquires from the program content storing unit 3001 a program content corresponding to the program ID included in the received deletion instruction information, and further acquires from the bookmark storing unit 3002 all the bookmark information that includes a program ID matching the received program ID.

The deletion unit 3006 repeats the following deletion method as many times as the number of acquired pieces of bookmark information, using the acquired program content and bookmark information.

<Deletion Method>

The deletion unit 3006 judges whether or not the additional information included in the bookmark information is “music”. If it judges that the additional information is “music”, the deletion unit 3006 acquires a music start frame that is before and closest to the BM display time, by performing the music recognition process using the BM display time included in the bookmark information and the acquired program content. The deletion unit 3006 then acquires music sound/voice image data that is composed of (a) consecutive frames of a preliminarily set time period (for example, three minutes) starting with the acquired music start frame and (b) the sound/voice data, and temporarily stores the acquired music sound/voice image data with indication of correspondence with the program ID, CH number, and BM display time.

If it judges that the additional information included in the bookmark information is not “music”, the deletion unit 3006 judges whether or not the additional information is “person”. If it judges that the additional information is “person”, the deletion unit 3006 detects a person start frame that is before and closest to the BM display time, by performing the person recognition process using the BM display time included in the bookmark information and the program content acquired from the program content storing unit 3001. The deletion unit 3006 then acquires, by copying, person sound/voice image data that is composed of (a) consecutive frames of a preliminarily set time period (for example, three minutes) starting with the detected person start frame and (b) the sound/voice data, and temporarily stores the acquired person sound/voice image data with indication of correspondence with the program ID, CH number, and BM display time.

If it judges that the additional information included in the bookmark information is not “person”, the deletion unit 3006 judges whether or not the additional information is “character”. If it judges that the additional information is “character”, the deletion unit 3006 detects a character start frame that is before and closest to the BM display time, by performing the character recognition process using the BM display time included in the bookmark information and the program content acquired from the program content storing unit 3001. The deletion unit 3006 then acquires, by copying, character sound/voice image data that is composed of (a) consecutive frames of a preliminarily set time period (for example, three minutes) starting with the detected character start frame and (b) the sound/voice data, and temporarily stores the acquired character sound/voice image data with indication of correspondence with the program ID, CH number, and BM display time.

If it judges that the additional information included in the bookmark information is not “character”, that is to say, if it judges that the additional information is “capture”, the deletion unit 3006 detects a capture start frame that is before and closest to the BM display time, by performing the capture recognition process using the BM display time included in the bookmark information and the program content acquired from the program content storing unit 3001. The deletion unit 3006 then acquires, by copying, capture sound/voice image data that is composed of (a) consecutive frames of a preliminarily set time period (for example, three minutes) starting with the detected capture start frame and (b) the sound/voice data, and temporarily stores the acquired capture sound/voice image data with indication of correspondence with the program ID, CH number, and BM display time.

Hereinafter, the music, person, character, and capture sound/voice image data is generically referred to as sound/voice image data when there is no need for distinction between them.

After it performs the above-described operation onto each piece of bookmark information acquired from the bookmark information storing unit 3002, the deletion unit 3006 deletes the program content.

The deletion unit 3006 stores the temporarily stored sound/voice image data into the program content storing unit 3001. At this point in time, the recording start time is the date and time indicated by the BM display time.

With the above-described operation, the image data and sound/voice image data that are in the vicinity of the bookmarked image data are stored even after the program content is deleted, thus enabling the user to refer to the stored data.

The above-described bookmark storing unit 3002, writing unit 3032, data acquiring unit 3041, and deletion unit 3006 constitute a partial content acquiring unit that acquires a bookmarked still or moving image. The writing unit 3032 constitute a writing unit that writes the bookmark information. The operation of acquiring sound/voice image data after receiving the deletion instruction information constitutes a first acquiring unit. The operation of storing sound/voice image data into the program content storing unit 3001 constitutes a recording unit. The operation of acquiring sound/voice image data for each all the pieces of bookmark information acquired from the bookmark storing unit 3002 and then deleting the program content from the program content storing unit 3001 constitutes a deletion unit. The operation of acquiring a still image or acquiring a moving image and sound/voice by the data acquiring unit 3041 constitutes a second acquiring unit.

(7) Output Unit 3007

The output unit 3007 is the same as the above-described output unit 2007, and description thereof is omitted.

(8) Reception Unit 3008

The reception unit 3008 is the same as the above-described reception unit 2008, and description thereof is omitted.

(9) Transmission/Reception Unit 3009

The transmission/reception unit 3009 is the same as the above-described transmission/reception unit 2009, and description thereof is omitted.

2.6.2 Operation of BM Registration Process

Here, operation of the BM registration process performed by the playback apparatus 3000 will be described by paying attention to the differences from the BM registration process shown in FIG. 44.

A change has been made to step S2040 in which after the image data acquisition process is performed, the control moves to the information storage process which is performed as shown in FIG. 47. It should be noted here that only the generated bookmark information is stored into each folder.

Also, in step S2035, the bookmark information is generated as follows.

Upon receiving the bookmark instruction information including the first registration instruction, the information generating unit 3030 generates the bookmark information using the received identification name, the acquired BM display time, CH number, and program ID, the information stored in the object storage area, and the corner detection flag “0”. In this case, no information is recorded as the regional code.

If it receives bookmark instruction information including the second registration instruction, the information generating unit 3030 generates bookmark information from the received identification name, the acquired BM display time, the CH number and program ID, the information stored in the object storage area, and the corner detection flag “1”. In this case, no information is recorded as the regional code.

If it receives bookmark instruction information including the first registration instruction and a regional code, the information generating unit 3030 generates bookmark information from the received identification name, the acquired BM display time, the CH number and program ID, the received regional code, the information stored in the object storage area, and the corner detection flag “0”.

If it receives bookmark instruction information including the second registration instruction and a regional code, the information generating unit 3030 generates bookmark information from the received identification name, the acquired BM display time, the CH number and program ID, the received regional code, the information stored in the object storage area, and the corner detection flag “1”.

2.6.3 Operation of First Display Process

Here will be described the operation of the first display process that is performed by the playback apparatus 3000 when it receives the display start information from the remote controller 2300, by paying attention to the differences from the first display process shown in FIG. 47.

A change has been made to step S2430 in which the image data acquisition process, which will be described later, is performed.

2.6.4 Operation of Second Display Process

Here will be described the operation of the second display process that is performed by the playback apparatus 3000 when it receives the image data request information and a regional code from the portable phone 2100, by paying attention to the differences from the second display process shown in FIG. 48.

A change has been made to step S2510 in which the image data acquisition process, which will be described later, is performed.

In the second display process, when a plurality of pieces of bookmark information are acquired in step S2505, the image data acquisition process is repeated as many times as the number of acquired pieces of bookmark information.

2.6.5 Image Data Acquisition Process

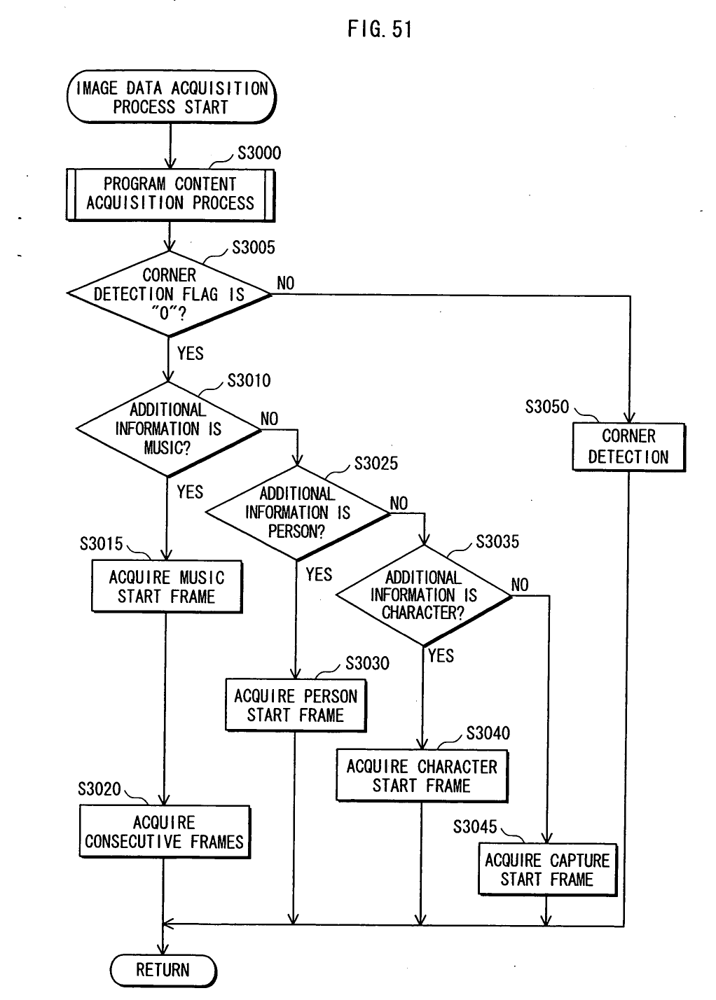

Here, operation of the image data acquisition process performed in the first and second display processes will be described with reference to the flowchart shown in FIG. 51.

The data acquiring unit 3041 of the playback apparatus 3000 performs the program content acquisition process in which it acquires, from the program content storing unit 3001, a BM object content that corresponds to the CH number and the program ID included in the bookmark information generated by the information acquiring unit 3040 (step S3000).

The data acquiring unit 3041 judges whether or not the corner detection flag included in the bookmark information acquired by the information acquiring unit 3040 is “0” (step S3005).

If it judges that the corner detection flag is “0” (“YES” in step S3005), the data acquiring unit 3041 judges whether or not the additional information included in the bookmark information acquired by the information acquiring unit 3040 is “music” (step S3010). If it judges that the additional information is “music” (“YES” in step S3010), the data acquiring unit 3041 detects and acquires a music start frame from the acquired program content, by performing the music recognition process using the BM display time included in the bookmark information and the BM object content (step S3015). The data acquiring unit 3041 then acquires, by copying, a predetermined number of consecutive frames starting with the acquired music start frame, and also acquires sound/voice data by copying (step S3020). In step S3015, sound/voice data corresponding to the acquired music start frame is also acquired by copying.

If it judges that the additional information included in the bookmark information is not “music” (“NO” in step S3010), the data acquiring unit 3041 judges whether or not the additional information is “person” (step S3025).

If it judges that the additional information is “person” (“YES” in step S3025), the data acquiring unit 3041 detects and acquires a person start frame from the acquired program content, by performing the person recognition process using the BM display time included in the bookmark information and the BM object content (step S3030).

If it judges that the additional information is not “person” (“NO” in step S3025), the data acquiring unit 3041 judges whether or not the additional information is “character” (step S3035).

If it judges that the additional information is “character” (“YES” in step S3035), the data acquiring unit 3041 detects and acquires a character start frame from the acquired program content, by performing the character recognition process using the BM display time included in the bookmark information and the BM object content (step S3040).

If it judges that the additional information is not “character” (“NO” in step S3035), that is to say, if it judges that the additional information is “capture”, the data acquiring unit 3041 detects and acquires a capture start frame from the acquired program content, by performing the capture recognition process (step S3045).

If it judges that the corner detection flag is not “0”, namely that the flag is “1” (“NO” in step S3005), the data acquiring unit 3041 detects, from the acquired program content by using the BM display time and performing a corner recognition process, a corner including image data that corresponds to the information indicated by the additional information included in the bookmark information acquired by the information acquiring unit 3040, and acquires all the image data included in the detected corner by copying, namely, acquires a moving image (step S3050).

It should be noted here that the phrase “to detect and acquire a frame” means to detect a frame and acquire the detected frame by copying.

2.6.6 Program Content Acquisition Process

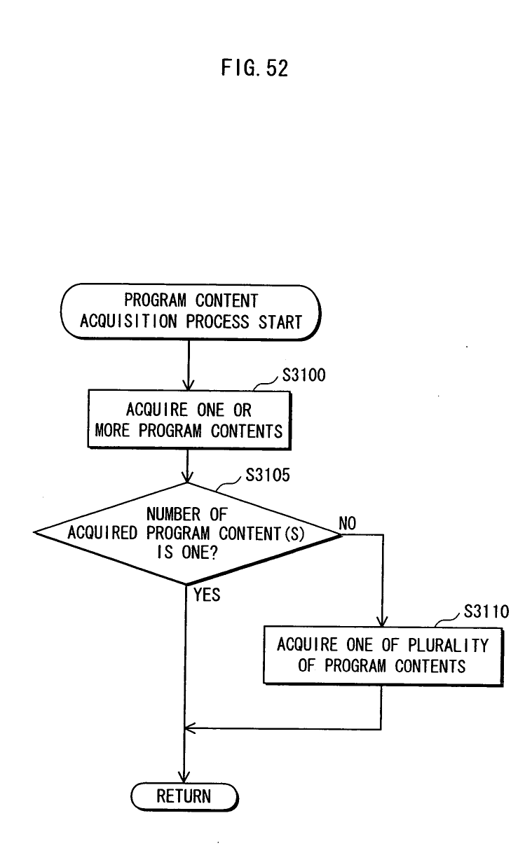

Here will be described the operation of the program content acquisition process performed in step S3000 of the image data acquisition process shown in FIG. 51, with reference to the flowchart shown in FIG. 52.

The data acquiring unit 3041 acquires one or more program contents corresponding to the CH number and program ID of the bookmark information acquired by the information acquiring unit 3040, from the program content storing unit 2001 (step S3100), and judges whether or not the number of acquired program content(s) is one (step S3105).

If the data acquiring unit 3041 judges that the number of acquired program content(s) is one (“YES” in step S3105), the process is ended; and if the data acquiring unit 3041 judges that the number of acquired program content(s) is not one (“NO” in step S3105), the data acquiring unit 3041 acquires, among the plurality of acquired program contents, a program content whose recording start time matches the time indicated by the BM display time included in the bookmark information (step S3110).

2.6.7 Deletion Process

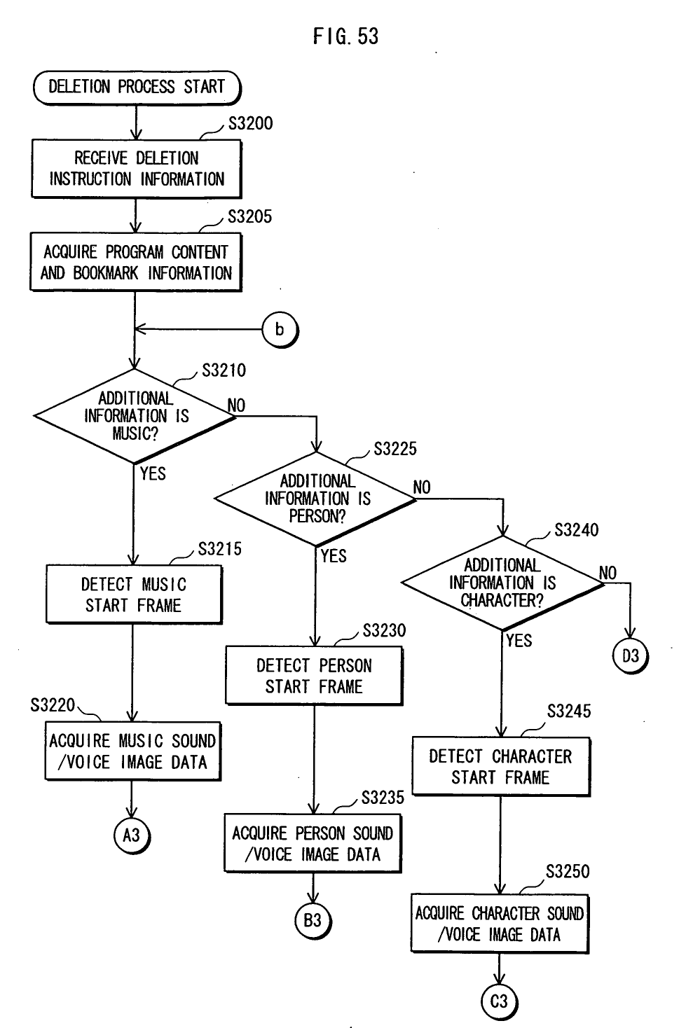

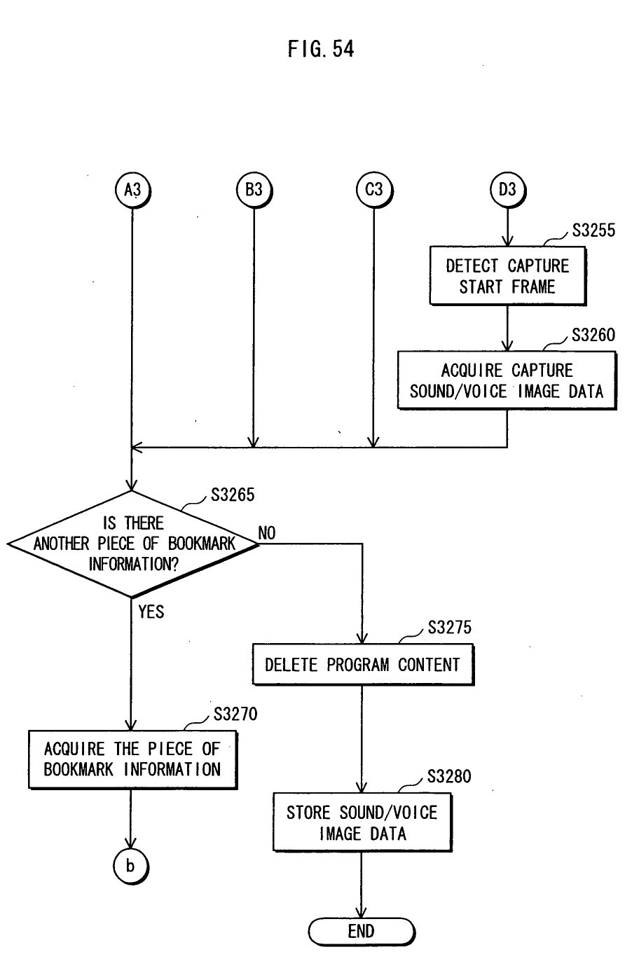

Here will be described the operation of a deletion process for deleting a program content performed by the playback apparatus 3000, with reference to the flowcharts shown in FIGS. 53 and 54.

When it receives the deletion instruction information (step S3200), the deletion unit 3006 acquires, from the program content storing unit 3001, a program content that corresponds to the program ID included in the received deletion instruction information, and acquires, from the bookmark information storing unit 3002, all pieces of bookmark information that correspond to the program ID (step S3205).

The deletion unit 3006 judges whether or not the bookmark additional information included in one of the acquired pieces of bookmark information is “music” (step S3210).

If it judges that the bookmark additional information is “music” (“YES” in step S3210), the deletion unit 3006 performs the music recognition process to detect a music start frame (step S3215), acquires the music sound/voice image data by copying with use of the detected music start frame, and temporarily stores the acquired music sound/voice image data with indication of correspondence with the program ID, CH number, and BM display time (step S3220).

If it judges that the additional information is not “music” (“NO” in step S3210), the deletion unit 3006 judges whether or not the additional information is “person” (step S3225).

If it judges that the additional information is “person” (“YES” in step S3225), the deletion unit 3006 performs the person recognition process to detect a person start frame (step S3230), acquires the person sound/voice image data by copying with use of the detected person start frame, and temporarily stores the acquired person sound/voice image data with indication of correspondence with the program ID, CH number, and BM display time (step S3235).

If it judges that the additional information is not “person” (“NO” in step S3225), the deletion unit 3006 judges whether or not the additional information is “character” (step S3240).

If it judges that the additional information is “character” (“YES” in step S3240), the deletion unit 3006 performs the character recognition process to detect a character start frame (step S3245), acquires the character sound/voice image data by copying with use of the detected character start frame, and temporarily stores the acquired character sound/voice image data with indication of correspondence with the program ID, CH number, and BM display time (step S3250).

If it judges that the additional information is not “character” (“NO” in step S3240), that is to say, if it judges that the additional information is “capture”, the deletion unit 3006 performs the capture recognition process to detect a capture start frame (step S3255), acquires the capture sound/voice image data by copying with use of the detected capture start frame, and temporarily stores the acquired capture sound/voice image data with indication of correspondence with the program ID, CH number, and BM display time (step S3260).

The deletion unit 3006 judges whether or not there is, among the pieces of bookmark information acquired in step S3205, a piece of bookmark information for which steps S3210 to S3260 have not been performed (step S3265).

If it judges that there is such a piece of bookmark information (“YES” in step S3265), the deletion unit 3006 acquires the piece of bookmark information that has not been processed (step S3270), then returns to step S3210 to perform step S3210 and onwards for the acquired piece of bookmark information.

If it judges that there is no piece of bookmark information for which steps S3210 to S3260 have not been performed, that is to say, if it judges that steps S3210 to S3260 have been performed for all the pieces of bookmark information acquired in step S3205 (“NO” in step S3265), the deletion unit 3006 deletes the program content (step S3275), and stores the temporarily stored sound/voice image data into the program content storing unit 3001 with indication of correspondence with the program ID, CH number, and BM display time (step S3280).

2.7 Other Modifications

Up to now, the present invention has been explained through an embodiment thereof. However, the present invention is not limited to the embodiment. The following, for example, should be construed as the present invention.

(1) In the above-described embodiment, the playback apparatus 2000 receives a bookmark instruction during a playback of a program content. However, not limited to this, the playback apparatus 2000 may receive a bookmark instruction during a playback of a moving image corresponding to the bookmark information. For example, the playback apparatus 2000 may receive a bookmark instruction during a playback of a moving image that has been detected by a bookmark instruction including the second registration instruction, namely, during a playback of a moving image of one corner.

In this case, the playback apparatus 2000 records, as the BM display time, a broadcast time of a start frame acquired in a recognition process (for example, the corner recognition process). Upon receiving the bookmark instruction information during a playback of a moving image, the playback apparatus 2000 calculates a bookmarked broadcast time from the BM display time corresponding to the moving image being played back, and acquires the CH number and program ID from the bookmark information corresponding to the moving image being played back. The playback apparatus 2000 also receives an identification name, and generates the bookmark information using the calculated broadcast time, the acquired CH number and program ID, the received identification name, and the information stored in the object storage area. The playback apparatus 2000 further acquires a still or moving image that corresponds to the bookmark information, using the calculated broadcast time and performing the recognition process corresponding to the information stored in the object storage area. The playback apparatus 2000 stores the acquired still or moving image and the generated bookmark information with indication of correspondence between them. If the bookmark instruction information includes a regional code, the playback apparatus 2000 generates the bookmark information using the calculated broadcast time, the acquired CH number and program ID, the received identification name, the regional code included in the bookmark instruction information, and the information stored in the object storage area.

In the above-described manner, the playback apparatus 2000 is able to perform the bookmarking during a playback of a moving image.

(2) The operation described in the above (1) may be applied to the playback apparatus 3000.

In this case, when the playback apparatus 3000 receives a display request and plays back a moving image corresponding to the bookmark information, the playback apparatus 3000 calculates a broadcast time of a start frame acquired in a recognition process, and temporarily stores the calculated broadcast time. Upon receiving the bookmark instruction information, the playback apparatus 3000 calculates a broadcast time corresponding to the time at which it received the bookmark instruction information, using the temporarily stored broadcast time. The playback apparatus 3000 acquires the CH number and program ID from the bookmark information corresponding to the moving image being played back. The playback apparatus 3000 also receives an identification name, and generates the bookmark information using the calculated broadcast time, the acquired CH number and program ID, the received identification name, and the information stored in the object storage area, and stores the generated bookmark information. If the bookmark instruction information includes a regional code, the playback apparatus 3000 generates the bookmark information using the calculated broadcast time, the acquired CH number and program ID, the received identification name, the regional code included in the bookmark instruction information, and the information stored in the object storage area.

(3) In the above-described embodiment, the left button 2313 and the right button 2314 of the remote controller 2300 are used to change the object of bookmarking. However, not limited to this, the remote controller 2300 may be provided with, in place of the left button 2313 and the right button 2314, buttons indicating the objects of bookmarking, for example, a music button, a person button, a character button, and a capture button.

In this case, when any of the music button, person button, character button, and capture button is depressed, the remote controller 2300 transmits the bookmark instruction information including the first registration instruction information and the correspondence information to the playback apparatus 2000 via the radiation unit 2303. It should be noted here that the correspondence information is the same as the correspondence information described in Embodiment 1, and description thereof is omitted.

When any of the music button, person button, character button, and capture button is depressed, and a regional code is input by operating the character operation unit 2302, the remote controller 2300 transmits the bookmark instruction information composed of the first registration instruction information, the correspondence information, and the regional code to the playback apparatus 2000 via the radiation unit 2303.

The information generating unit 2030 of the playback apparatus 2000, upon receiving the bookmark instruction information, generates the bookmark information using the correspondence information included in the bookmark instruction information. The other elements to be included in the bookmark information are acquired by the operations indicated in the above-described embodiment.

The operations subsequent to this are the same as the operations indicated in the above-described embodiment, and thus description thereof is omitted.

(4) In the above-described embodiment, the bookmark system is composed of the playback apparatus 2000 and the portable phone 2100. However, not limited to this, the bookmark system may be composed of only a playback apparatus. In this case, the playback apparatus receives the bookmark instruction information including the first registration instruction or the bookmark instruction information including the second registration instruction, from the remote controller 2300. Also, the playback apparatus receives the display start information for displaying an image related to the bookmark information, from only the remote controller.

(5) In the above-described embodiment, the playback apparatus 2000 detects a start frame positioned before the BM display time, by performing a recognition process. However, not limited to this, a frame corresponding to the BM display time may be regarded as the start frame.

(6) The above-described embodiments and modifications may be combined in any manner.

### 3. Modifications

Up to now, the present invention has been explained through embodiments thereof. However, the present invention is not limited to the embodiments. The following, for example, should be construed as the present invention.

(1) In the above-described embodiments, program contents to be played back are stored by the playback apparatus. However, not limited to this, program contents to be played back may be distributed by a server-type broadcasting. In this case, registration of a bookmark and transmission/reception of an image related to the bookmark information may be performed between the playback apparatus and the server that distributes program contents.

(2) In the above-described embodiments, when the bookmark information is generated, an image corresponding to the bookmark information is acquired by performing the corner recognition process or a recognition process that corresponds to the additional information. However, the present invention is not limited to this.

The playback apparatus may have a function to store a played-back image into a buffer having a predetermined capacity. And upon receiving a bookmark instruction, the playback apparatus may store one or more images stored in the buffer as still or moving images corresponding to the bookmark information, with indication of correspondence with the bookmark information.

(3) In the above-described embodiments, when the portable phone receives an image corresponding to the bookmark information, the portable phone may record the received image onto a memory in the portable phone or onto an attachable/detachable recording medium (for example, an SD card).

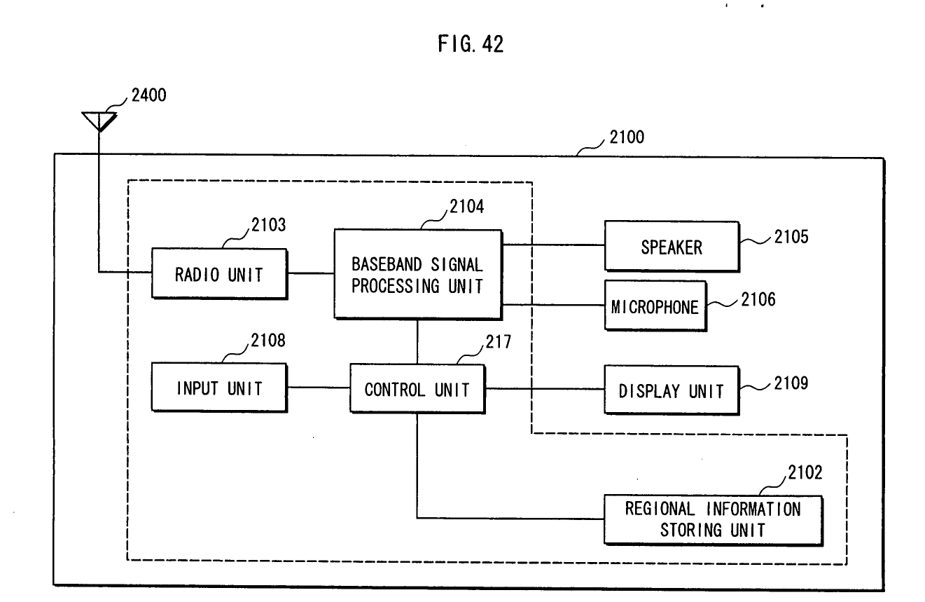

(4) Part or all of the functional blocks shown in FIGS. 2, 10, 22, 24, 28, 32, 42, and 49, encircled by dotted lines, may be achieved as an LSI being an integrated circuit. Each of the functional blocks may be achieved in one chip, or part or all of the functional blocks may be achieved in one chip.

It should be noted here that although the term LSI is used here to indicate an integrated circuit for controlling the recording/playback apparatus, the integrated circuit may be called IC, system LSI, super LSI, ultra LSI or the like, depending on the level of integration.

Also, the integrated circuit is not limited to the LSI, but may be achieved by a dedicated circuit or a general purpose processor. It is also possible to achieve the integrated circuit by using the FPGA (Field Programmable Gate Array) that can be re-programmed after the LSI is manufactured, or a reconfigurable processor that can reconfigure the connection and settings of the circuit cells inside the LSI.

Furthermore, a technology for an integrated circuit that replaces the LSI may appear in the near future as the semiconductor technology improves or branches into another technologies. In that case, the new technology may be incorporated into the integration of the functional blocks constituting the present invention as described above. Such possible technologies include biotechnology.

(5) In the above-described embodiments, a still or moving image is acquired as information corresponding to the bookmark information. However, not limited to this, only sound/voice data may be acquired as information corresponding to the bookmark information. In this case, for example, if the additional information included in the bookmark information is “music” in the above-described embodiments, only a sound/voice is acquired.

(6) In the above-described embodiments, to calculate the elapse time until the bookmark instruction is issued, counting the frames starts when a program content starts to be played back. However, not limited to this, a timer may be used to calculate the elapse time from the start of a playback of a program content.

In this case, upon receiving the bookmark instruction information, the playback apparatus acquires, as the elapse time, a time that is measured by the timer when the bookmark instruction information is received.

(7) The present invention may be methods shown by the above. The present invention may be a computer program that causes a computer to realize the methods, or may be digital signals representing the computer program.

Furthermore, the present invention may be a computer-readable recording medium such as a flexible disk, a hard disk, CD-ROM, MO, DVD, DVD-ROM, DVD RAM, BD (Blu-ray Disc), or a semiconductor memory, that stores the computer program or the digital signal. Furthermore, the present invention may be the computer program or the digital signal recorded on any of the aforementioned recording mediums.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal via the recording medium, or by transferring the program or the digital signal via the network or the like, the program or the digital signal may be executed by another independent computer system.

(8) The present invention may be any combination of the above-described embodiments and modifications.

### INDUSTRIAL APPLICABILITY

The above-described bookmark system can be used effectively, namely repetitively and continuously, in the industry for producing and selling playback apparatuses and portable terminals.

1. A playback apparatus, comprising:
an information receiving unit operable to receive type information that indicates a type of an object;
a position acquiring unit operable to acquire position information that indicates a playback position, which corresponds to a time at which the type information was received, in a content that was being played back then; and
a partial content acquiring unit operable to acquire, from the content, a partial content being a part of the content that includes an object corresponding to the type indicated by the type information and is started from either the playback position indicated by the position information or a position in a vicinity of the playback position.

2. The playback apparatus of claim 1, wherein
the partial content acquiring unit acquires the partial content when the position acquiring unit acquires the position information, the playback apparatus further comprising:
a bookmark storing unit; and
a writing unit operable to write the partial content into the bookmark storing unit.

3. The playback apparatus of claim 2, wherein
the content includes a moving image that is composed of a plurality of still images,
the partial content is composed of a still image included in the content,
the partial content acquiring unit detects, from a portion of the content positioned back prior to the playback position, a still image that contains an object corresponding to the type indicated by the type information, and acquires the detected still image as the partial content.

4. The playback apparatus of claim 3, wherein
the partial content acquiring unit acquires a still image as the partial content if the type information indicates an image-related type.

5. The playback apparatus of claim 4, wherein
the type information indicates that the type of the object is one of (i) either image of person or character that constitutes part of one image and (ii) capture that constitutes one entire image, and
the partial content acquiring unit acquires a still image as the partial content if the type information indicates one of image of person, character, and capture as the type.

6. The playback apparatus of claim 2, wherein
the content includes a moving image, which is composed of a plurality of still images, and a sound/voice that corresponds to the moving image,
the partial content is composed of a partial moving image and a partial sound/voice, the partial moving image being included in the moving image, and the partial sound/voice corresponding to the partial moving image,
the partial content acquiring unit detects, from a portion of the content positioned back prior to the playback position, a still image that contains an object corresponding to the type indicated by the type information, and acquires, as the partial content, the partial moving image that starts with the detected still image, and acquires the partial sound/voice that corresponds to the partial moving image.

7. The playback apparatus of claim 6, wherein
the partial content acquiring unit acquires, as the partial content, a partial moving image and a partial sound/voice corresponding to the partial moving image if the type information indicates a sound-related type.

8. The playback apparatus of claim 7, wherein
the partial content acquiring unit acquires, as the partial content, a partial moving image and a partial sound/voice corresponding to the partial moving image if the type information indicates music as a type.

9. The playback apparatus of claim 2, wherein
the content includes one or more corner contents,
each corner content includes one or more images,
a specific image indicating a boundary of corner content is present before and after each corner content,
the partial content acquiring unit detects, from a portion of the content positioned back prior to the playback position, a specific image that is closest to the playback position, and acquires, as the partial content, a corner content that starts immediately after the detected specific image.

10. The playback apparatus of claim 2 further comprising:
a request receiving unit operable to receive an output request for the partial content;
a reading unit operable to, if the request receiving unit receives the output request, read the partial content from the bookmark storing unit; and
an output unit operable to output the read partial content.

11. The playback apparatus of claim 2 further comprising:
a receiving unit operable to receive an output request for the partial content from an external terminal via a network;
a reading unit operable to, if the receiving unit receives the output request, read the partial content from the bookmark storing unit; and
a content transmitting unit operable to transmit the read partial content to the external terminal via the network.

12. The playback apparatus of claim 1 further comprising:
a request receiving unit operable to receive an output request for the partial content acquired by the partial content acquiring unit; and
an output unit operable to output the acquired partial content, wherein
the partial content acquiring unit acquires the partial content using the position information and the type information when the request receiving unit receives the output request.

13. The playback apparatus of claim 1, wherein
the partial content acquiring unit, upon receiving delete information which instructs deletion of the content, deletes the content except for a specific portion including the partial content.

14. The playback apparatus of claim 13, wherein
the content includes a moving image, which is composed of a plurality of still images, and a sound/voice that corresponds to the moving image,
the playback apparatus further comprising
a content storing unit operable to preliminarily store the content, wherein
the partial content acquiring unit includes:
a bookmark storing unit;
a writing unit operable to write, into the bookmark storing unit, the position information and the type information with indication of correspondence with each other;
a deletion receiving unit operable to receive delete information which instructs deletion of the content,
a first acquisition unit operable to, if the deletion receiving unit receives the delete information, detect, from a portion of the content positioned back prior to the playback position, a still image that contains an object corresponding to the type indicated by the type information, and acquire a specific partial content which is part of the content, includes a specific partial moving image that starts with the detected still image, and includes a specific partial sound/voice that corresponds to the specific partial moving image;
a recording unit operable to record the specific partial content acquired by the first acquisition unit into the content storing unit;
a deletion unit operable to delete the content from the content storing unit; and
a second acquisition unit operable to acquire the partial content from the specific partial content recorded in the content storing unit, using the type information and the position information.

15. The playback apparatus of claim 14 further comprising:
a request receiving unit operable to receive an output request for the partial content; and
an output unit operable to output the acquired partial content, wherein
the second acquisition unit acquires the partial content using the position information and the type information when the request receiving unit receives the output request.

16. The playback apparatus of claim 1, wherein
the partial content acquiring unit acquires the partial content when the position acquiring unit acquires the position information, the playback apparatus further comprising:
a content storing unit operable to preliminarily store the content;
a bookmark storing unit;
a writing unit operable to write the partial content into the bookmark storing unit;
a deletion receiving unit operable to receive delete information which instructs deletion of the content; and
a deletion unit operable to, if the deletion receiving unit receives the delete information, delete the content from the content storing unit, leaving the partial content in the bookmark storing unit without deleting thereof.

17. The playback apparatus of claim 1, wherein
the information receiving unit receives the type information from an external terminal, and further receives a terminal identifier for identifying the external terminal from the external terminal, the playback apparatus further comprising:
a bookmark storing unit; and
a writing unit operable to write, into the bookmark storing unit, the terminal identifier in correspondence with the position information and the type information.

18. The playback apparatus of claim 17 further comprising:
a receiving unit operable to receive a terminal identifier and an output request for the partial content acquired by the partial content acquiring unit, from an external terminal; and
a content transmitting unit operable to transmit the partial content to the external terminal from which the output request was received, wherein
the partial content acquiring unit compares the received terminal identifier with the terminal identifier stored in the bookmark storing unit, and if the two terminal identifiers are identical with each other, reads position information and type information that correspond to the terminal identifiers, from the bookmark storing unit, and acquires the partial content using the read position information and type information.

19. The playback apparatus of claim 18, wherein
the content includes an image group that is composed of a plurality of images,
the partial content includes one or more images included in the image group, and
the partial content acquiring unit performs degrading so that each image included in the partial content is lower in image quality than each image constituting the image group included in the content.

20. The playback apparatus of claim 18, wherein
the content includes a sound/voice,
the partial content includes a partial sound/voice that is a part of the sound/voice, and
the partial content acquiring unit performs degrading so that the partial sound/voice included in the partial content is lower in sound quality than the sound/voice included in the partial content.

21. The playback apparatus of claim 18, wherein
the content includes an image group that is composed of a plurality of images,
in the partial content, a predetermined character is attached to one or more images included in the image group, and
the partial content acquiring unit attaches a predetermined character to an image acquired from the image group.

22. The playback apparatus of claim 18, wherein
the bookmark storing unit further stores another position information and another type information in correspondence with another terminal identifier for identifying another external terminal, said another position information and said another type information corresponding to the content,
the playback apparatus further comprises
an expiration time writing unit operable to write, in correspondence with the position information into the bookmark storing unit, an expiration time of the partial content transmitted by the content transmitting unit, and
the partial content acquiring unit acquires the partial content if the receiving unit receives the output request and the terminal identifier from the external terminal before the expiration time, and prohibits itself from acquiring the partial content for said another position information and said another type information if the receiving unit receives, before the expiration time, said another terminal identifier and the output request for the partial content from said another terminal corresponding to said another position information and said another type information.

23. The playback apparatus of claim 1, wherein
the information receiving unit further receives a regional identifier that identifies a region related to the object, the playback apparatus further comprising:
a bookmark storing unit; and
a writing unit operable to write, into the bookmark storing unit, the regional identifier in correspondence with the position information and the type information.

24. The playback apparatus of claim 23 further comprising:
an identifier receiving unit operable to receive, from an external terminal, an output request for the partial content acquired by the partial content acquiring unit and receive a terminal region identifier that identifies a region in which the external terminal is located; and
a content transmitting unit operable to transmit the partial content to the external terminal, wherein
the partial content acquiring unit reads, from the bookmark storing unit, position information and type information that correspond to a regional identifier that is identical with the received terminal region identifier, and acquires the partial content using the read position information and type information.

25. The playback apparatus of claim 1, wherein
the position acquiring unit acquires, as the position information, an elapse time between a time at which the content is started to be played back and a time at which the type information is received, and
the partial content acquiring unit acquires the partial content that is started within the elapse time.

26. A bookmark system comprising a playback apparatus and a terminal apparatus that transmits an instruction to the playback apparatus to attach a bookmark to a content that is being played back,
the terminal apparatus including:
an instruction receiving unit operable to receive, from a user, an instruction to attach a bookmark regarding an object; and
an information transmitting unit operable to, if the instruction receiving unit receives the instruction to attach a bookmark, transmit, to the playback apparatus, type information that indicates a type of the object,
the playback apparatus including:
an information receiving unit operable to receive the type information from the terminal apparatus;
a position acquiring unit operable to acquire position information that indicates a playback position, which corresponds to a time at which the type information was received, in a content that was being played back then; and
a partial content acquiring unit operable to acquire, from the content, a partial content being a part of the content that includes an object corresponding to the type indicated by the type information and is started from either the playback position indicated by the position information or a position in a vicinity of the playback position.

27. The bookmark system of claim 26, wherein
the partial content acquiring unit acquires the partial content when the information receiving unit receives the type information, the playback apparatus further including:
a bookmark storing unit; and
a writing unit operable to write the partial content into the bookmark storing unit.

28. The bookmark system of claim 27, wherein
the terminal apparatus further includes
an identifier storing unit for preliminarily storing a terminal identifier for identifying the terminal apparatus, and
the information transmitting unit further transmits the terminal identifier with indication of correspondence with the type information,
the information receiving unit further receives the terminal identifier, and
the writing unit writes the received terminal identifier into the bookmark storing unit with indication of correspondence with the partial content.

29. The bookmark system of claim 28, wherein
the instruction receiving unit further receives an output request for the partial content stored in the bookmark storing unit,
the playback apparatus further comprises:
a receiving unit operable to receive the output request and the terminal identifier for identifying the terminal apparatus that received the output request, from the terminal apparatus;
a reading unit operable to, if the receiving unit receives the output request and the terminal identifier, compare the received terminal identifier with the terminal identifier stored in the bookmark storing unit, and if the two terminal identifiers are identical with each other, reads a partial content corresponds to the terminal identifiers, from the bookmark storing unit; and
a content transmitting unit operable to transmit the read partial content to the terminal apparatus,
the terminal apparatus further includes:
a request transmitting unit operable to, if the receiving unit receives the output request, transmit the received output request and terminal identifier to the playback apparatus;
a content receiving unit operable to receive, from the playback apparatus, the partial content read by the reading unit; and
a content output unit operable to output the received partial content.

30. The bookmark system of claim 29, wherein
the playback apparatus and the terminal apparatus are connected to each other by a home network,
the playback apparatus is a server apparatus in the home network, and
the terminal apparatus is a client apparatus in the home network.

31. The bookmark system of claim 29, wherein
the terminal apparatus is a portable terminal apparatus.

32. The bookmark system of claim 26, wherein
the playback apparatus further includes
a position transmitting unit operable to transmit the position information to the terminal apparatus,
the terminal apparatus further includes:
a position receiving unit operable to receive the position information;
a bookmark storing unit; and
an information writing unit operable to write the received position information into the bookmark storing unit with indication of correspondence with the type information that was transmitted to the playback apparatus.

33. The bookmark system of claim 32, wherein
the instruction receiving unit further receives an output request for the partial content corresponding to the position information and the type information,
the terminal apparatus further includes:
a request transmitting unit operable to, if the instruction receiving unit receives the output request, transmit, to the playback apparatus, the received output request and the position information and the type information stored in the bookmark storing unit;
a content receiving unit operable to receive, from the playback apparatus, the partial content acquired based on the transmitted position information and type information; and
a content output unit operable to output the received partial content,
the playback apparatus further includes:
a receiving unit operable to receive the position information, the type information, and the output request from the terminal apparatus; and
a content transmitting unit operable to transmit the partial content acquired by the partial content acquiring unit to the terminal apparatus, wherein
if the receiving unit receives the position information, the type information, and the output request, the partial content acquiring unit acquires the partial content using the received position information and type information.

34. A terminal apparatus that transmits an instruction to a playback apparatus to attach a bookmark to a content that is being played back, the terminal apparatus comprising:
an instruction receiving unit operable to receive, from a user, an instruction to attach a bookmark regarding an object;
an information transmitting unit operable to, if the instruction receiving unit receives the instruction to attach a bookmark, transmit, to the playback apparatus, type information that indicates a type of the object;
a position receiving unit operable to receive, from the playback apparatus, position information that indicates a playback position, which corresponds to a time at which the type information was received, in a content that was being played back then;
a bookmark storing unit; and
an information writing unit operable to write the received position information and the type information transmitted to the playback apparatus, into the bookmark storing unit with indication of correspondence with each other.

35. The terminal apparatus of claim 34, wherein
the bookmark storing unit has an area corresponding to the type indicated by the type information, and
the information writing unit writes the position information and the type information into the area corresponding to the type indicated by the type information.

36. The terminal apparatus of claim 34, wherein
the instruction receiving unit further receives an output request for the partial content acquired from the content by the playback apparatus, the output request corresponding to the position information and the type information,
the terminal apparatus further includes:
a request transmitting unit operable to transmit, to the playback apparatus, the received output request and the position information and the type information stored in the bookmark storing unit;
a content receiving unit operable to receive, from the playback apparatus, the partial content acquired based on the transmitted position information and type information; and
a content output unit operable to output the received partial content.

37. The terminal apparatus of claim 36, wherein
the terminal apparatus is a portable terminal apparatus that communicates with another terminal apparatus, and
the information transmitting unit further transmits the position information and the type information stored in the bookmark storing unit, to said another terminal apparatus.

38. The terminal apparatus of claim 37, wherein
the position receiving unit further receives, from said another terminal apparatus, position information and type information stored in said another terminal apparatus, and
the information writing unit further writes the position information and type information received from said another terminal apparatus, into the bookmark storing unit.

39. The terminal apparatus of claim 36, wherein
the terminal apparatus is a network-connected client apparatus in a home network in which the playback apparatus is a server apparatus.

40. The terminal apparatus of claim 34, wherein
the instruction receiving unit further receives a regional identifier that identifies a region related to the object, and
the information writing unit further writes, into the bookmark storing unit, the regional identifier in correspondence with the position information.

41. The terminal apparatus of claim 40, wherein
the instruction receiving unit further receives an output request for the partial content acquired from the content by the playback apparatus, the output request corresponding to the position information and the type information that correspond to a regional identifier,
the terminal apparatus further comprises:
an identifier acquiring unit operable to, if the output request is received, acquire a terminal region identifier that identifies a region in which the external terminal is currently located;
an information acquiring unit operable to acquire, from the bookmark storing unit, position information and type information that correspond to a terminal identifier that is identical with the received terminal region identifier;
a request transmitting unit operable to transmit the acquired position information and type information and the output request to the playback apparatus;
a content receiving unit operable to receive, from the playback apparatus, the partial content acquired based on the transmitted position information and type information; and
a content output unit operable to output the received partial content.

42. An integrated circuit for a playback apparatus, the integrated circuit comprising:
an information receiving unit operable to receive type information that indicates a type of an object;
a position acquiring unit operable to acquire position information that indicates a playback position, which corresponds to a time at which the type information was received, in a content that was being played back then; and
a partial content acquiring unit operable to acquire, from the content, a partial content being a part of the content that includes an object corresponding to the type indicated by the type information and is started from either the playback position indicated by the position information or a position in a vicinity of the playback position.

43. An integrated circuit for a terminal apparatus that transmits an instruction to a playback apparatus to attach a bookmark to a content that is being played back, the integrated circuit comprising:
an instruction receiving unit operable to receive, from a user, an instruction to attach a bookmark regarding an object; and
an information transmitting unit operable to, if the instruction receiving unit receives the instruction to attach a bookmark, transmit, to the playback apparatus, type information that indicates a type of the object;
a position receiving unit operable to receive, from the playback apparatus, position information that indicates a playback position, which corresponds to a time at which the type information was received, in a content that was being played back then;
a bookmark storing unit; and
an information writing unit operable to write the received position information and the type information transmitted to the playback apparatus, into the bookmark storing unit with indication of correspondence with each other.

44. An acquisition method for a playback apparatus, the acquisition method comprising the steps of:
receiving type information that indicates a type of an object;
acquiring position information that indicates a playback position, which corresponds to a time at which the type information was received, in a content that was being played back then; and
acquiring, from the content, a partial content being a part of the content that includes an object corresponding to the type indicated by the type information and is started from either the playback position indicated by the position information or a position in a vicinity of the playback position.

45. An acquisition program for causing a playback apparatus to execute:
receiving type information that indicates a type of an object;
acquiring position information that indicates a playback position, which corresponds to a time at which the type information was received, in a content that was being played back then; and
acquiring, from the content, a partial content being a part of the content that includes an object corresponding to the type indicated by the type information and is started from either the playback position indicated by the position information or a position in a vicinity of the playback position.

46. A computer-readable acquisition program recording medium which records therein an acquisition program for causing a playback apparatus to execute:
receiving type information that indicates a type of an object;
acquiring position information that indicates a playback position, which corresponds to a time at which the type information was received, in a content that was being played back then; and
acquiring, from the content, a partial content being a part of the content that includes an object corresponding to the type indicated by the type information and is started from either the playback position indicated by the position information or a position in a vicinity of the playback position.

47. A bookmark method for a terminal apparatus that transmits an instruction to a playback apparatus to attach a bookmark to a content that is being played back, and includes a bookmark storing unit, the bookmark method comprising the steps of:
receiving, from a user, an instruction to attach a bookmark regarding an object; and
transmitting, if the instruction to attach a bookmark is received, type information that indicates a type of the object, to the playback apparatus;
receiving, from the playback apparatus, position information that indicates a playback position, which corresponds to a time at which the type information was received, in a content that was being played back then; and
writing the received position information and the type information transmitted to the playback apparatus, into the bookmark storing unit with indication of correspondence with each other.

48. A bookmark program for causing a terminal apparatus, which transmits an instruction to a playback apparatus to attach a bookmark to a content that is being played back, and includes a bookmark storing unit, to execute:
receiving, from a user, an instruction to attach a bookmark regarding an object; and
transmitting, if the instruction to attach a bookmark is received, type information that indicates a type of the object, to the playback apparatus;
receiving, from the playback apparatus, position information that indicates a playback position, which corresponds to a time at which the type information was received, in a content that was being played back then; and
writing the received position information and the type information transmitted to the playback apparatus, into the bookmark storing unit with indication of correspondence with each other.

49. A computer-readable bookmark program recording medium which records therein a bookmark program for causing a terminal apparatus, which transmits an instruction to a playback apparatus to attach a bookmark to a content that is being played back, and includes a bookmark storing unit, to execute:
receiving, from a user, an instruction to attach a bookmark regarding an object; and
transmitting, if the instruction to attach a bookmark is received, type information that indicates a type of the object, to the playback apparatus;
receiving, from the playback apparatus, position information that indicates a playback position, which corresponds to a time at which the type information was received, in a content that was being played back then; and
writing the received position information and the type information transmitted to the playback apparatus, into the bookmark storing unit with indication of correspondence with each other.
